(19) United States
(12) Patent Application Publication
(10) Pub. No.: US 2015/0106748 A1
(43) Pub. Date: Apr. 16, 2015

(54) DOCUMENT EXPLORATION, ANALYSIS, AND COLLABORATION TECHNIQUES

(71) Applicants: CHARLES MONTE, San Rafael, CA (US); RICHARD RATKOWSKI, St. Peters, MO (US)

(72) Inventors: CHARLES MONTE, San Rafael, CA (US); RICHARD RATKOWSKI, St. Peters, MO (US)

(21) Appl. No.: 14/515,524

(22) Filed: Oct. 16, 2014

Related U.S. Application Data
(60) Provisional application No. 61/891,468, filed on Oct. 16, 2013.

(51) Int. Cl. G06F 3/0482; G06F 3/0488; G06F 3/0485; G06F 3/0484

(52) U.S. Cl. CPC G06F 3/0482; G06F 3/04842; G06F 3/04845; G06F 3/04883; G06F 3/0485
USPC 715/753

(57) ABSTRACT

Various embodiments of systems and methods for document exploration, analysis, and collaboration are described herein. In an aspect, the method includes receiving a command for displaying a document. Upon receiving the command, it is determined whether the document includes an erroneous data. Based upon the determination, the document is displayed along with a highlighted erroneous data. A primary mode of operation and/or the secondary mode of operation is preformed on the highlighted erroneous data. When the primary mode of operation is performed, one or more sub-data constituting the erroneous data is displayed. When the secondary mode of operation is performed on the erroneous data, a cell action menu is displayed to enable user perform at least one of sharing the erroneous data to one or more recipients, annotating the erroneous data, marking the erroneous data as favorite, and exporting the erroneous data to other application.

This application claims priority under 35 U.S.C. §119 to Provisional Patent Application 61/891,468, filed on Oct. 16, 2013, titled “DOCUMENT EXPLORATION TECHNIQUES, ANALYSIS, AND COLLABORATION”, which is incorporated herein by reference in its entirety.

### BACKGROUND

A document refers to any written, printed, or electronic matter that provides information or serves as an official record. The document may be a business document such as a financial document, an operational document, etc. Usually, the business documents include voluminous data which are scattered and might be difficult to analyze. Often, it is time consuming and difficult to segregate, explore, and analyze data. Switching from one document to another for segregating and analyzing data is an arduous task. Usually, an origin data or start point of analysis gets lost due to improper data arrangement. Even if data is arranged in a hierarchical topography, it is difficult to analyze data by scrolling up or drilling down, specifically on small screen mobile devices. Further, it is an arduous task to switch to collaboration tools for sharing or sending the analysis results.

### BRIEF DESCRIPTION OF THE DRAWINGS

The claims set forth the embodiments with particularity. The embodiments are illustrated by way of examples and not by way of limitation in the figures of the accompanying drawings in which like references indicate similar elements. The embodiments, together with its advantages, may be best understood from the following detailed description taken in conjunction with the accompanying drawings.

FIG. 1 is a block diagram illustrating an exemplary environment including an exploration and analysis tool coupled to a collaborator for exploring and analyzing a document and sharing the analysis result, according to an embodiment.

FIG. 2A-FIG. 2G illustrate document time selection based upon various parameters, according to an embodiment.

FIG. 3A-FIG. 3G illustrates selecting a document, according to another embodiment.

FIG. 4A-FIG. 4I illustrate filtering a document based upon various parameters, according to yet another embodiment.

FIG. 5A-FIG. 5J illustrate modifying dimensions, rows, and columns of a document, according to an embodiment.

FIG. 6A-FIG. 6D illustrate various options for viewing documents in a tile pane window, according to an embodiment.

FIG. 7A-FIG. 7P illustrate a dynamic multi-select hierarchical tree selection, according to an embodiment.

FIG. 8A-FIG. 8G illustrate auto-scrolling and re-justification of row items according to user scroll actions, according to an embodiment.

FIG. 9 illustrates a view pane with an adjustable focused “field-of-view” for viewing data within a document, according to an embodiment.

FIG. 10A-FIG. 10Y illustrate a dynamic multi-select hierarchical tree selection using a view pane, according to an embodiment.

FIG. 11A-FIG. 11B illustrate a graphical representation of focused “field-of-view,” according to an embodiment.

FIG. 12A-FIG. 12J illustrate a ledger document including an explorer for exploring an identified issue, according to an embodiment.

FIG. 13 illustrates a document explored by drilling down the identified issue, according to an embodiment.

FIG. 14A-FIG. 14C illustrate a problem detector user interface (UI), according to an embodiment.

FIG. 15A-FIG. 15H illustrate a collaboration feature in a detail document level view, according to an embodiment.

FIG. 16A illustrates a user's action for returning to a home screen, according to an embodiment.

FIG. 16B illustrates the home screen, according to an embodiment.

FIG. 17 a flow chart illustrating a process of document exploration, analysis, and collaboration, according to an embodiment.

FIG. 18 is a block diagram of an exemplary computer system, according to an embodiment.

### DESCRIPTION

Embodiments of techniques for document exploration, analysis, and collaboration are described herein. In the following description, numerous specific details are set forth to provide a thorough understanding of the embodiments. One skilled in the relevant art will recognize, however, that the embodiments can be practiced without one or more of the specific details, or with other methods, components, materials, etc. In other instances, well-known structures, materials, or operations are not shown or described in detail.

Reference throughout this specification to “an embodiment”, “this embodiment” and similar phrases, means that a particular feature, structure, or characteristic described in connection with the embodiment is included in at least one of the one or more embodiments. Thus, the appearances of these phrases in various places throughout this specification are not necessarily all referring to the same embodiment. Furthermore, the particular features, structures, or characteristics may be combined in any suitable manner in one or more embodiments.

A document refers to any written, printed, or electronic matter that provides information or serves as an official record. The document may comprise a record, a report, or a file and is used for maintaining business transactions. The document may be a financial document, an operational document, etc. The financial document refers to a document or a file for maintaining financial data. In an embodiment, the financial document may be a ledger document for recording and totaling monetary transactions. In an embodiment, the ledger document includes, but is not limited to, general ledgers (GL), balance sheet, profit and loss (P&L) statements, backlogs reporting, and low level invoices, etc. The documents may be analyzed at various stages and for various issues, e.g., when sales result appears incorrect.

A problem finder refers to an application which is executed in backend to determine potential issues. The problem finder application programmatically performs “rules-based” analysis of the document (e.g., financial documents) for identifying potential errors or issues. The problem finder provides problem indications on individual data “cells” within the document. In an embodiment, the problem finder may be integrated into other applications, e.g., financial application. In another embodiment, the problem finder may be a separate application which is communicatively coupled to other applications. The problem finder enables displaying “potential problem” indications on specific financial numbers or data cell in the financial document like a spreadsheet to provide “clues” during problem-finding investigations. In an embodiment, rules-based analysis is comprised of an array of conditions, actions, parameters, and formulas that may be predefined by a user.

In an embodiment, based upon the identified problem, the investigations are performed relative to various parameters namely, but not limited to, financial time periods (e.g., Q1, Q4, March 2012, etc.) and a type of document (e.g., a GL document, P&L statement, etc.). Once values for the parameters are provided, the data within the document is filtered based upon the selected parameters and their selected values. The user can perform multiple filtrations of data based upon various parameters and/or values to investigate the problem. In an embodiment, the parameters may be referred as dimensions and the value of parameter may be referred as measure.

In various embodiments, the document may be configured in hierarchical topology. In hierarchical topology, the data within the document are arranged and can be explored in the multiple level hierarchical fashions. Therefore, the data or fields within the ledger document can be drilled down or drilled up in a hierarchical fashion. A hierarchical path may be traversed or explored during an analysis which enables a user to more efficiently and continuously manipulate paths (explore alternate paths) depending on varying thought process during investigation.

A collaborator refers to a communication tool or channel communicatively coupled to an exploration and analysis tool of the document. In an embodiment, the collaborator comprises multiple modes of communication including, but not limited to, email, short messaging service (SMS), instant messaging, corporate blogs or networks, in-app messaging, etc. In an embodiment, the collaborator may be embedded within the exploration and analysis tool. Therefore, the result or other information related to analysis can be sent, shared, or communicated to various recipients through the collaborator. In an embodiment, the result can be sent or communicated from anywhere (e.g., data cell) within the document. In an embodiment, the document screen captures can also be sent so that the recipients not conversant with complex application (e.g., accounting application) allowing the recipient to view and understand the issue.

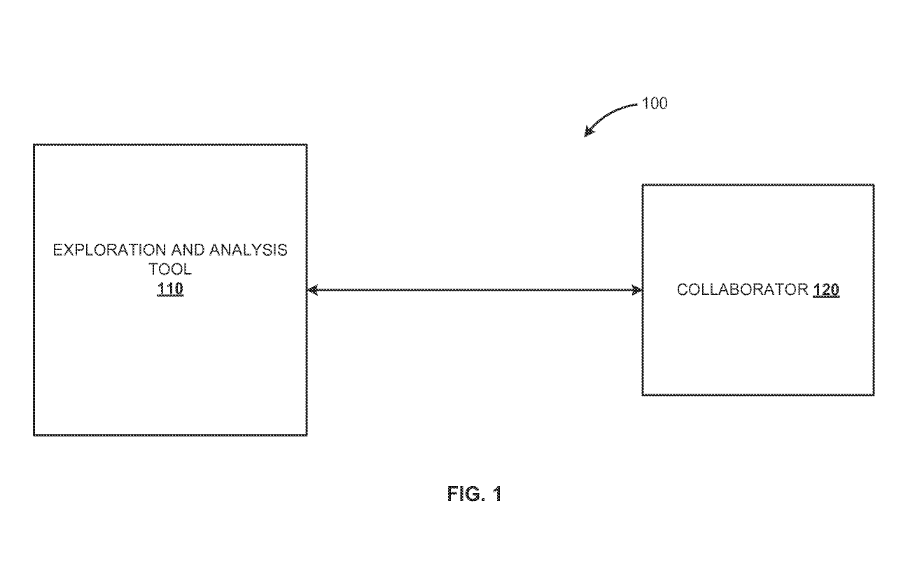

One or more embodiments described herein provide for exploring and analyzing document data and collaborating with broad range of recipients during analysis. The following exemplary embodiments illustrated with reference to FIG. 1 to FIG. 18, describe in detail the exploration and analysis tool and collaborator with reference to financial analysis. However, it should be appreciated that the embodiments can be implemented for other analysis (e.g., operational analysis) in similar way. Also, it should be understood that the embodiments can be implemented on any computing device including laptops, desktops, tablets, and other hand held devices.

FIG. 1 is a block diagram illustrating an exemplary environment 100 including an exploration and analysis tool 110 for exploring and analyzing a document (not shown). The exploration and analysis tool 110 is communicatively coupled to a collaborator 120 for sharing the analysis result to various recipients. The exploration and analysis tool 110 is a feature which enables the user to explore and analyze a document, e.g., a ledger document, in a multi-dimensional hierarchical fashion. The exploration and analysis tool 110 enables to drill down data or fields of the document in a multi-level hierarchical fashion. Various paths may be explored to discover a desired data or investigate a problem. In an embodiment, a path may comprise various navigations and selections. Once the desired result or data is explored, the result can be shared instantly and directly with various recipients through the collaborator 120. In an embodiment, the collaborator 120 enables the user to collaborate and share information related to the analysis from anywhere (e.g., any hierarchical level) within the document. The collaborator 120 is communicatively coupled to the exploration and analysis tool 110. In an embodiment, the collaborator 120 is embedded within the exploration and analysis tool 110. The collaborator 120 enables the user to send documents or other relevant information, e.g., a user interface (UI) or a screen capture to various recipients. The collaborator 120 message UI context is directly associated with analysis, e.g., the selected data cell or number. Therefore, the multi-dimensional hierarchical document can be efficiently analyzed for any issues and the analysis can be shared.

In an embodiment, an algorithm (e.g., state-of-art algorithms) is executed in backend to identify issues (e.g., variance). In an embodiment, such algorithms may be termed as ‘problem finder.’ Once the issues are identified and highlighted in the document by the algorithm, the user can drill down or explore the document to investigate the identified issues.

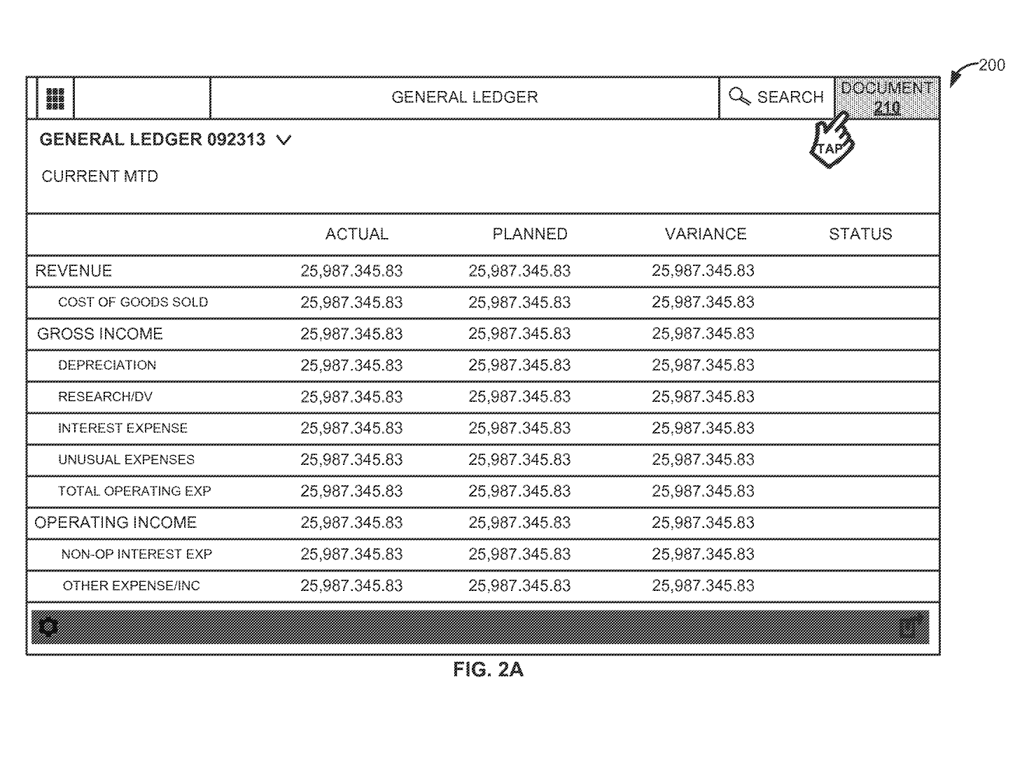

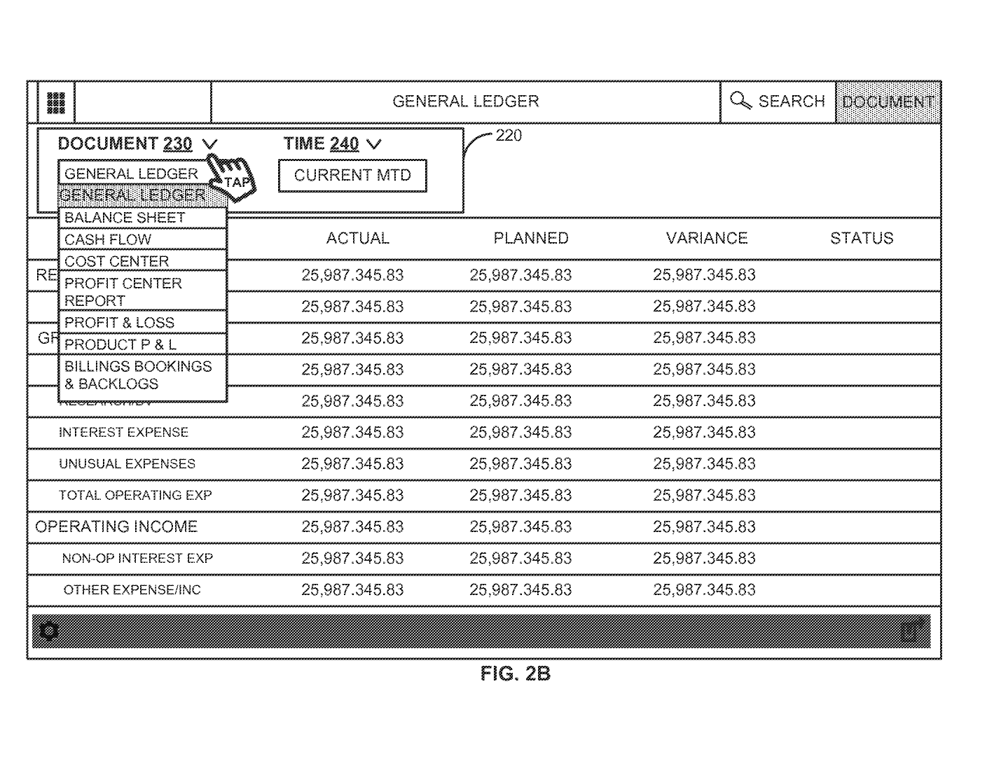

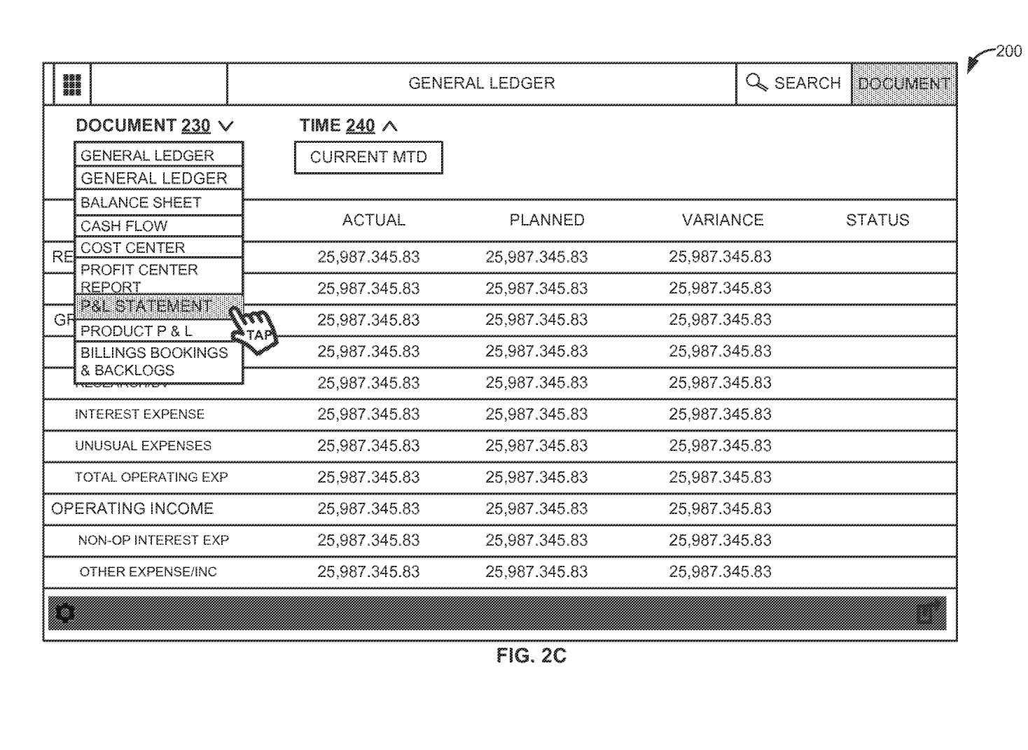

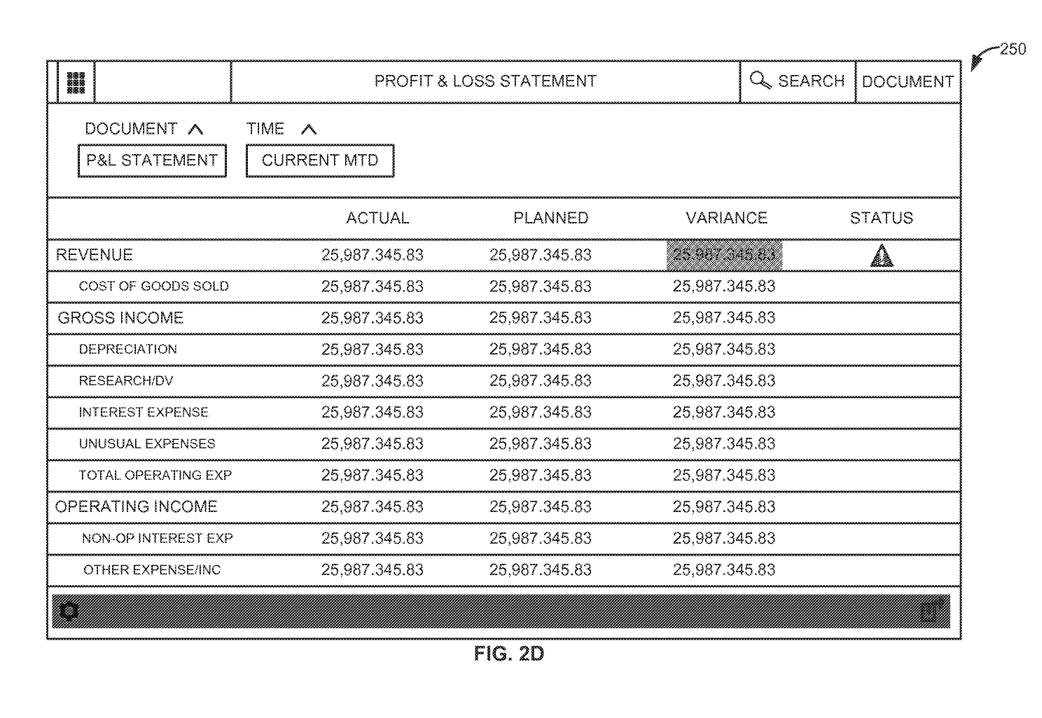

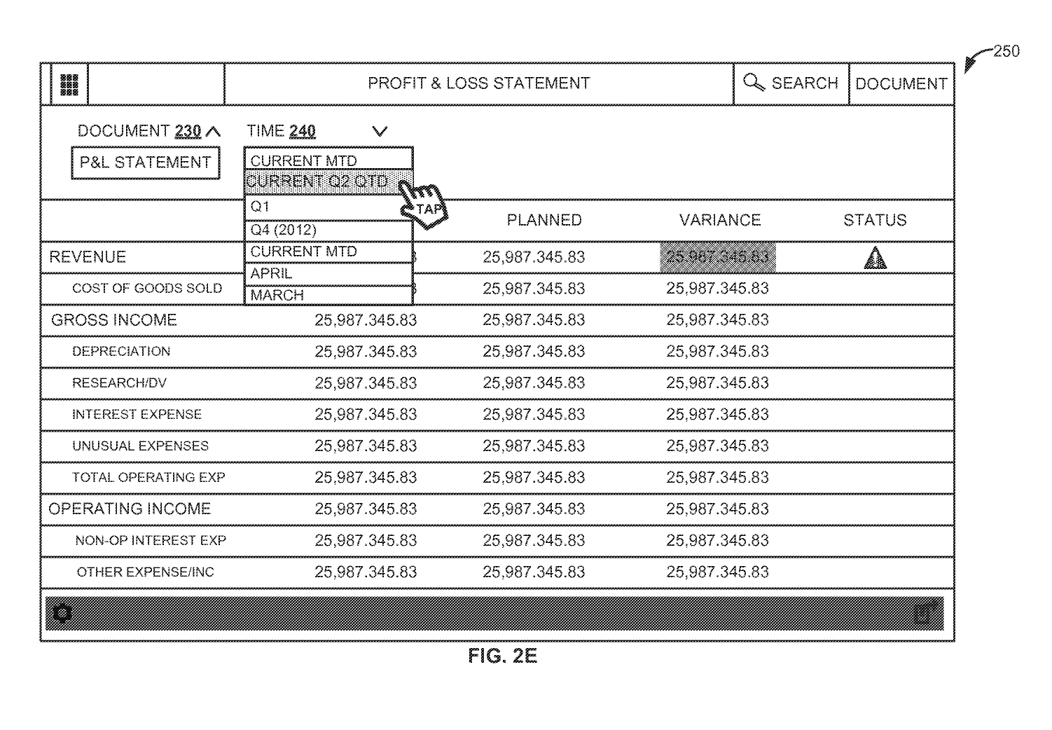

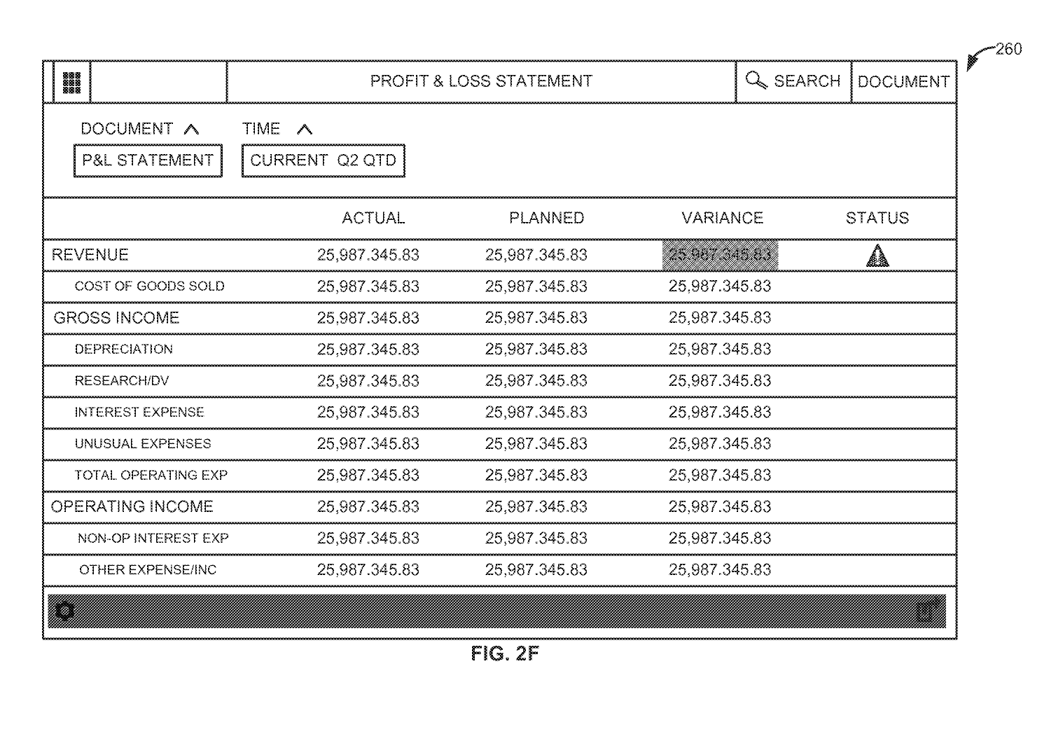

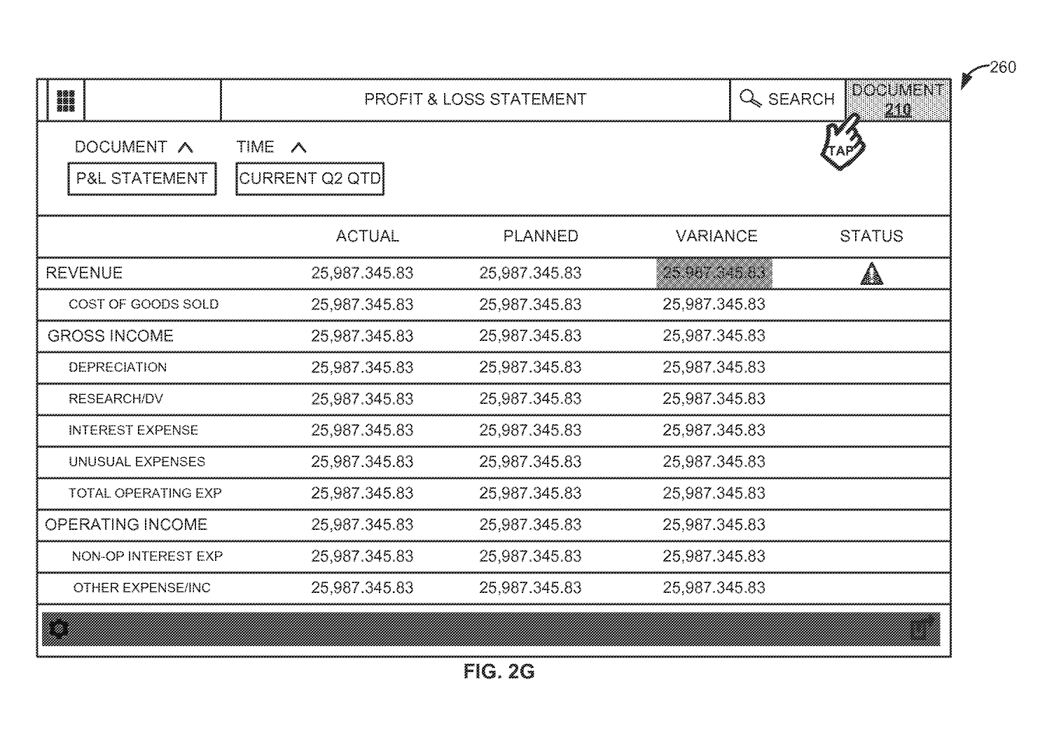

FIG. 2A-FIG. 2G illustrate selecting a documents and filtering a document based upon various parameters, according to an embodiment. In an embodiment, the document may be filtered for investigating an identified issue. In an embodiment, the document may be filtered for general investigating. Filtering the document may refer to editing values (measure) of various parameters (e.g., document type, time, etc). FIG. 2A shows a financial document 200 (General Ledger). The user may select a ‘document control button’ 210 to open a document control UI 220 (FIG. 2B) including ‘document type’ 230 and ‘time’ 240 parameters. The document control UI 220 is displayed (e.g., by sliding from under a header) when the ‘document control button’ 210 is selected (e.g., tapped). The user can select the ‘document type’ 230 and ‘time’ 240 parameters of their choice to start the investigation. Similarly, other parameters (not shown) related to the financial document 200 may optionally be displayed. The user may select the document type as ‘P&L Statement’ document from various document types options displayed in the ‘document type’ 230 dropdown, as shown in FIG. 2C. Upon selecting the ‘P&L statement’ document, FIG. 2D is displayed illustrating the selected ‘P&L statement’ document 250. In an embodiment, FIG. 2E shows the user selecting the time 240 for further filtering the selected ‘P&L statement’ document 250. The user selects the time parameter as ‘Current Q2 QTD.’ In an embodiment, the time options displayed in ‘time’ 240 are dependent on the selected ‘document type’ 230. In an embodiment, the time selections are real-time dependent (RTD) and the data within the selected document are updated in real time. FIG. 2F shows a filtered document 260 based upon the user selected parameters (time and document type). FIG. 2G shows that upon selecting the ‘document control button’ 210 again the document can be closed and the newly selected document with filter selections are displayed.

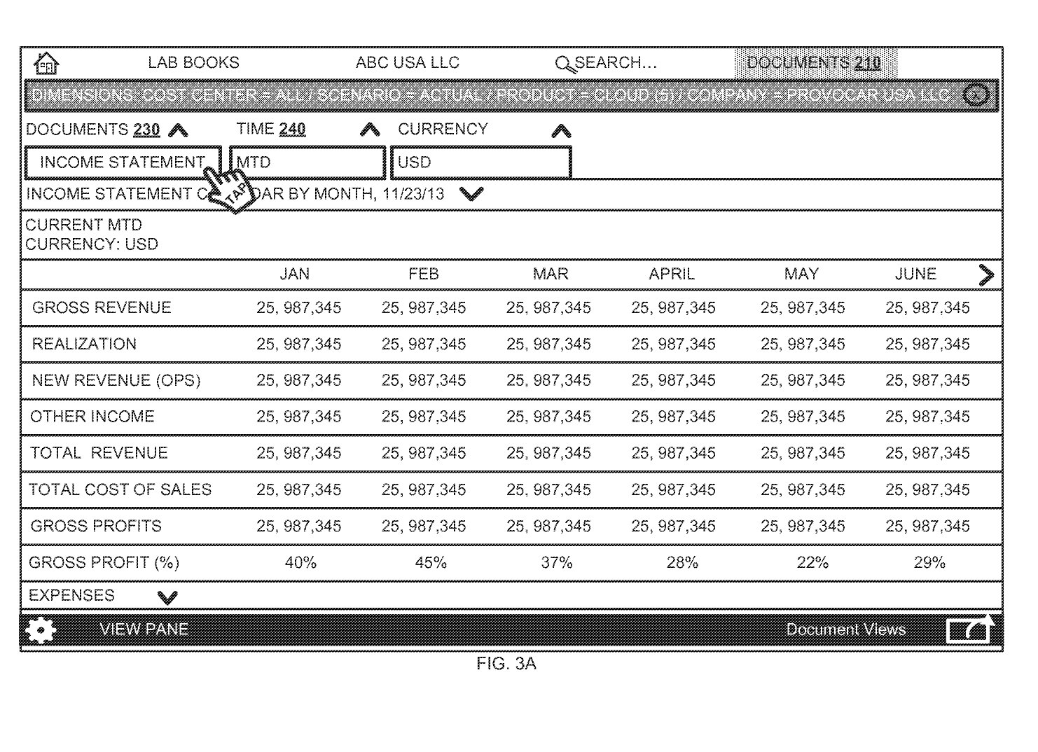

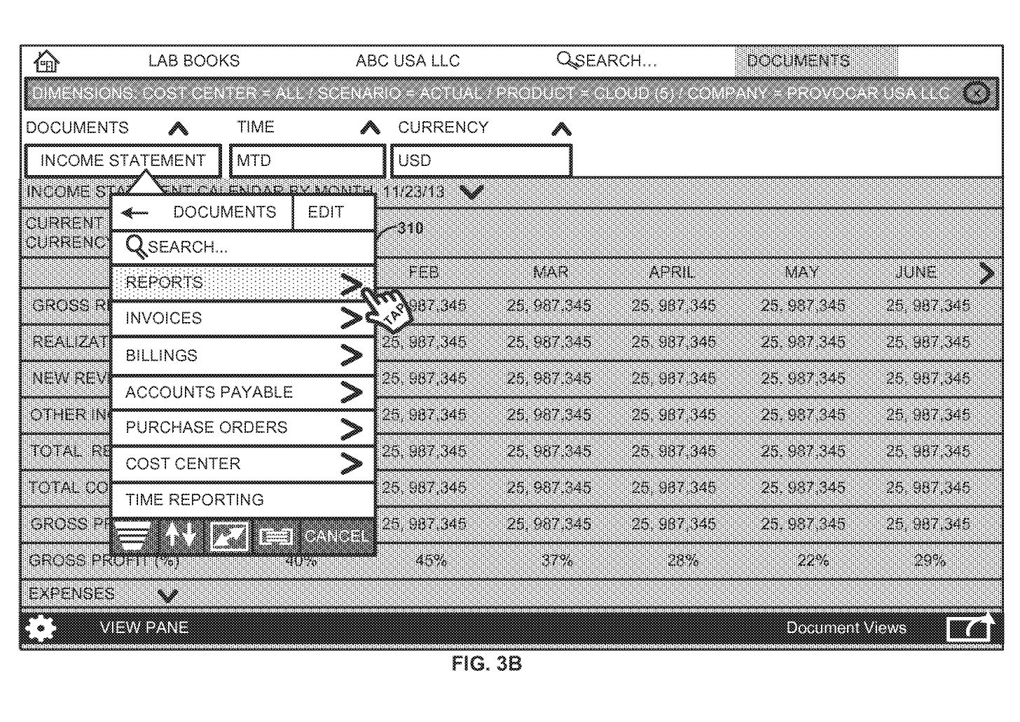

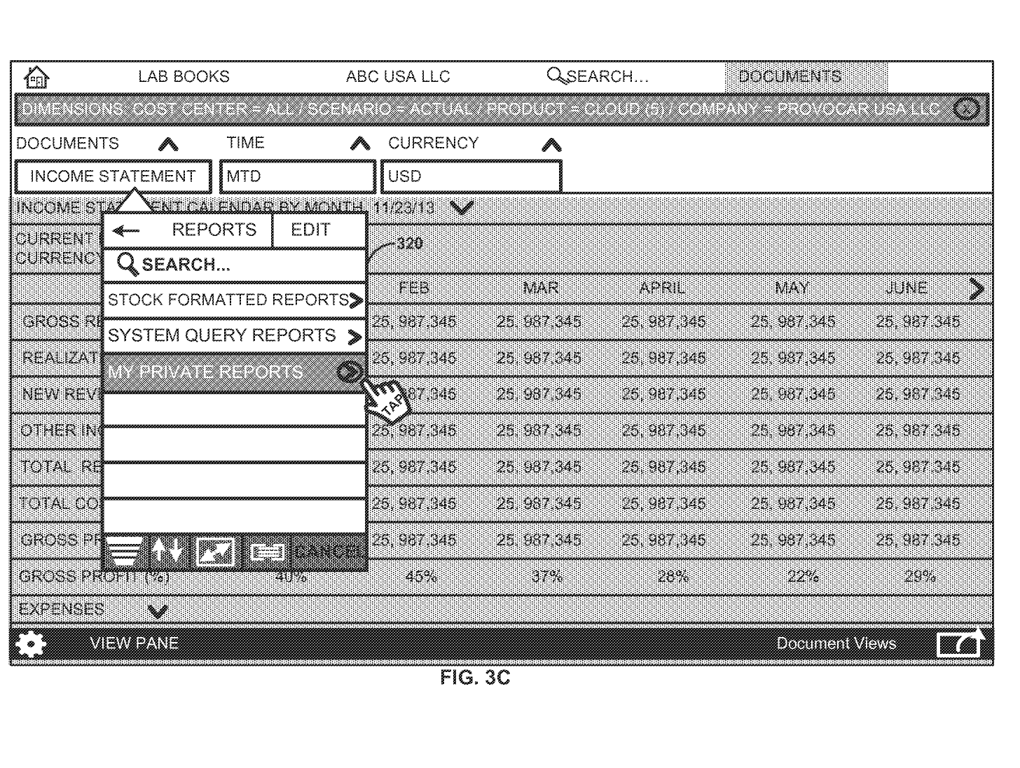

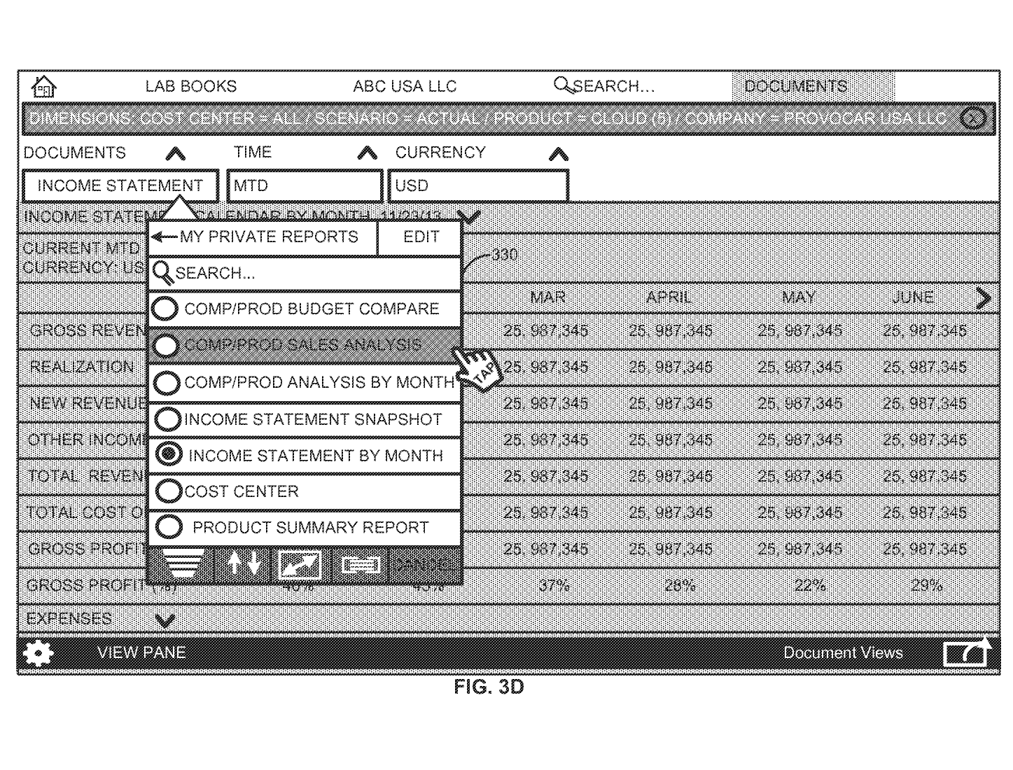

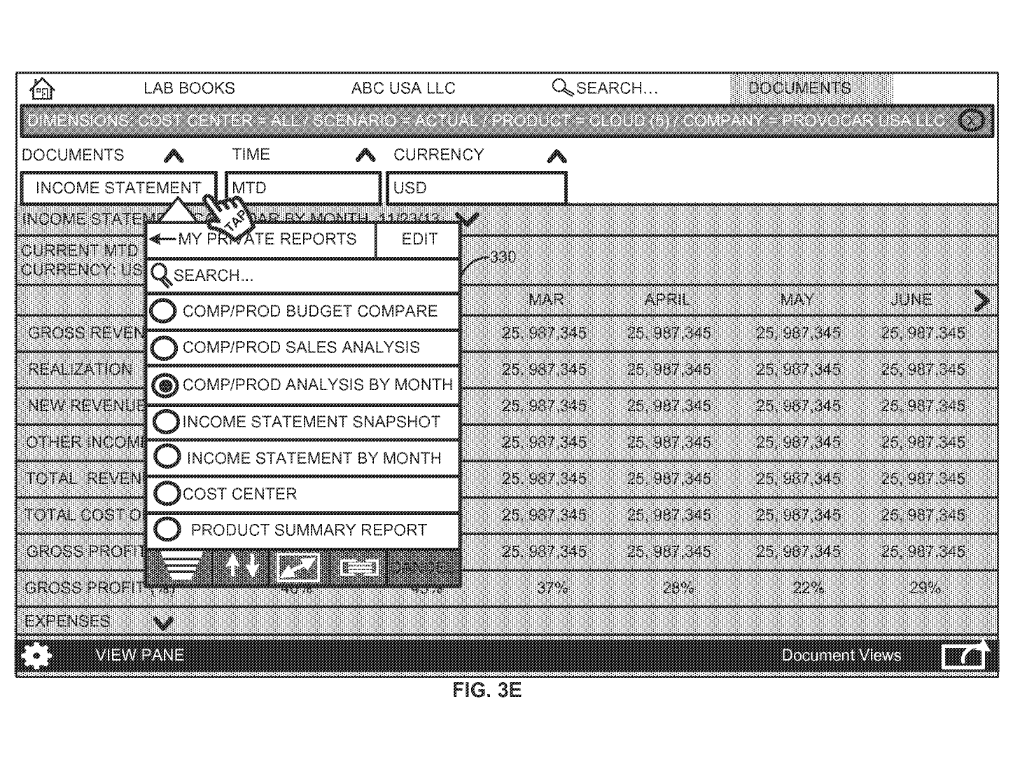

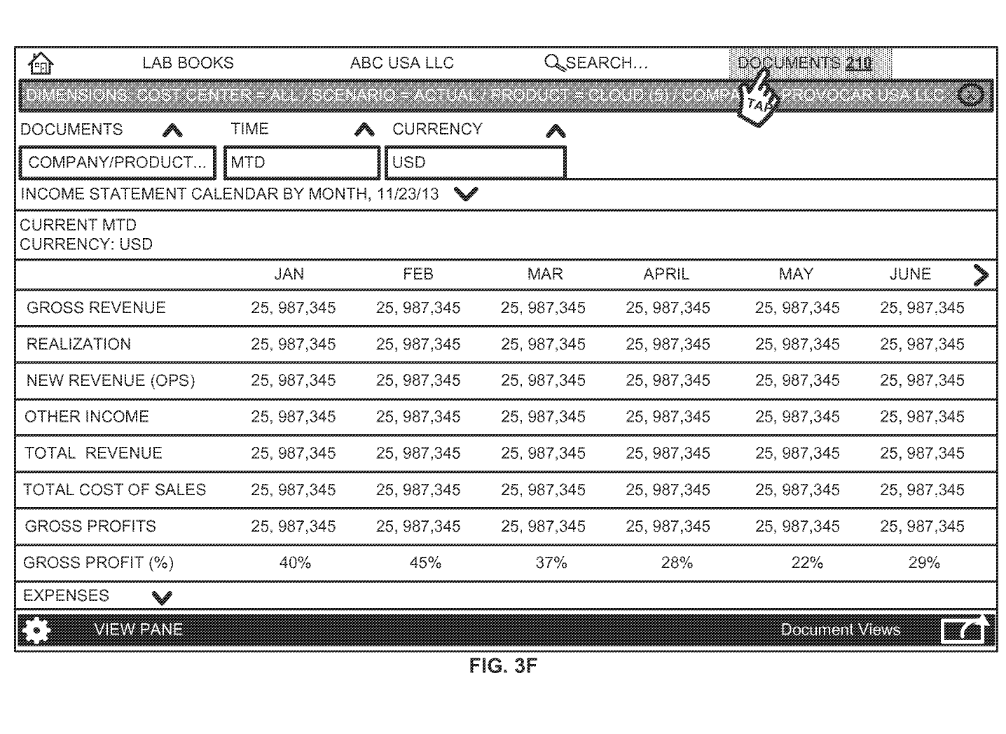

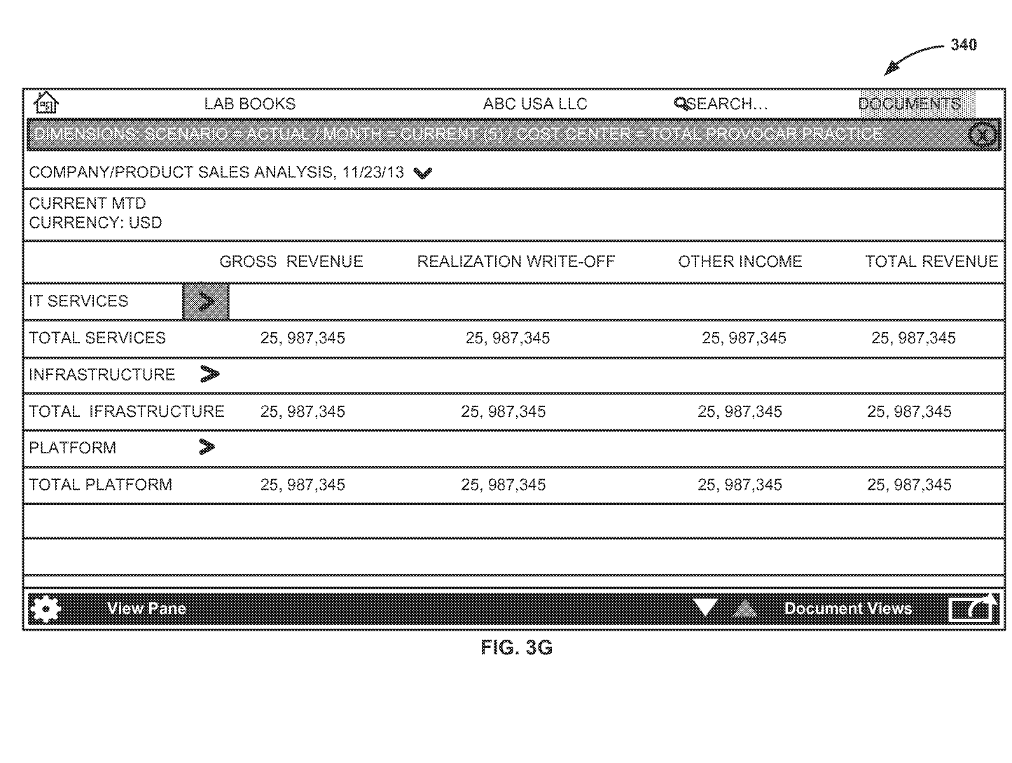

FIG. 3A-FIG. 3G illustrate selecting and filtering a document based upon various parameters, according to another embodiment. FIG. 3A shows an income statement document, according to an embodiment. For document selection, the user selects the ‘document control button’ 210. Upon selection of the ‘document control button’ 210, the ‘document type’ 230, the ‘time’ 240, and a currency parameter is displayed. The document type 230, time 240, and currency parameter has their corresponding values (measures) such as income statement, MTD, and USD. The user can edit these value/measures. The user may want to investigate problem related to another document (e.g., comp/prod/sales analysis). The document type 230 value, therefore, can be changed to display the document (e.g., comp/prod/sales analysis). For changing the document type value, the user taps on the ‘income statement,’ as shown in FIG. 3A.

In an embodiment, once the value ‘income statement’ is tapped, a menu 310 (FIG. 3B) is displayed. The menu 310 shows various types of documents, e.g., reports, invoices, billings, etc. As comp/prod/sales analysis may be stored in reports, the user selects the document of their choice, e.g., reports. In an embodiment, the document type can further include sub-categories (sub document types). In an embodiment, a GUI element such as an arrow, a pointer, etc., can be displayed adjacent the document type to indicate that it includes further sub-categories. In an embodiment, when the selected document type, e.g., reports, includes further sub-categories then another menu is displayed upon tapping on that document type or tapping on the GUI element adjacent that document type for selecting a sub document type or sub-category. For example, when the reports is selected from the menu 310, another menu 320 (FIG. 3C) is displayed. The menu 320 shows various sub-categories of reports available for selection. The user can select the type of reports of their choice, e.g., the user may select ‘my private reports.’ As shown, ‘my private reports’ further includes sub-categories indicated by arrow ‘>’ positioned adjacent ‘my private reports.’ Upon selection, another menu 330 (FIG. 3D) is displayed. The menu 330 displays reports included within ‘my private reports’ and the user can select the report of their choice, e.g., comp/prod sales analysis, as shown in FIG. 3D. Referring to FIG. 3E, after selection the user clicks on the ‘income statement’ field again and the ‘income statement’ field gets edited with the selected document ‘comp/prod sales analysis,’ as shown in FIG. 3F. When the user again taps on the document 210, an UI 340 is displayed (FIG. 3G) which displays the selected document ‘comp/prod sales analysis.’ Therefore, when the measures related to the dimension have various categories and sub-categories, the measures are arranged in a hierarchical topology and displayed under different menus based upon their hierarchical levels.

In the displayed document ‘comp/prod sales analysis,’ the user can drill down on each data field. In an embodiment, when the user taps on IT-services field, the IT-services drills down to display the companies (not shown) associated with the IT-services. In an embodiment, when the user taps on any data field or cell, a cell action menu (not shown) is displayed including options for viewing data by customer, viewing data by product, annotating data, and to perform various other actions on the data. In an embodiment, a page down button (not shown) and page up button (not shown) may be provided on the UI to scroll down/up to move from one opened (viewed) document to another. For example, when the page down button is tapped, the previously opened document ‘income statement’ is displayed and when the page up button is tapped, again the document ‘comp/prod sales analysis’ is displayed.

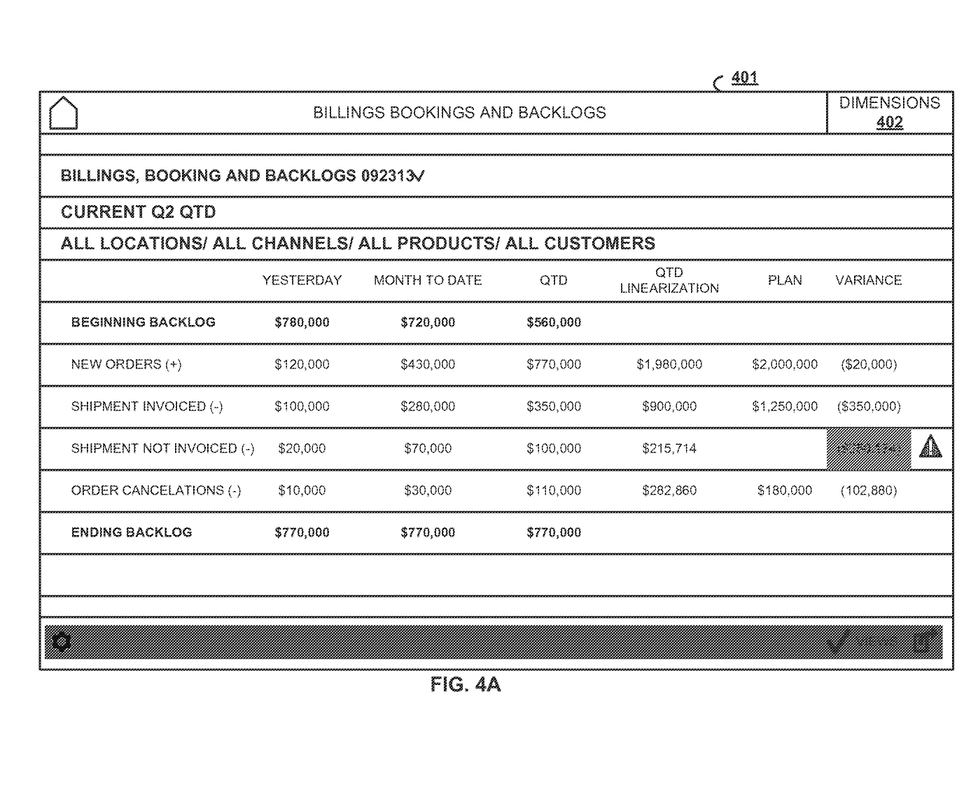

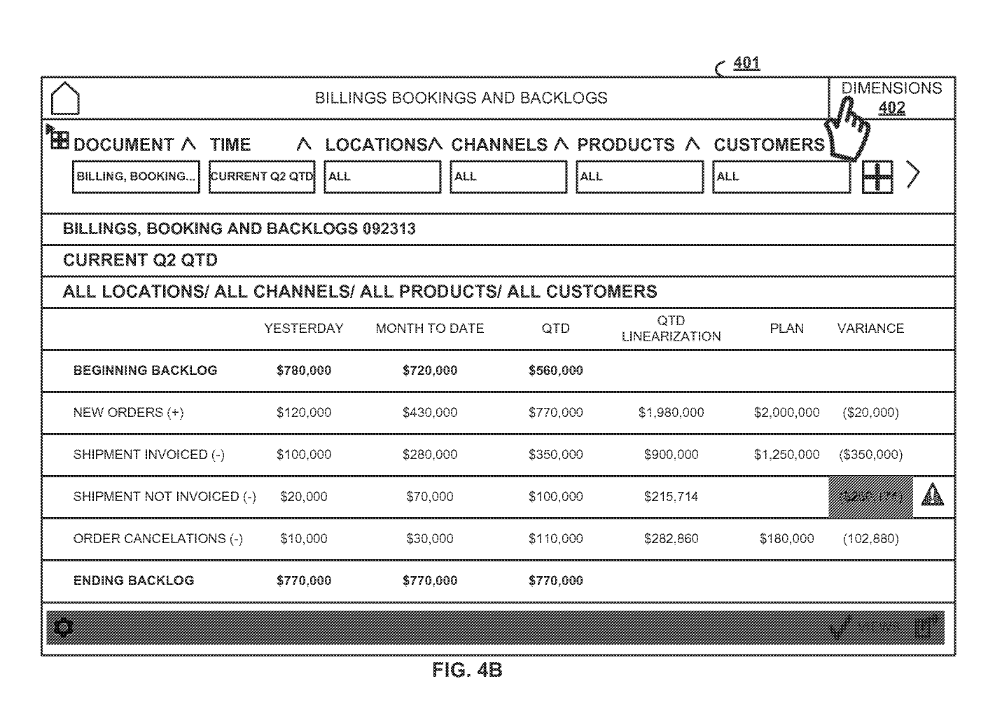

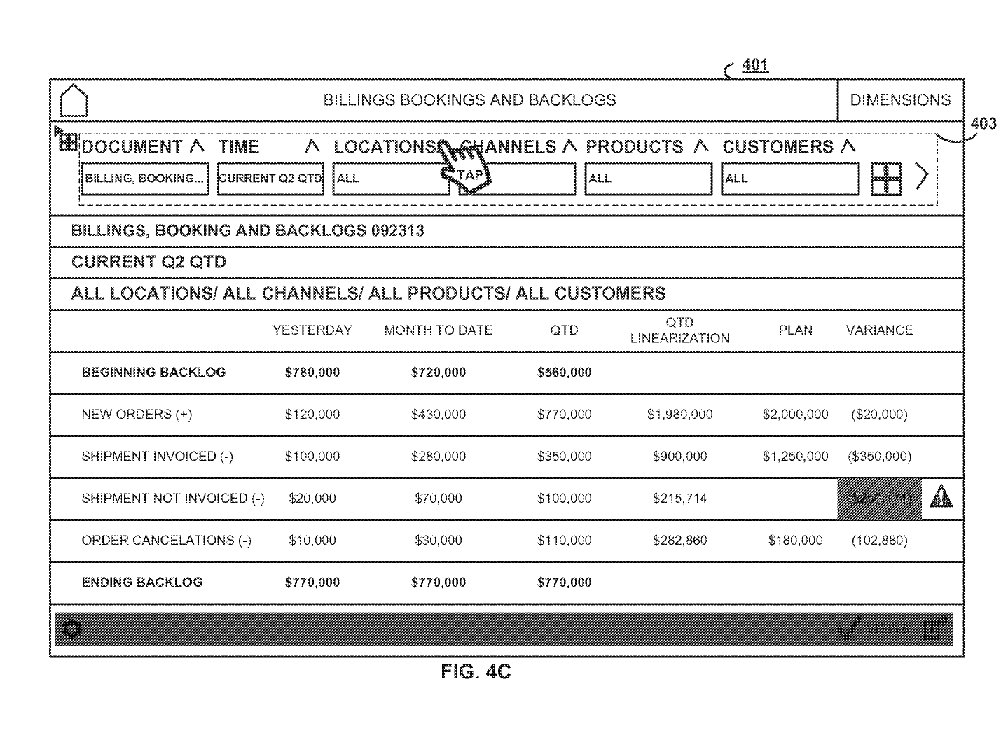

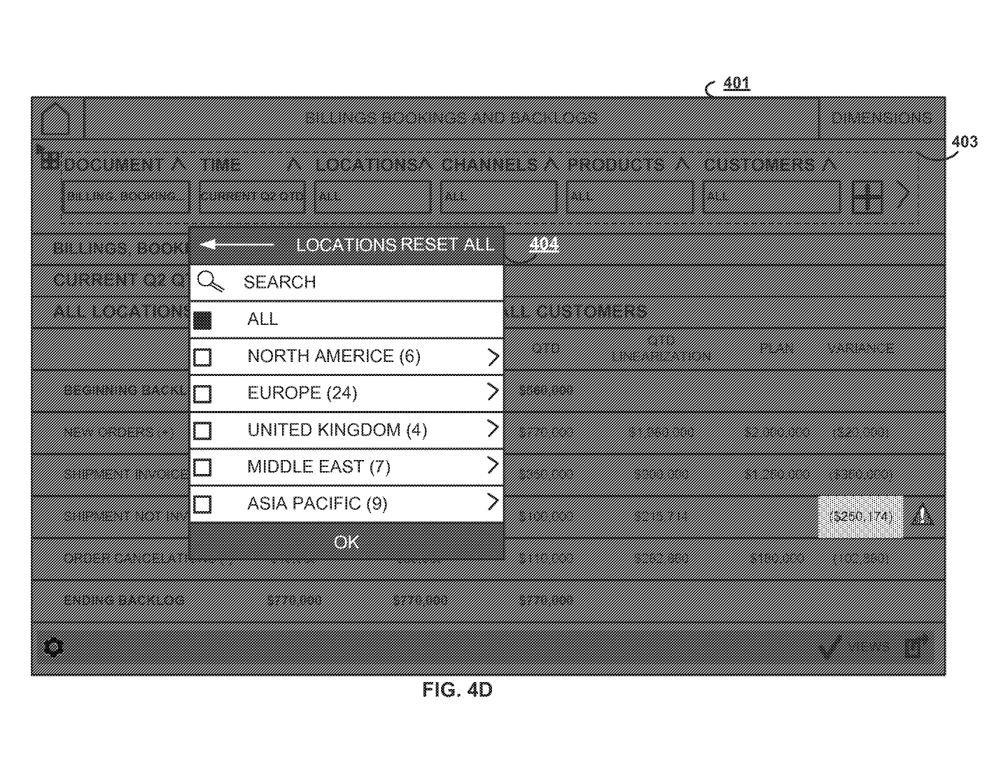

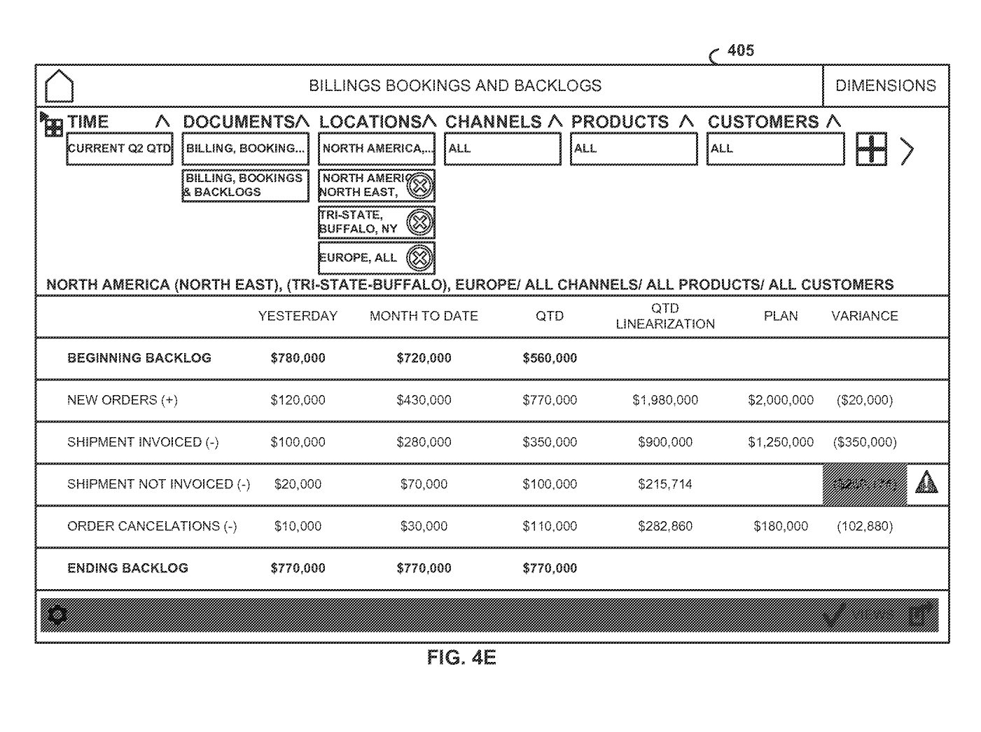

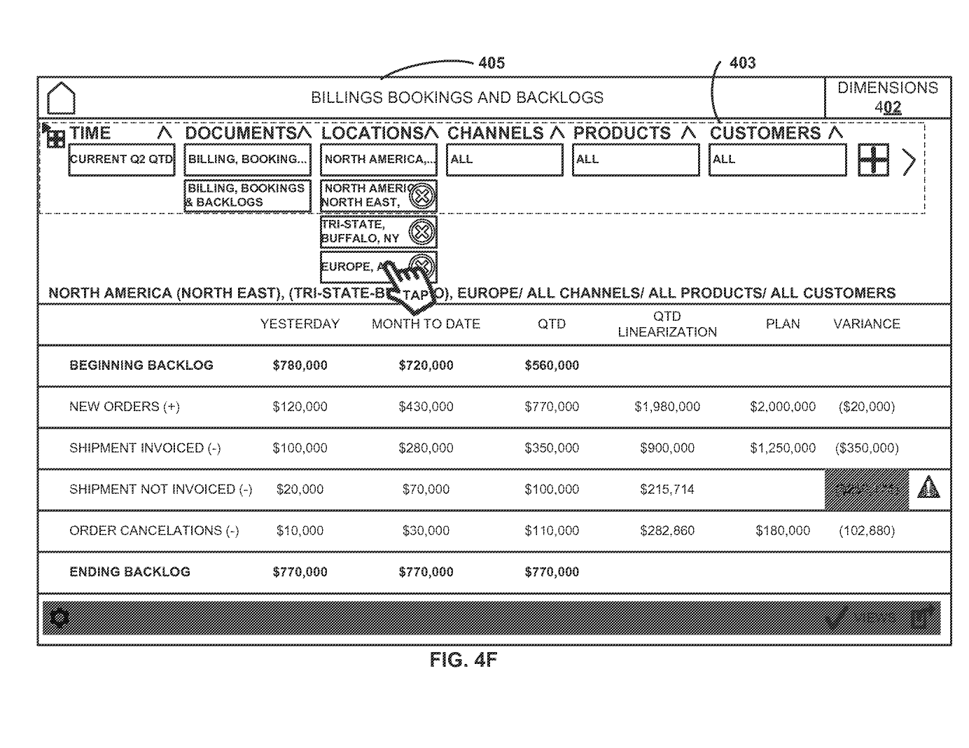

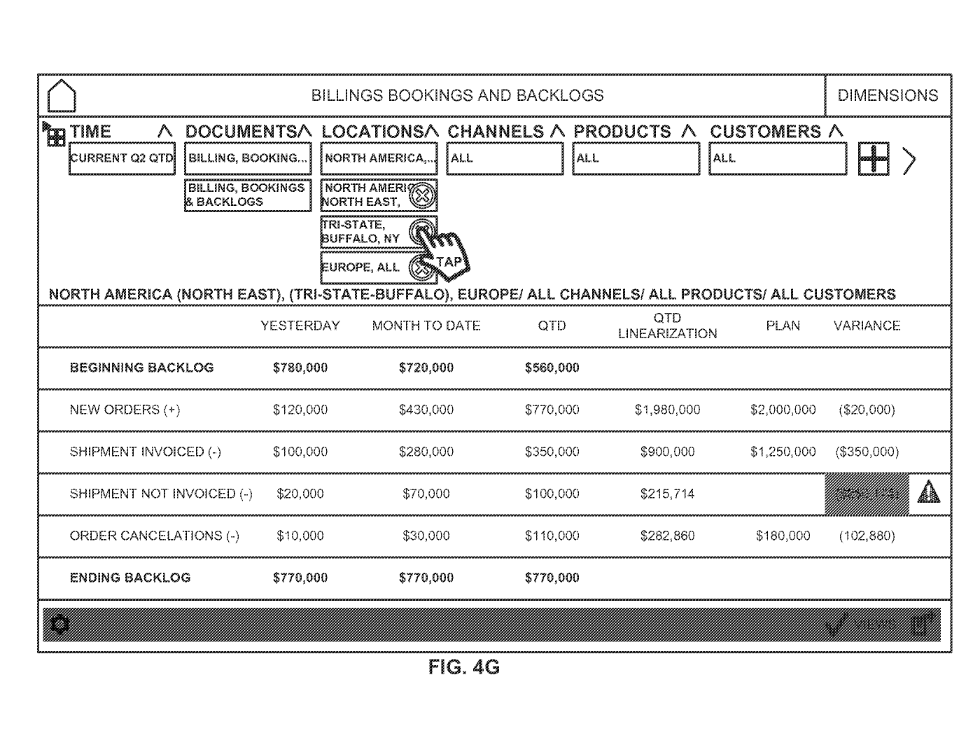

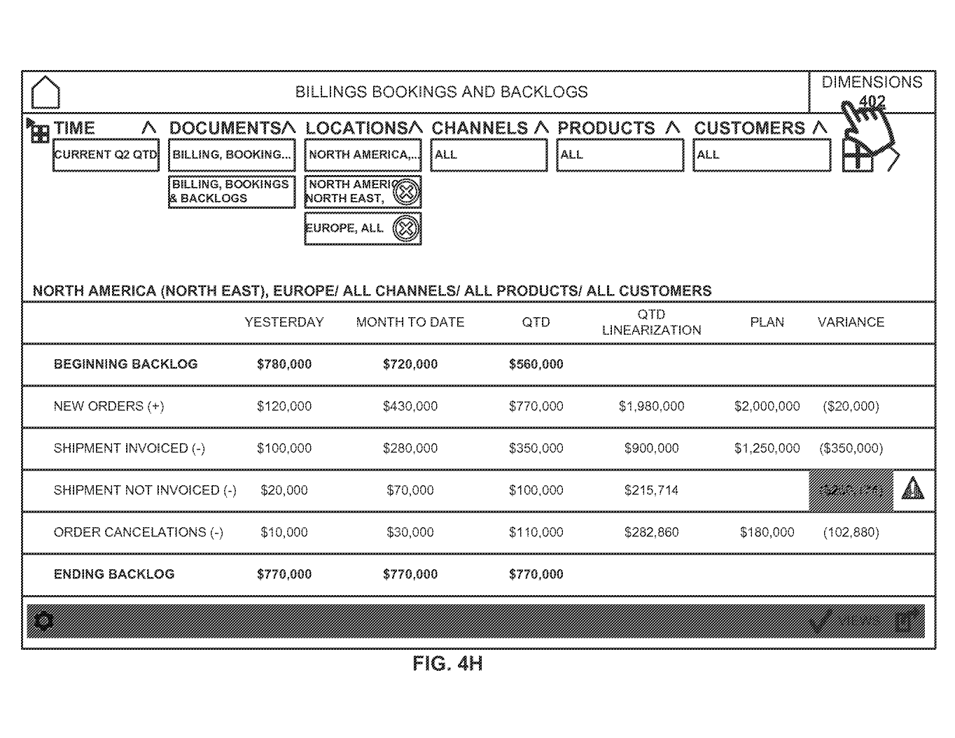

FIG. 4A-FIG. 4I show filtering a document based upon various parameters, according to yet another embodiment. In an embodiment, filtering is illustrated by multiple drill-down of dimensions and measures selected from a “global” control that affects the financial data displayed within the document without changing/affecting the “format” row and columns of the document or without changing the document type. The data within the document are updated to reflect selected dimensions and measures. FIG. 4A shows a report 401 namely ‘Billings, Bookings and Backlogs.’ In an embodiment, the report 401 is displayed when the user selects the ‘Billings, Bookings and Backlogs’ tile (not shown) from the home screen (not shown). In the displayed report 401, a dimension button (dimensions 402) is provided which may be similar to the ‘document control button’ 210 (FIG. 2A) and which when selected displays various selected dimensions and their corresponding measure. When the user selects the dimensions 402 (FIG. 4B), a dimension control 403 is displayed at the top of the report 401, as shown in FIG. 4C. The dimension control 403 displays various dimensions and their corresponding measure. Referring to FIG. 4C, the user selects a ‘location’ dimension from the dimension control 403. Upon selecting the ‘location’ dimension, a hierarchical measure UI popover 404 is displayed to select desired location parameter for the report 401 (FIG. 4D). When the user selects “ALL”, i.e., “ALL” locations, the report 401 gets filtered based upon the selected measures, e.g., the selected locations and the filtered report is displayed. For example, if user selects locations as North America, Tri State, and Europe All, then a filtered report 405 is displayed (FIG. 4E).

Therefore, the dimension and/or measure can be changed using one-click operation. For example, disabling or removing the measure from a control display (e.g., a dimensional control 403) can be performed in one click. FIG. 4F shows latest user selections of dimension control measures. For example, measure for dimension “Time” is selected as “Current Q2 QTD.” for dimension “document” is selected as “Billing, Booking, and Backlogs.” and for dimension “location” is selected as “North America, North America North East, Tri State, and Europe (All).” In an embodiment, the selected dimension control measures is highlighted, e.g., in blue. FIG. 4F shows that when the user taps or clicks on the “Europe All” measure, the highlighting is removed which shows that this measure is no longer selected or represented in the data table. When the user selects the “Tri-State” measure delete button (e.g., by selecting ‘X’), as shown in FIG. 4G. The “Tri-State” measure is no longer displayed nor represented in the data table of the document, as shown in FIG. 4H. After the user closes the dimension and measure control (e.g., dimension control 403), it retracts upward and the financial table data is displayed without the dimension control on-screen, as shown in FIG. 4I.

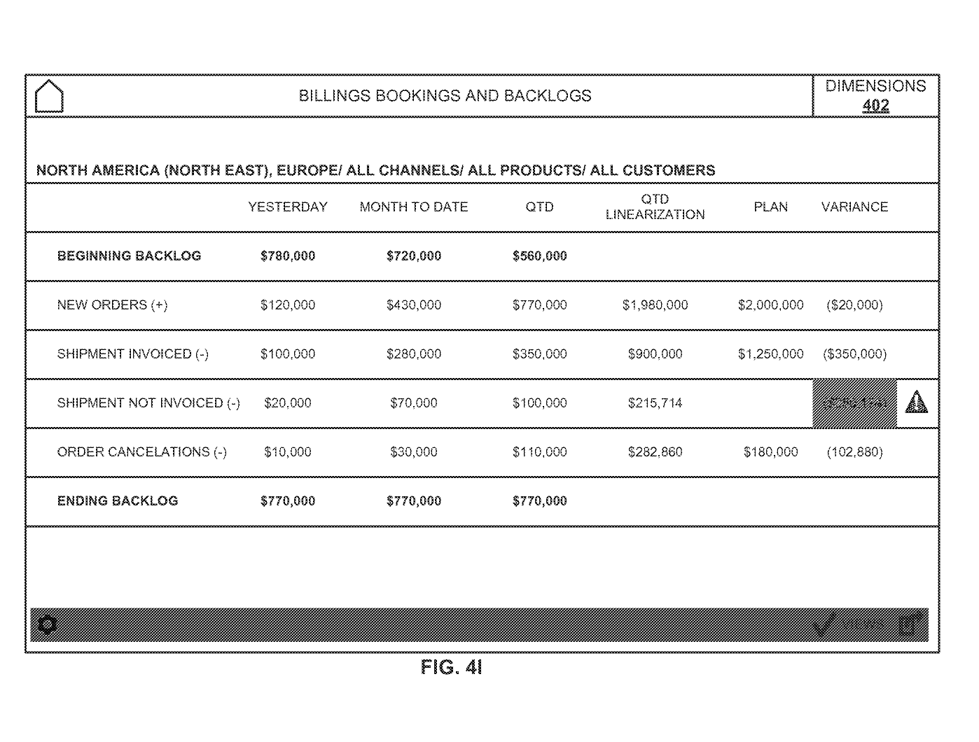

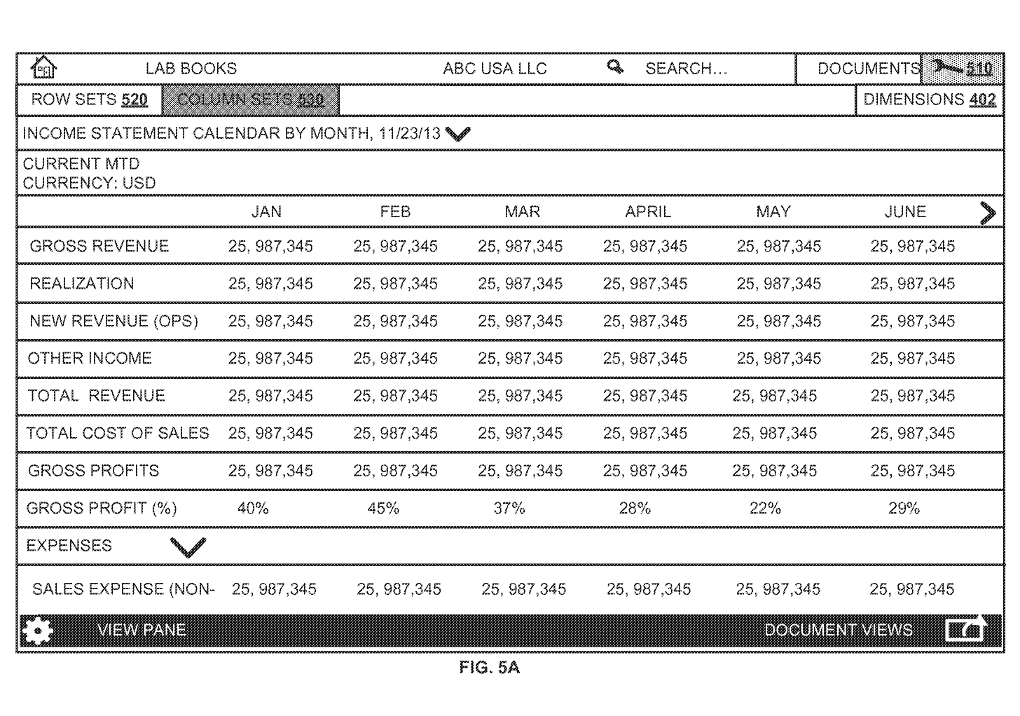

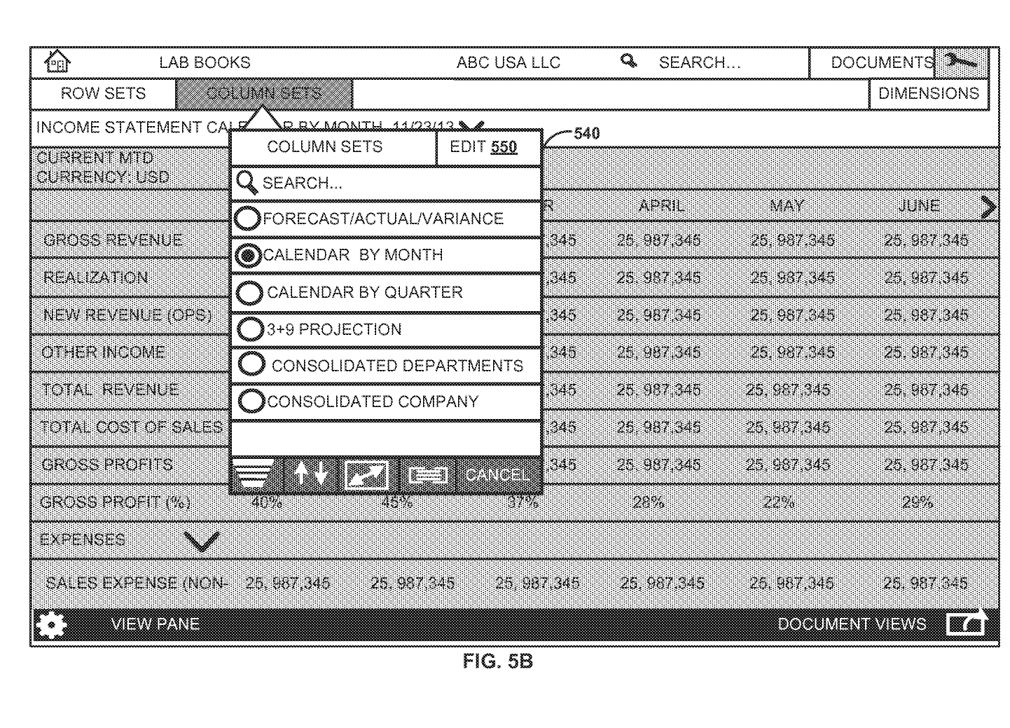

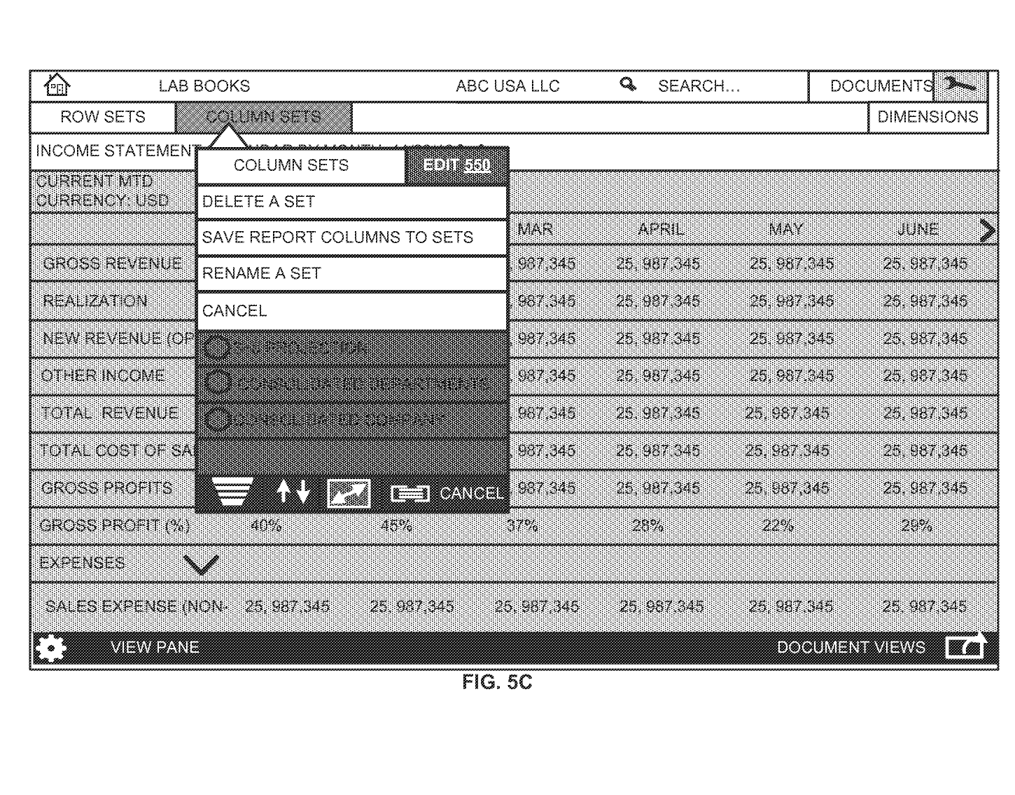

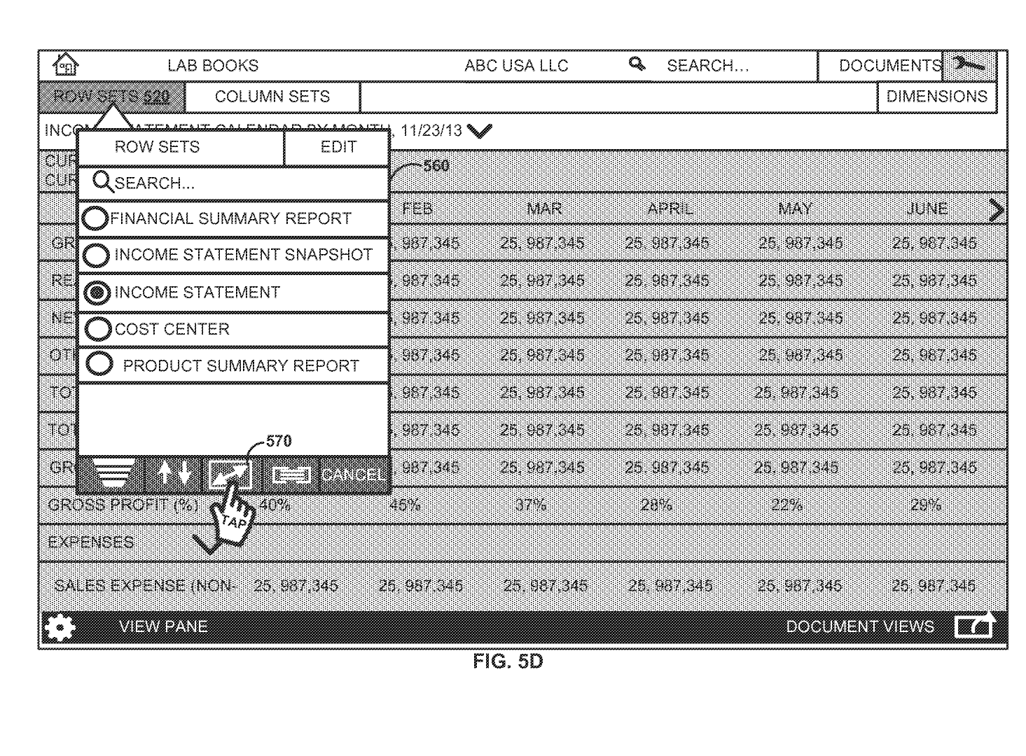

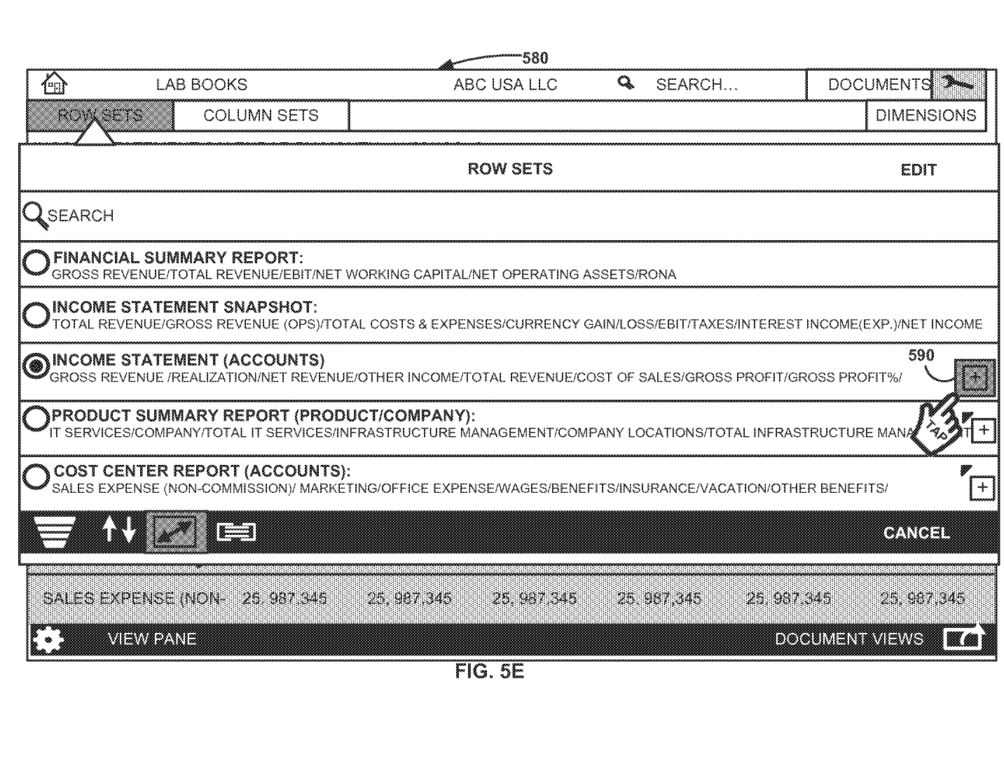

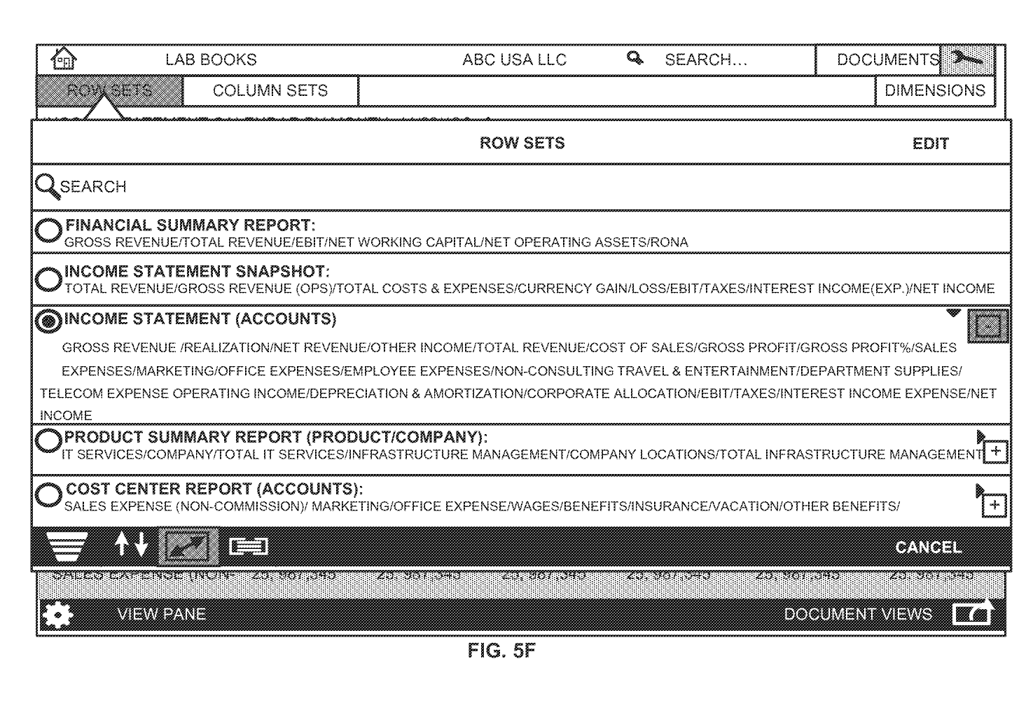

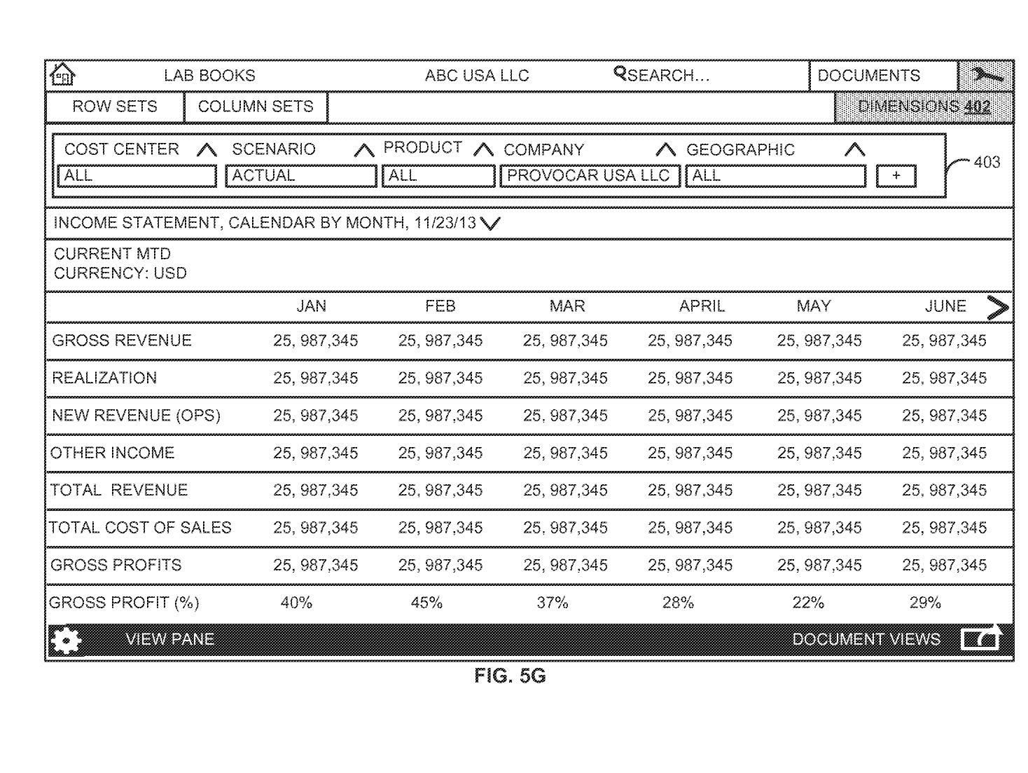

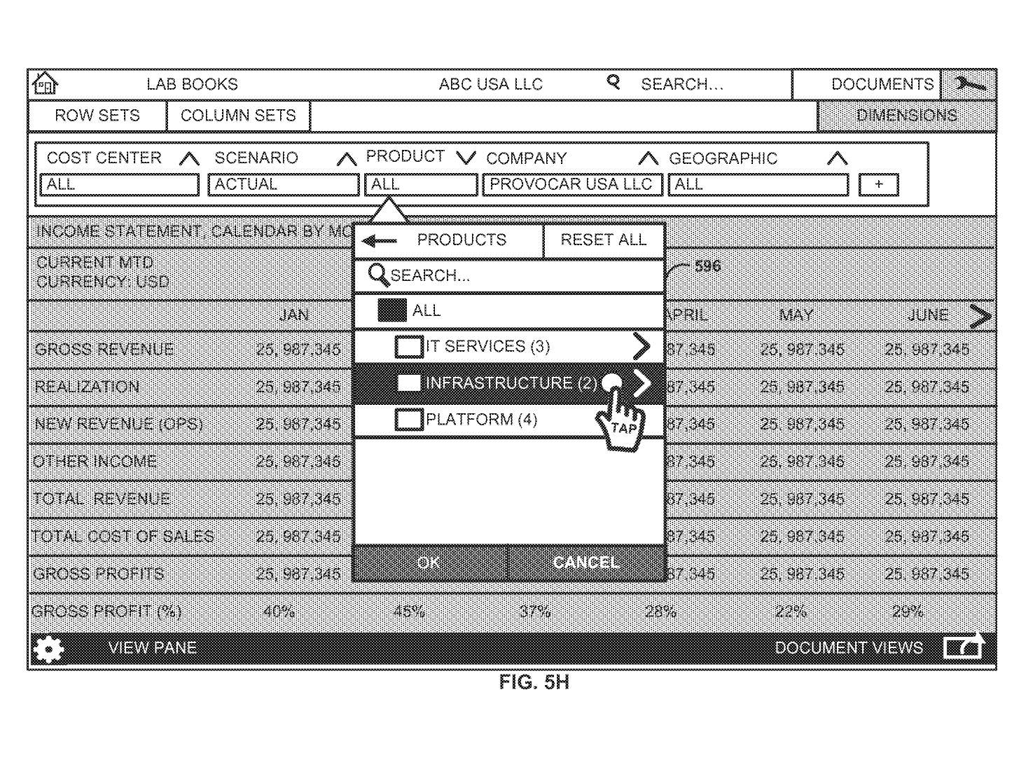

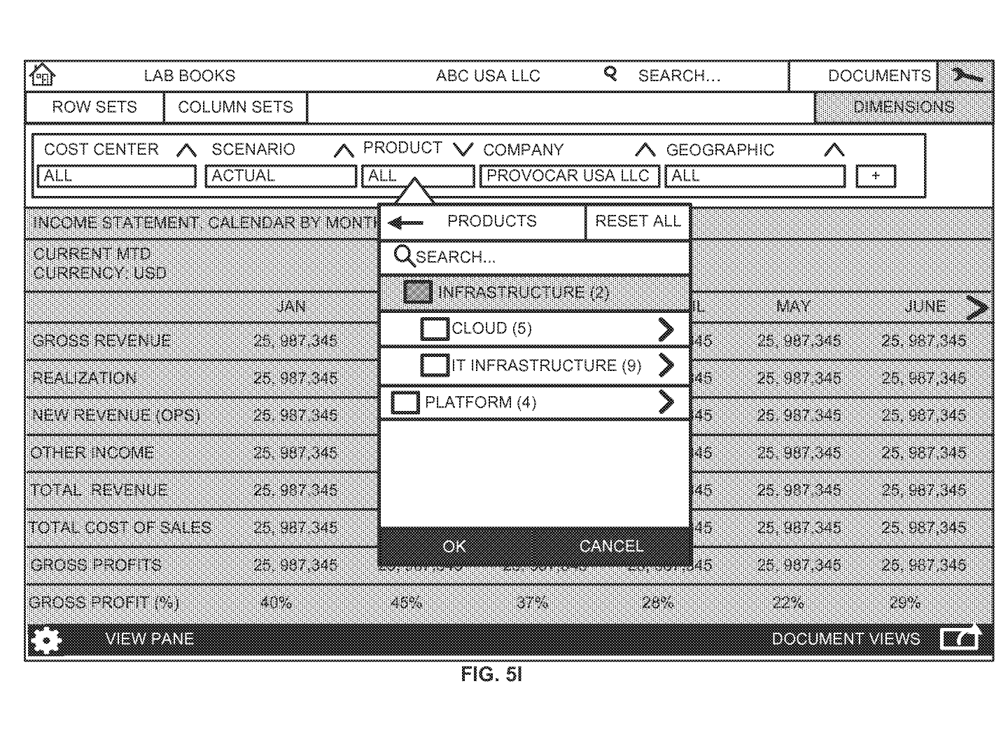

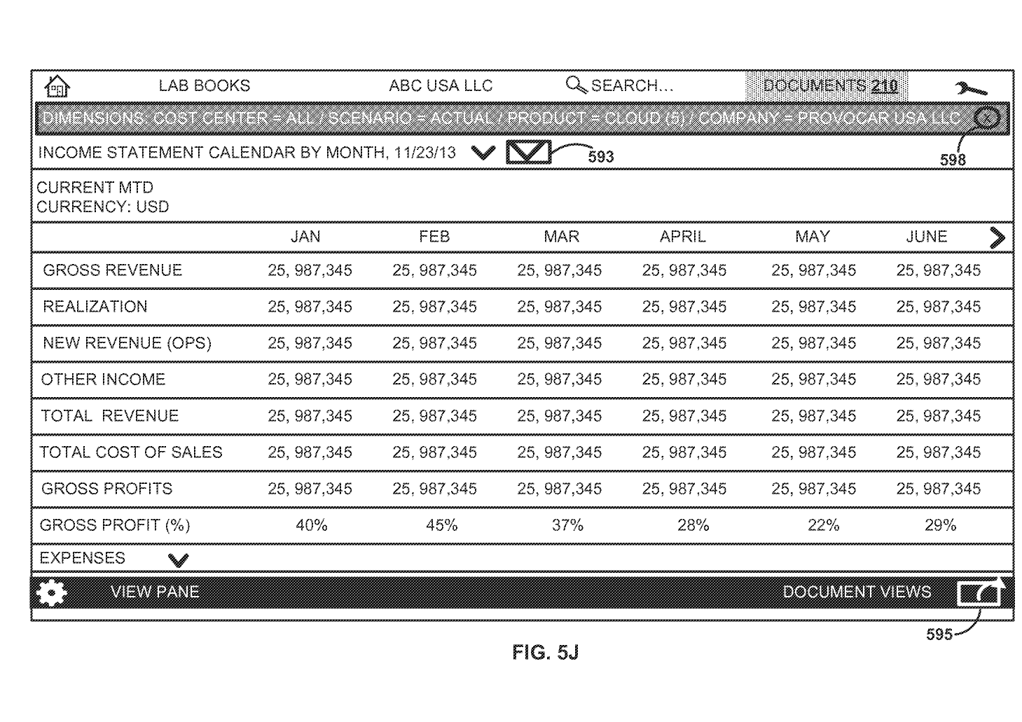

FIG. 5A-FIG. 5J show modifying dimensions, rows, and columns of the document or report, according to an embodiment. In an embodiment, referring to FIG. 5A, a document or report includes a tool icon 510 to modify dimensions, rows, and columns of the report. When the user taps on the tool icon 510, a row sets 520, a column sets 530, and the dimensions 402 is displayed. The row sets 520 is used for modifying the rows of the report, the column sets 530 is used for modifying the columns of the report, and the dimensions 402 is used for modifying the dimensions. When the column sets 530 is clicked, a column sets menu 540 (FIG. 5B) is displayed. The column sets menu 540 includes various types of column sets (options) in which columns of the report can be displayed, e.g., displaying columns as ‘calendar by month’ or displaying columns as ‘columns by quarter,’ etc. The column sets menu 540 also includes an edit button 550. When the edit button 550 is tapped, various options are displayed for editing the selected column set, e.g., deleting the selected column set such as ‘calendar by month’ column set, renaming the column set, saving the columns of report as column set, as shown in FIG. 5C.

Similarly, when the user taps on the row sets 520, a row set menu 560 (FIG. 5D) is displayed. The row set menu 560 shows various types of ‘rows sets’ available, e.g., ‘cost center’ row set which includes one or more fields or rows related to cost center, ‘income statement’ row set which includes one or more fields or rows related to income statement, etc. In an embodiment, the user may select an expand icon 570 from the row set menu 560 to see expanded row sets 580 (FIG. 5E). The expanded row sets 580 show various row sets and their corresponding rows/fields. In an embodiment, when the number of fields corresponding to a row set is large in number, an expand button 590 may be clicked to view all the fields of the row set, as shown in FIG. 5F.

Referring to FIG. 5G, when the user taps on the dimensions 402, the dimension set 403 is displayed. The dimension set 403 shows various dimensions related to the displayed report. For example, when the report is ‘income statement,’ the dimensions can be cost center, scenario, product, company, and geographic, etc. The dimension has its corresponding value (measure), e.g., the dimension ‘company’ has measure ‘ABC USA LLC,’ therefore, the report includes income statement data related to the company ‘ABC USA LLC.’ In an embodiment, the user can change the measure by clicking on a measure field. Upon clicking on the measure field, a menu corresponding to the measure's dimension is displayed. For example, a menu 596 (FIG. 5H) is displayed upon clicking on the measure field ‘all’ corresponding to the ‘product’ dimension. The menu 596 includes various measures or values related to the ‘product’ dimension. The user can select the measure of their choice and the report is edited accordingly.

In an embodiment, the menu 596 includes measures (e.g., product categories) in hierarchical arrangements. A number displayed adjacent the measure (product category) indicates a number of sub-categories included within that product category, e.g., infrastructure (2) indicates that infrastructure product includes two sub-categories. When a category is selected, the sub-categories included within the selected category are displayed. For example, when product category ‘infrastructure’ is selected, the two sub-categories (cloud and IT infrastructure) included within the product category ‘infrastructure’ is displayed, as shown in FIG. 5I. When the user taps on the dimensions 402 again, the dimension set 403 disappears and the selected dimensions are displayed at the top of the report, as shown in FIG. 5J. The displayed dimensions can be closed by tapping on a cross button ‘X’ 598.

In an embodiment, the report, e.g., ‘income statement,’ includes a drop-down GUI 593 which when selected displays an action menu (not shown) which includes options for saving the report, such as ‘save as my reports,’ ‘save as system reports,’ ‘save as lab book,’ renaming the report, annotating the report, etc. In an embodiment, when ‘save as’ option, e.g., ‘save as my reports’ is selected, a pop-up (not shown) is displayed for entering name of the report and saving it. In an embodiment, the report also includes a post tab 595 which when selected, displays a menu (not shown) which includes options for sharing, posting, or sending the report such as send copy, email as pdf, export to Microsoft Excel®, share on any communication medium, etc.

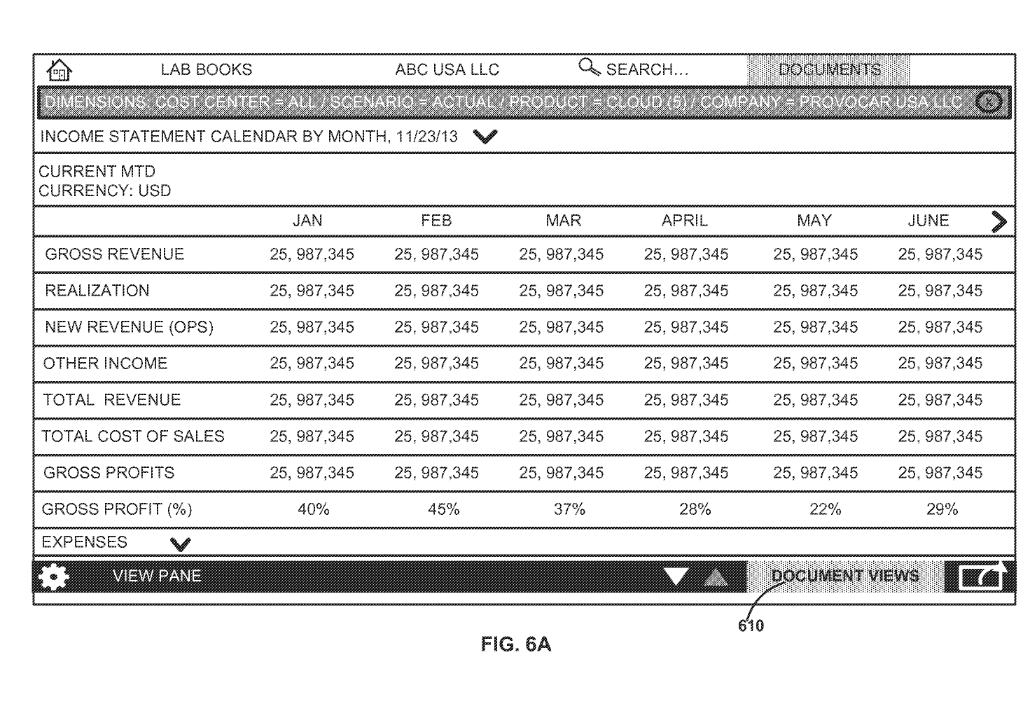

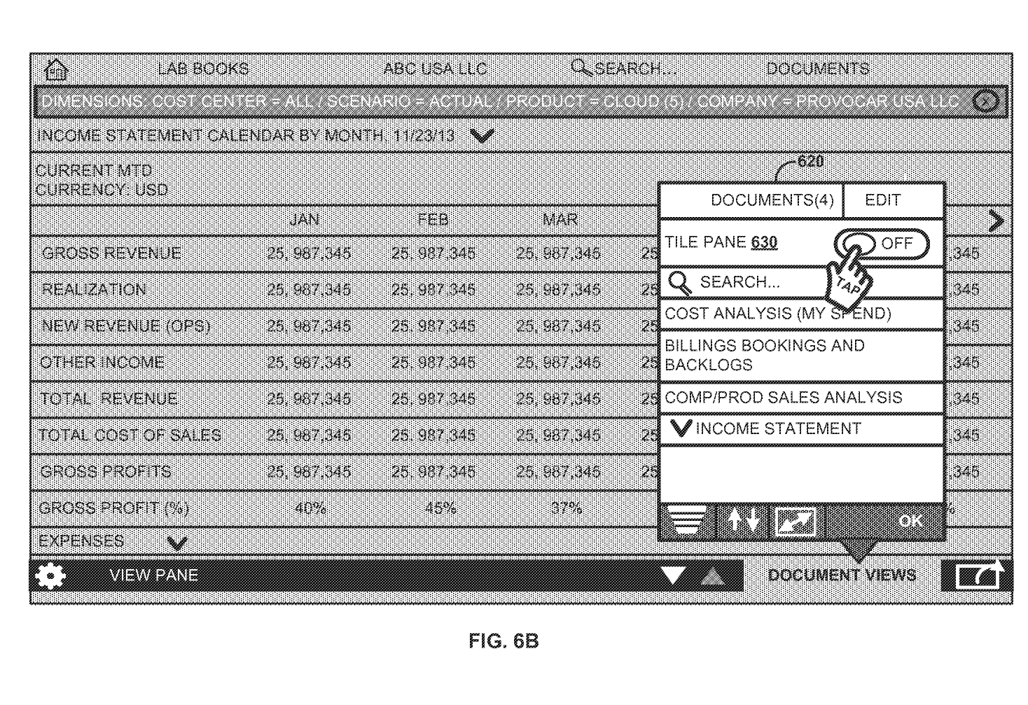

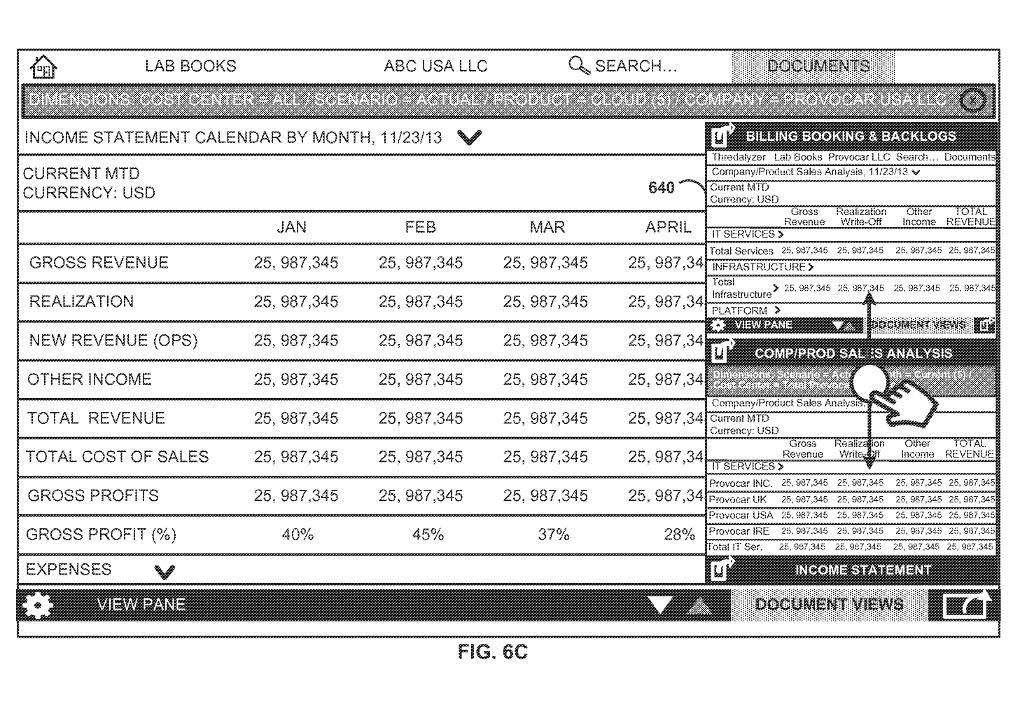

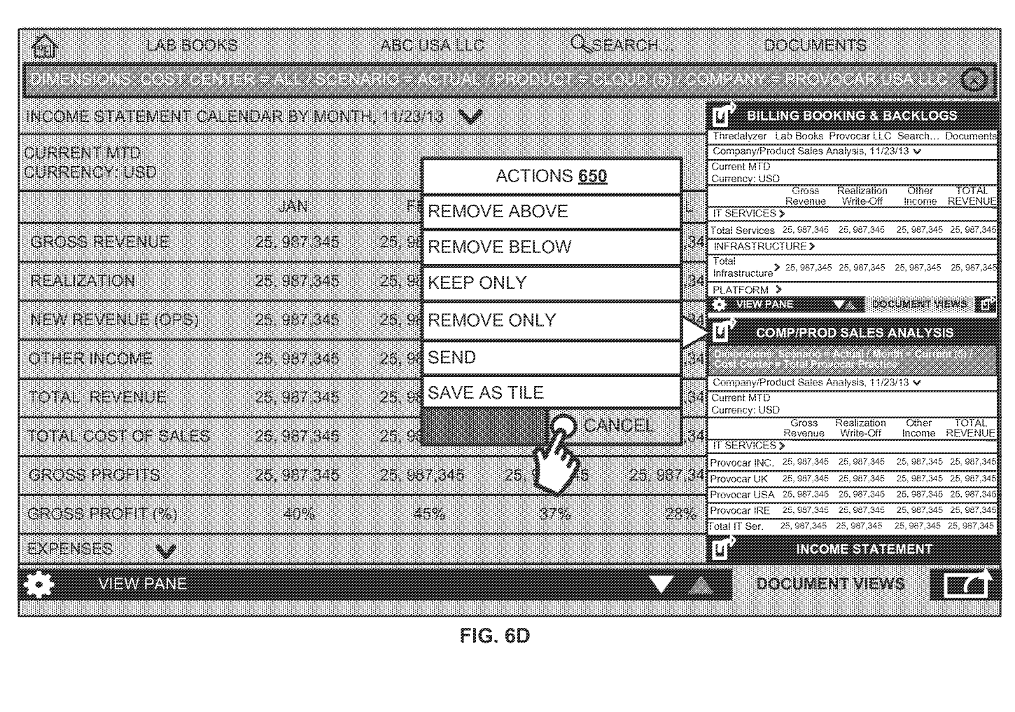

FIG. 6A-FIG. 6D show various options for displaying viewed documents in a tile pane window. Referring to FIG. 6A, when the user clicks on a document view tab 610, a document view menu 620 (FIG. 6B) is displayed. The document view menu 620 shows the documents or reports opened and viewed and also include an option ‘tile pane’ 630 which can be selected (ON) or de-selected (OFF). When the ‘tile pane’ is ON, the viewed documents are shown in a tile pane window 640 (FIG. 6C), one above another. The selected document of the tile pane window 640 is displayed on the left hand side (LHS) of the screen, e.g., ‘income statement’ document is displayed on the LHS. In an embodiment, the selected document (e.g., income statement) may be highlighted (e.g., in blue color) in the tile pane window 640. In an embodiment, the user can scroll up/down within the tile pane window 640 using single finger gesture, as shown in FIG. 6C. Referring to FIG. 6D, when the user taps or clicks on an action menu icon of a selected document (e.g., comp/prodisales analysis) in the tile pane window 640, an action menu 650 is displayed. The action menu 650 includes options, e.g., ‘remove above’ to remove the documents above the selected document (e.g., comp/prod/sales analysis), ‘remove below’ to remove the documents below the selected report, ‘keep only’ to keep just the selected document, ‘remove only’ to remove just the selected document, ‘send’ to send the selected document, and ‘save as tile’ to save and display the selected document as a tile on the Home Screen. The option ‘remove above’ or ‘remove below’ is disabled when there are no reports above or below, respectively, the selected document.

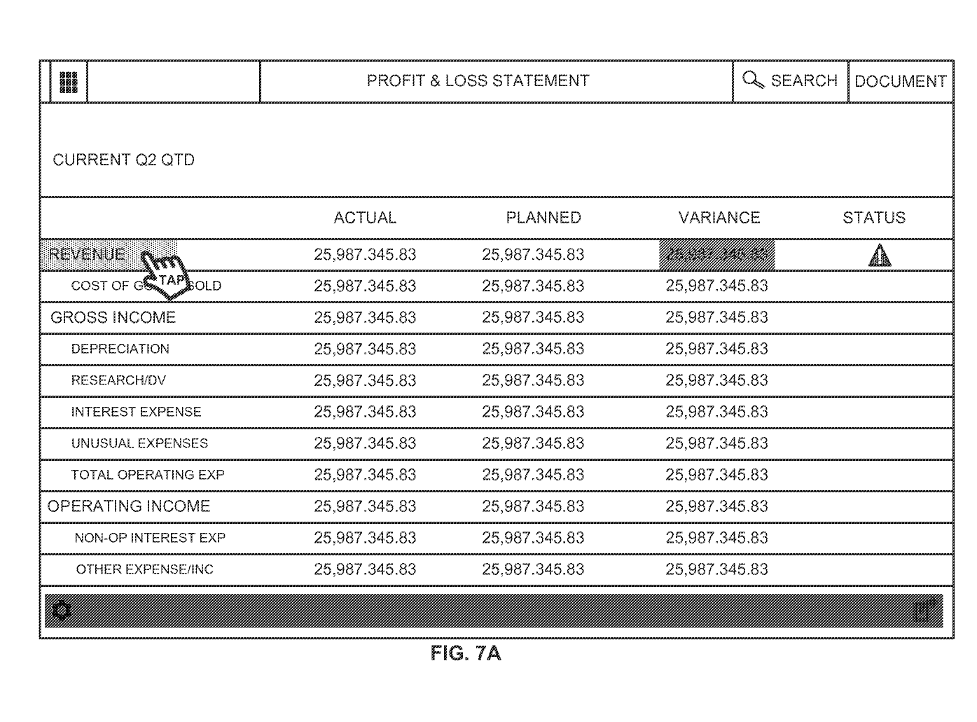

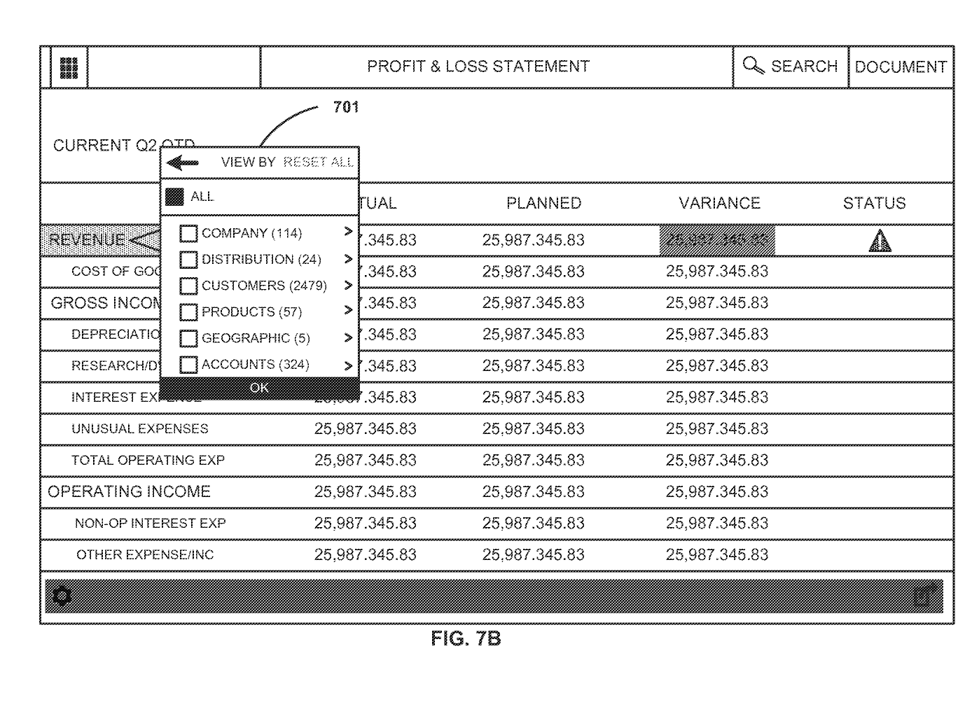

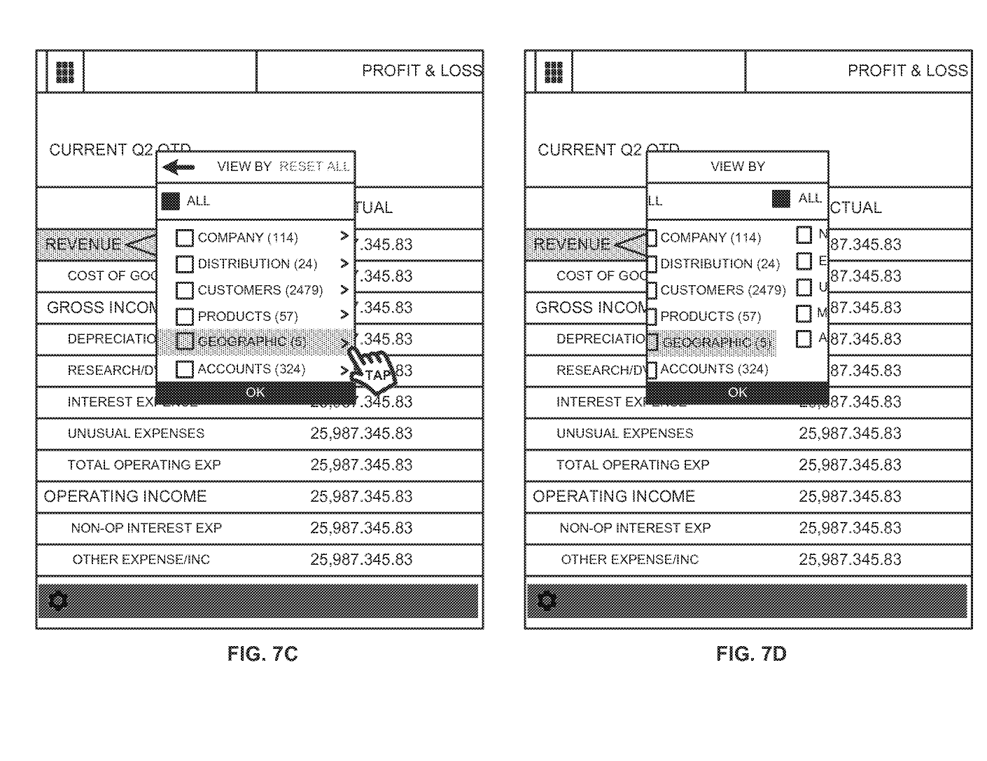

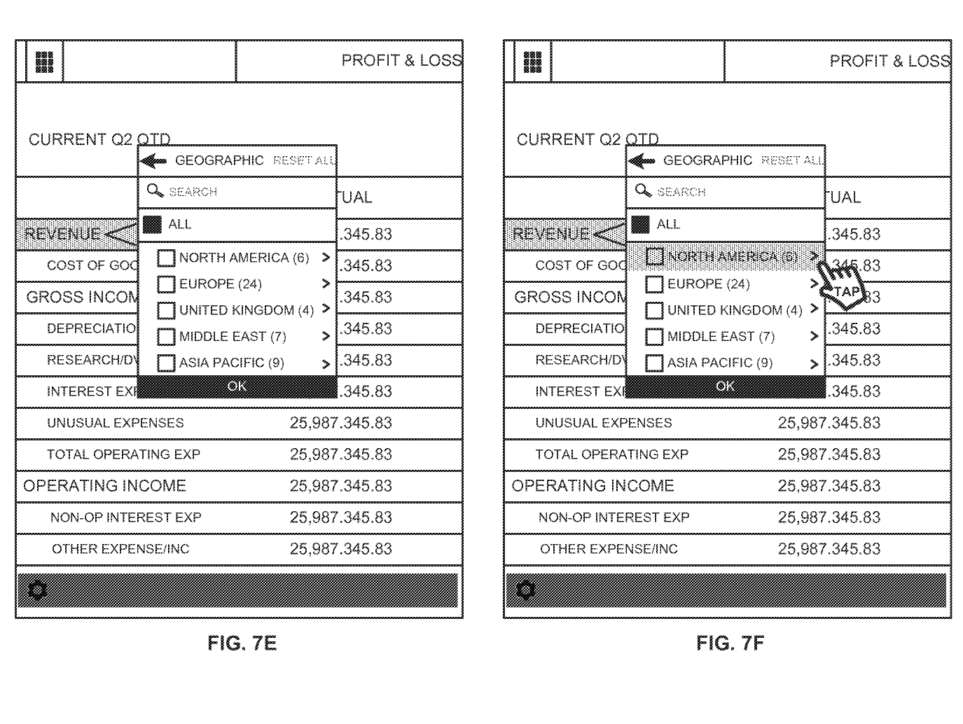

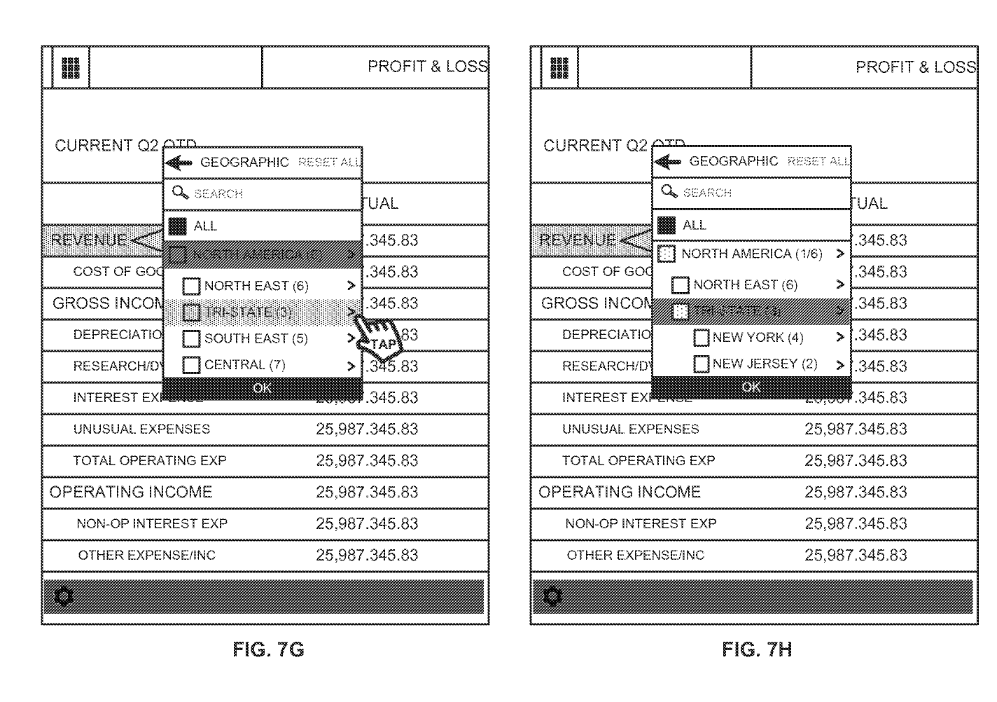

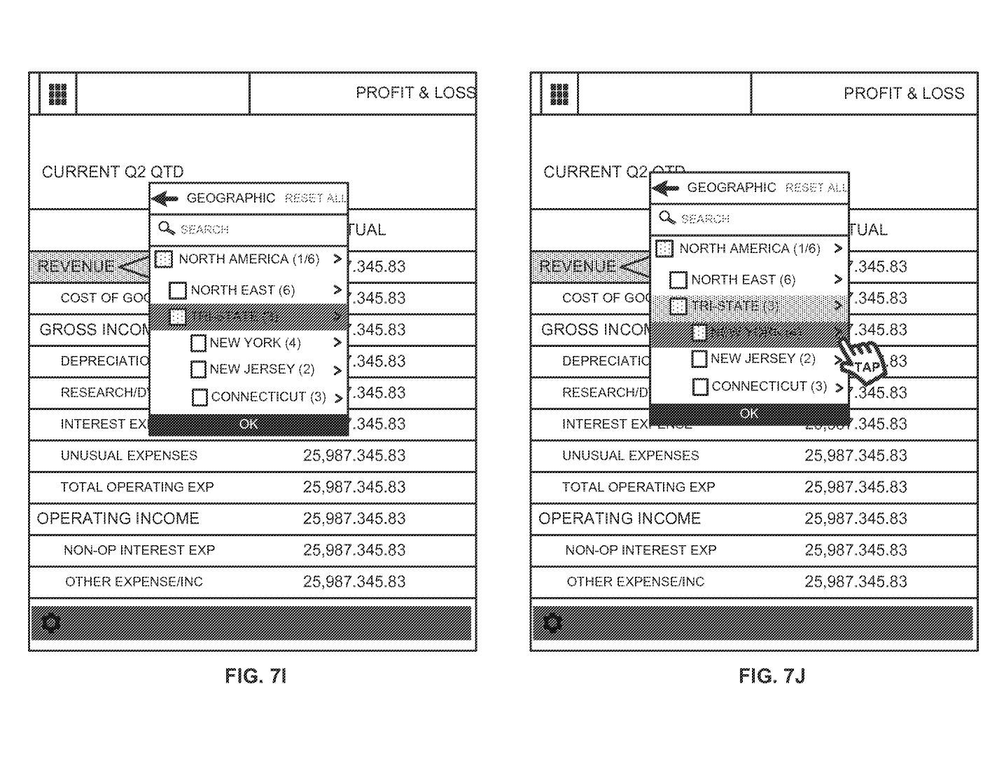

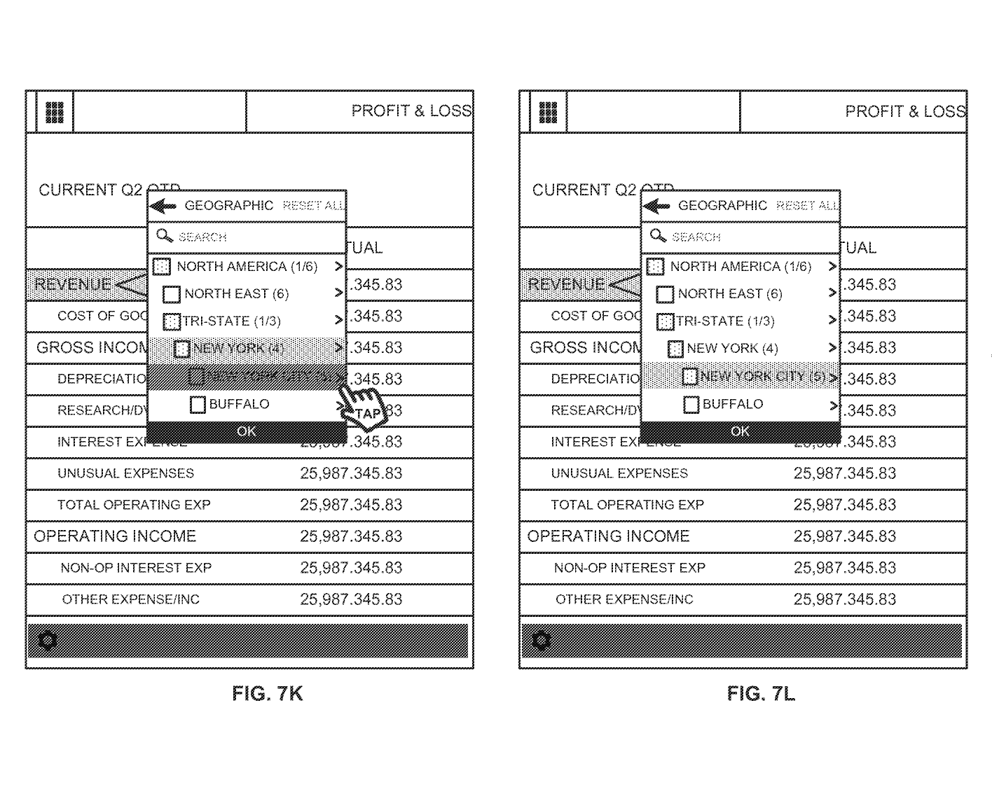

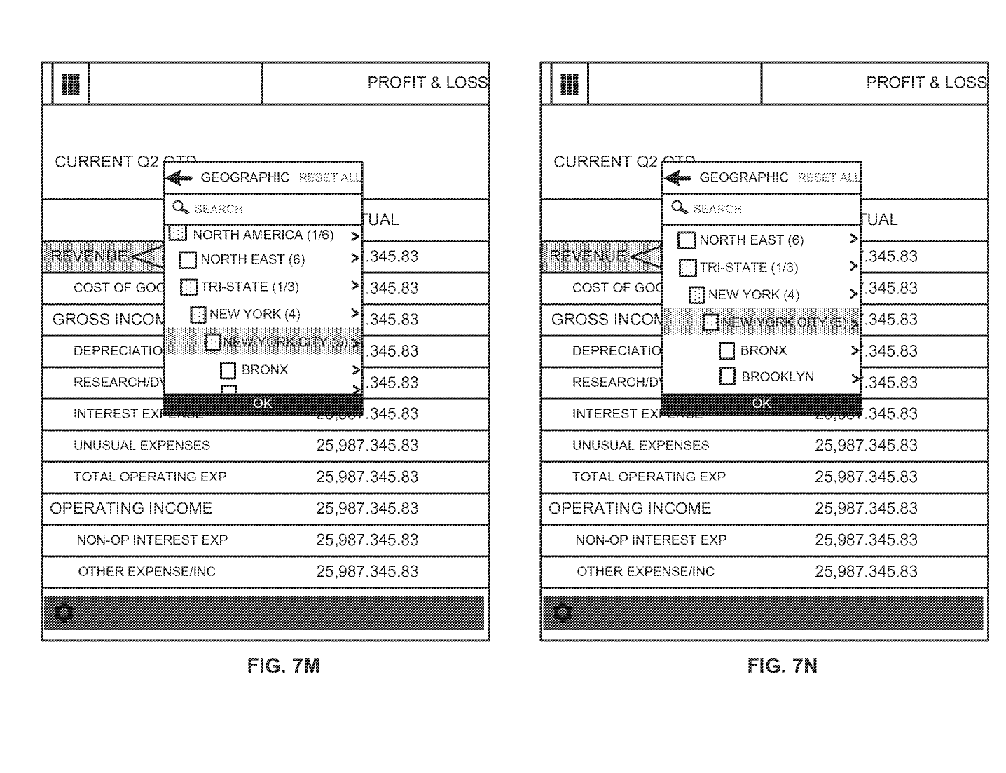

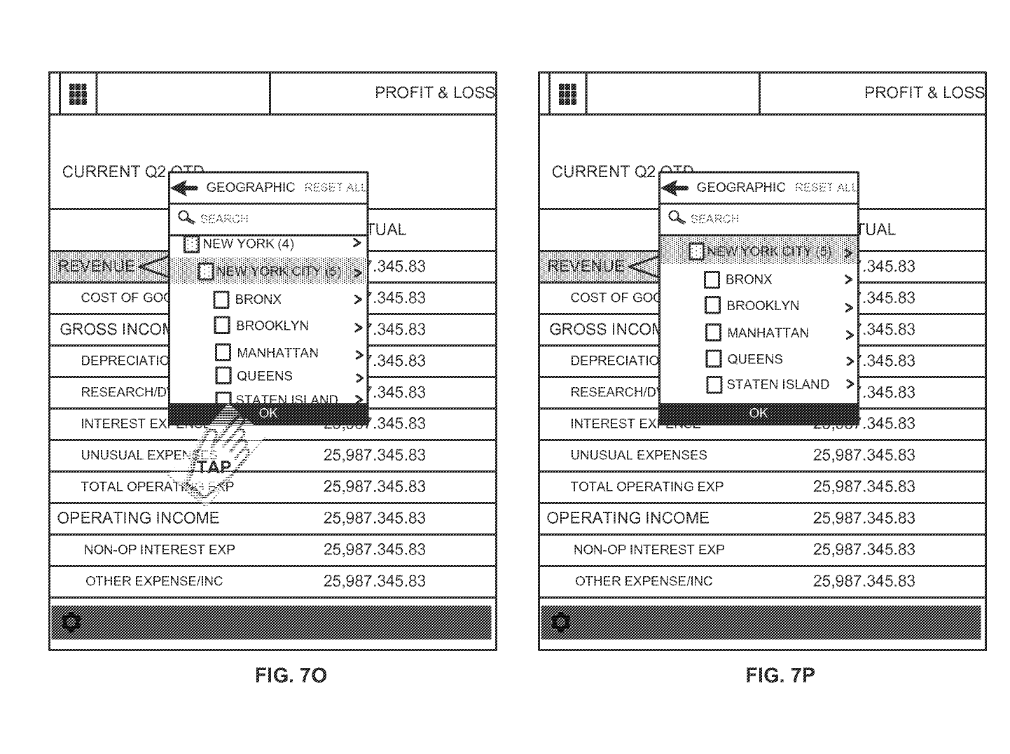

FIG. 7A-FIG. 7P illustrate a dynamic multi-select hierarchical tree selection from a row or a column item, according to an embodiment. FIG. 7A shows that user taps on “revenue” (row item label) to analyze “revenue” on various dimensions. Based upon action performed in FIG. 7A, a dimensional view menu 701 is displayed, as shown in FIG. 7B. The dimensional view menu 701 shows various options in dimensional format. In dimensional format, tapping on a selection box on a menu item selects the sub-categories within that category. Tapping on the right arrow button on a menu item in the dimensional view menu 701, moves one level down the hierarchy and displays the sub-categories within the selected menu item. The sub-categories slide-in from the right. For example, as shown in FIG. 7C, the user taps on “geographic” menu item, the transition starts whereby the geographic sub-categories slide-in from the right, as shown in FIG. 7D. The geographic sub-categories slide-in from the right, as shown in FIG. 7E. User may scroll the list. The numbers indicate how many items are in each sub-category.

FIG. 7F shows that the user taps on “North America” line item to view geographical hierarchical dimensions for North America which appear below. After selection, the line item text gets highlighted (e.g., in blue color) to show this category as not being selected, but opened with sub-categories below. User may scroll the screen to view sub-categories. In FIG. 7G, user taps on “Tri-State” sub category line item to view geographical hierarchical dimensions for the “Tri-State” area which appear below after release of the tap or click action. FIG. 7H shows that the “Tri-State” item text gets highlighted (e.g., in blue color), then a dynamic animation action occurs wherein the list auto-scrolls up then moves towards the right to adjust the hierarchical tree view to the relevant hierarchy group, justified to the left side of the screen. In one embodiment, animation action is a smooth medium speed movement.

Hierarchical tree list begins to auto-scroll up, until the top is reached with the North America line item at the top, as shown in FIG. 7I. At the top, the tree view begins to move towards the left to completely justify the tree hierarchy to the left side of the popup screen. Hierarchical tree list is now completely justified to the left side of the screen. FIG. 7J shows that the user taps or clicks on New York state sub-category. Based upon the action performed in FIG. 7J, New York state text gets highlighted (e.g., in blue color). Light blue highlight may provide an affordance of the user's last selection. New York State location sub-categories are displayed below New York further indented towards the right. In an embodiment, the auto-scroll “UP” animation moves the Tri-State item to the top and then moves the tree view to justify on the left side of screen. The user selects New York City location sub-category, as shown in FIG. 7K. Upon release of tap or click, the New York City (5) text gets highlighted, e.g., in blue color (FIG. 7L) and the animation starts. FIG. 7M shows tree list view with the selected “New York City (5)” at the top, next animation effect begins and the tree list moves towards the left, re-justifying completely on left. Then, the hierarchical tree list view begins to move towards the left until hierarchical tree list view is justified on left. FIG. 7N shows that the user selects 4 out of the 5 Boroughs of New York City. Then the user taps on “OK” to add selected dimensions to the document (e.g., P&L Statement), as shown in FIG. 7O. The dimensional view now includes the hierarchical tree locations selected, including roll-up categories, as shown in FIG. 7P.

In another embodiment, the multi-dimensional view can be created using a non-dynamic multi-select hierarchical control. Multi-selection of dimensional view hierarchical categories is accomplished using the standard single-screen pattern and control. The user does not have the contextual affordances of the dynamic multi-select hierarchical tree control to refer where they came from and where they have navigated to on the same UI. The next category from a prior selection may be viewed, however the tree hierarchy is not displayed in this approach.

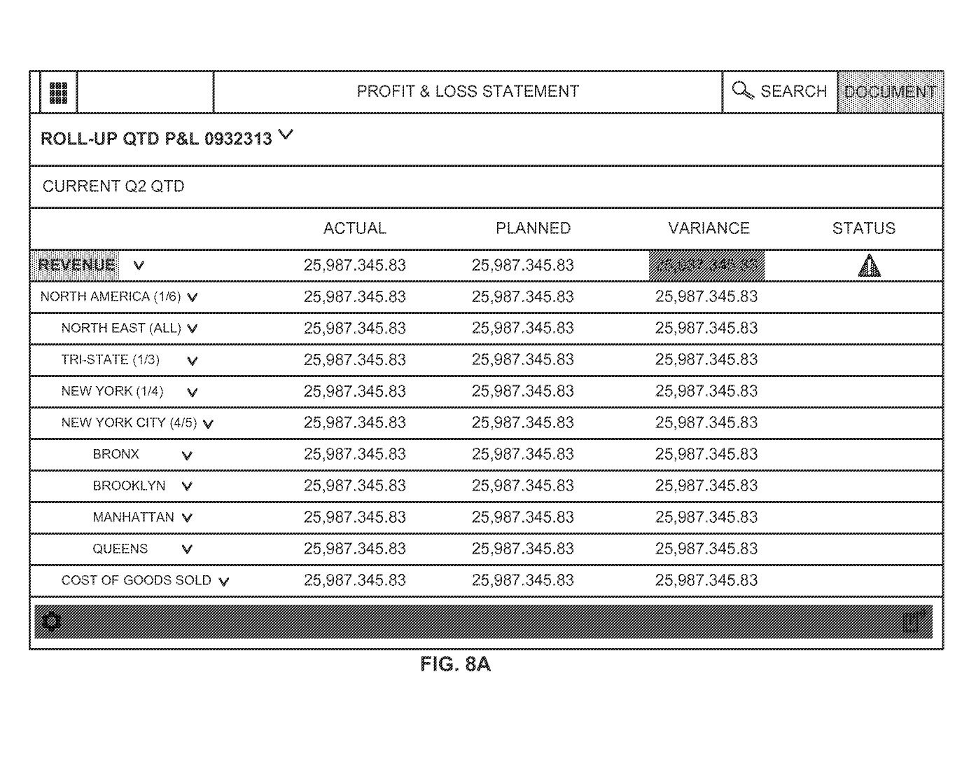

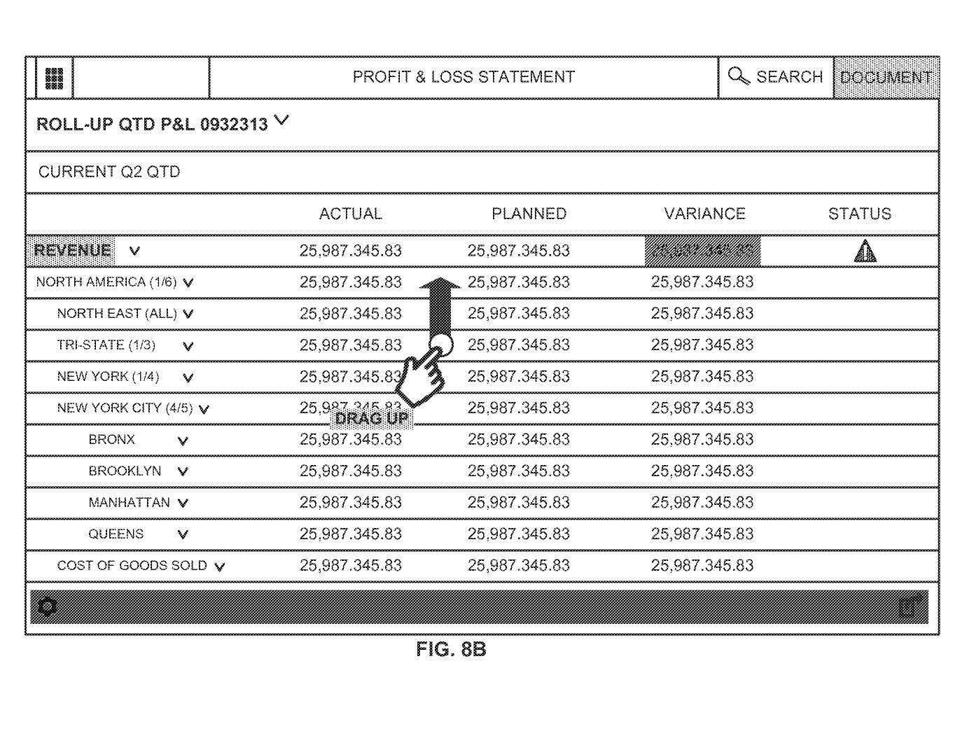

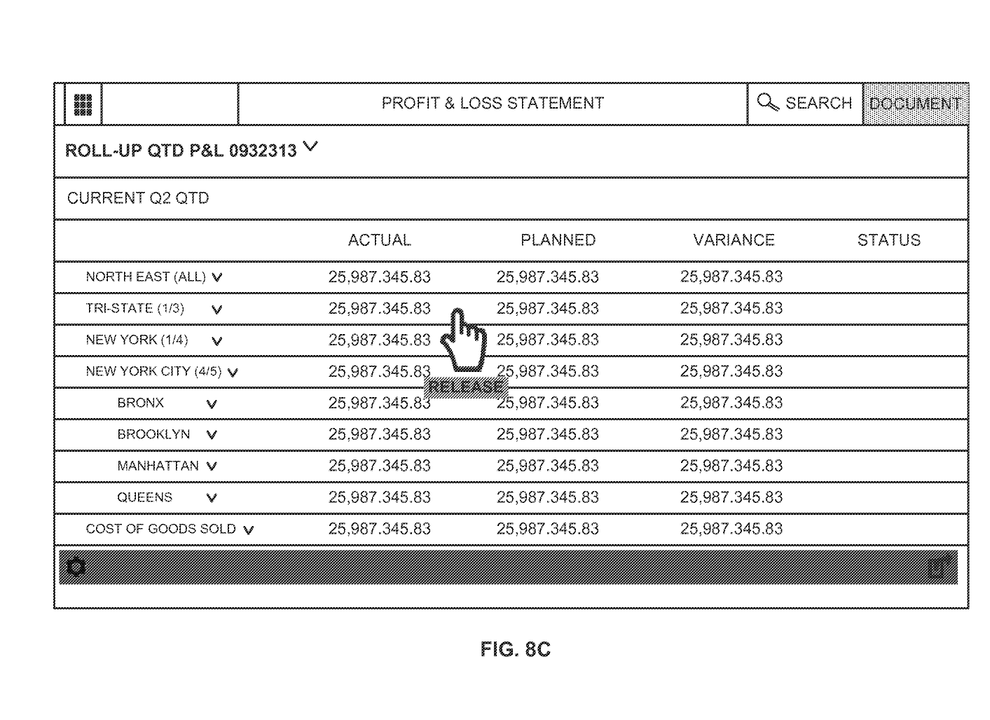

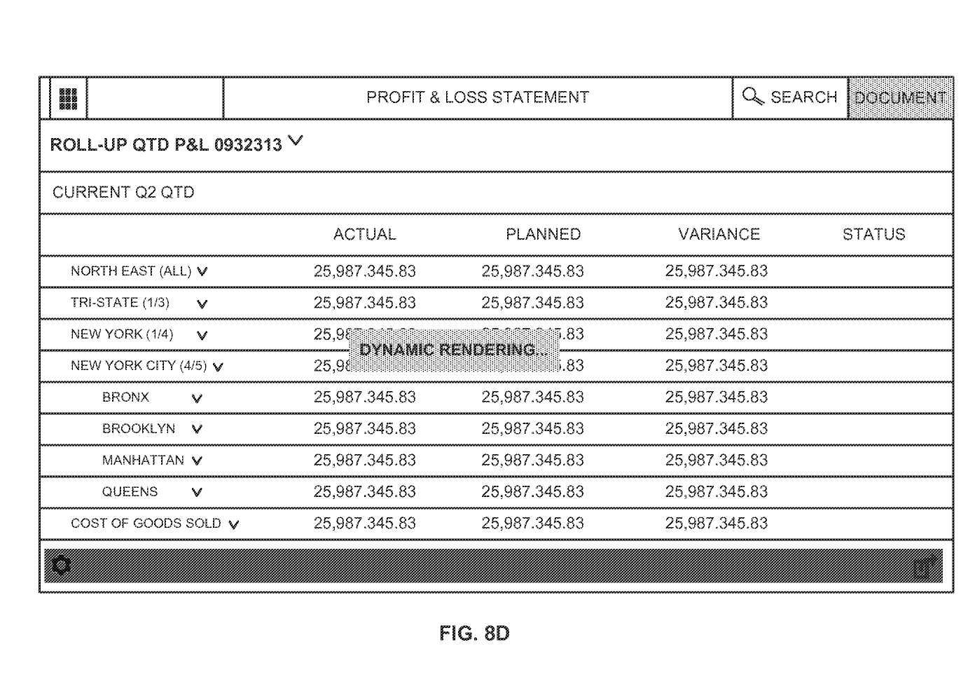

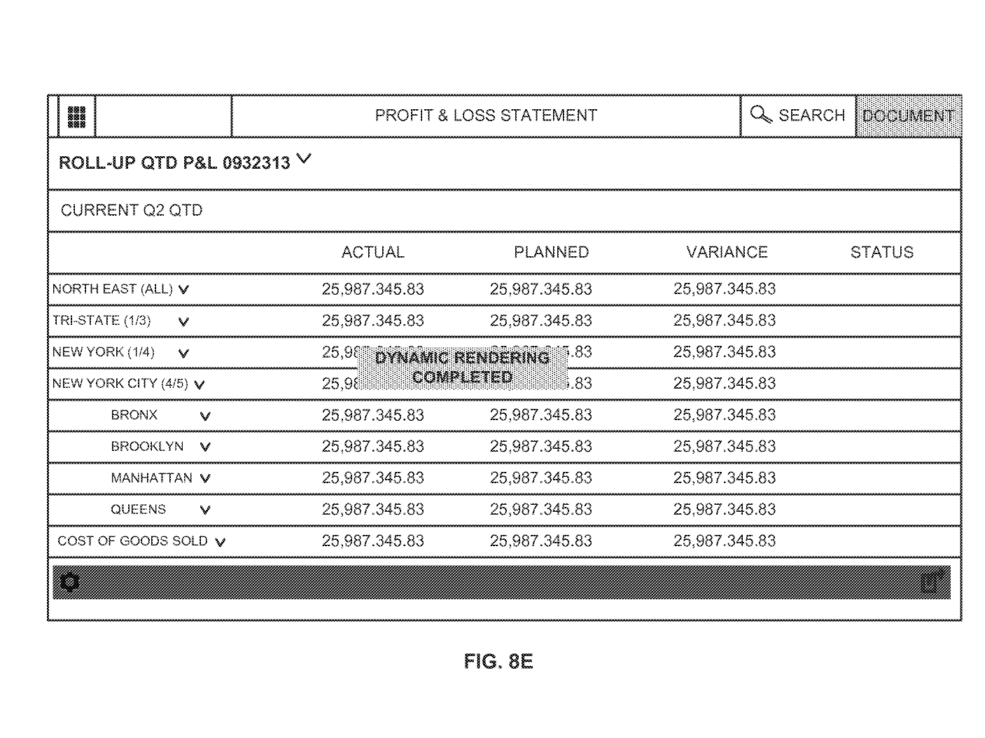

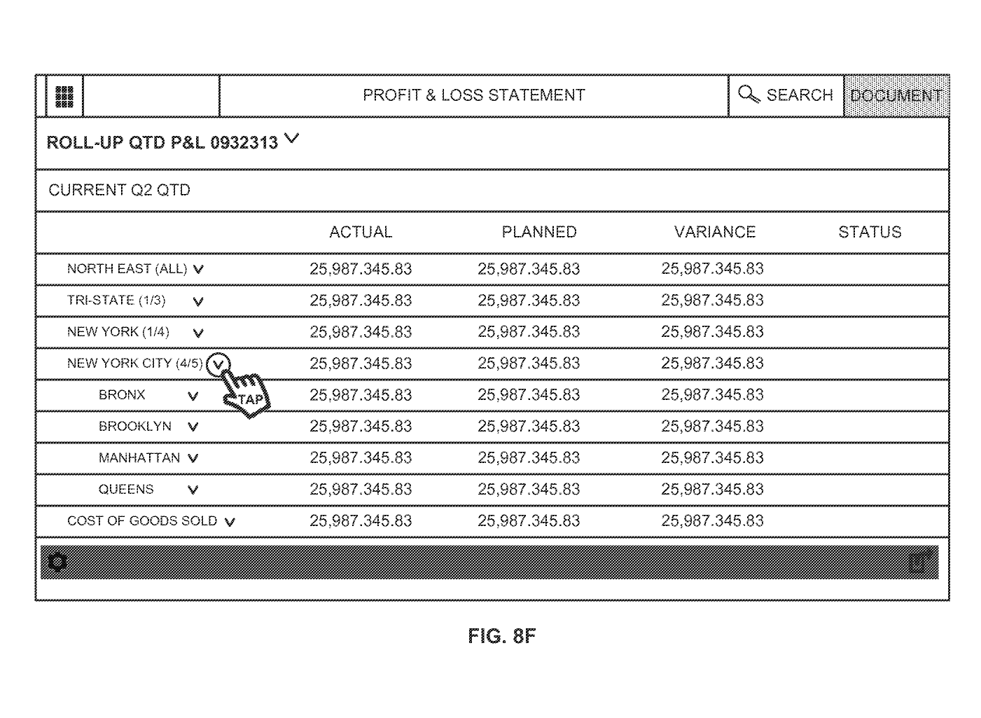

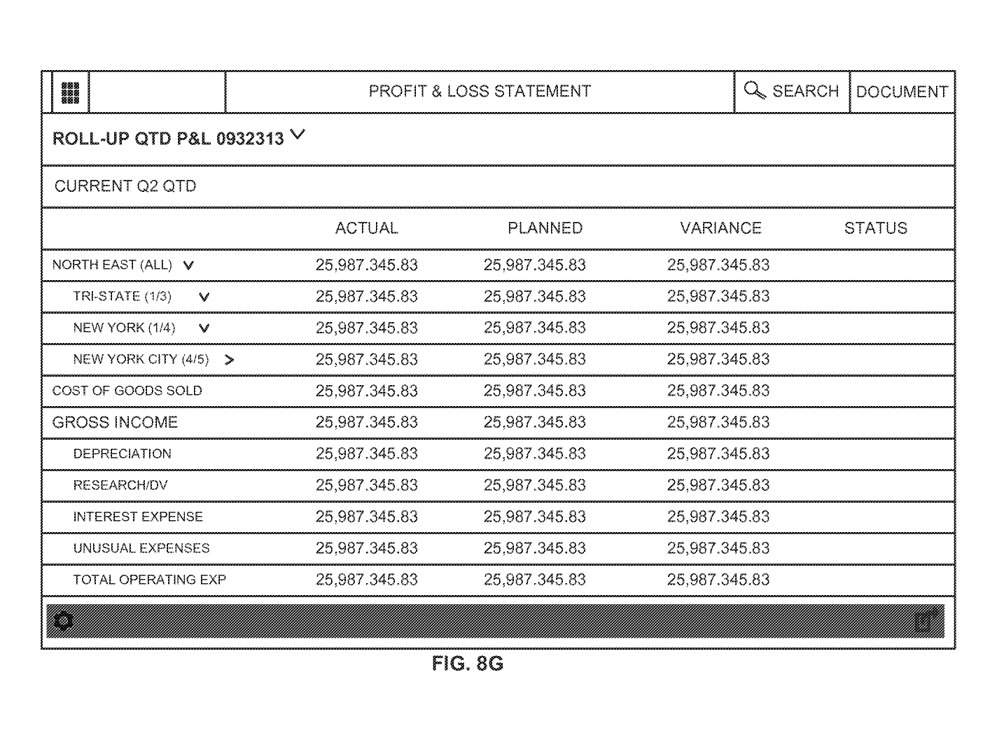

The dynamic and animation principles can also be applied to the hierarchical financial data table display. FIG. 8A-FIG. 8G show auto-scrolling and re-justification of row items according to user scroll actions and collapsing or expanding subcategories. FIG. 8A shows the revenue row item displaying the sub-category ‘locations,’ based upon the user's dimensional view selection. The user may desire to focus on hierarchies Northeast and below. Therefore, the user may drag up to scroll down the list, e.g., by 2 rows. FIG. 8B shows the user dragging the screen up to scroll down. Once the user scrolled down to desired point, the user releases touch from dragging gesture, as shown in FIG. 8C. The dynamic tree animation moves hierarchical row item labels towards the left, as shown in FIG. 8D. The dynamic tree animation gets completed and the hierarchical tree list rows are indented as much as the screen will allow, as shown in FIG. 8E. The user selects a collapse button on New York City to collapse the selected 4 out of 5 NYC Boroughs, as shown in FIG. 8F and the collapse button is changed to an expand button. Based upon the action performed in FIG. 8F, the New York City sub-categories are collapsed into the NYC roll-up row and lower hierarchies are moved up to view additional tree table data, as shown in FIG. 8G. In an embodiment, the user may again tap on the expand button to once again view the previously collapsed rows.

In an embodiment, a view pane may be provided with an adjustable focused “field-of-view” for re-justifying sections of a document data table for easy viewing. The view pane also provides various actions that allow users to apply drill-down or drill-up changes to multiple dimensions (row/column items) at the same time as well as other dimensional edits. Collectively, the view pane UI and auto re-justification of hierarchical views enhance the utility and viewing experience. The view pane tool is well-suited for mobile platforms with touch-screen gesture interfaces. Analogous to finger painting, the view pane allows for simple, intuitive, and easy to drill-down (or drill-up) dimensional views and changes, to view within a focused set of numbers and categories of interest during investigations and analysis, with a simple touch or stroke of a finger or fingers to a touch-screen surface. The functions and selections may also be accomplished with a mouse or similar computer control device.

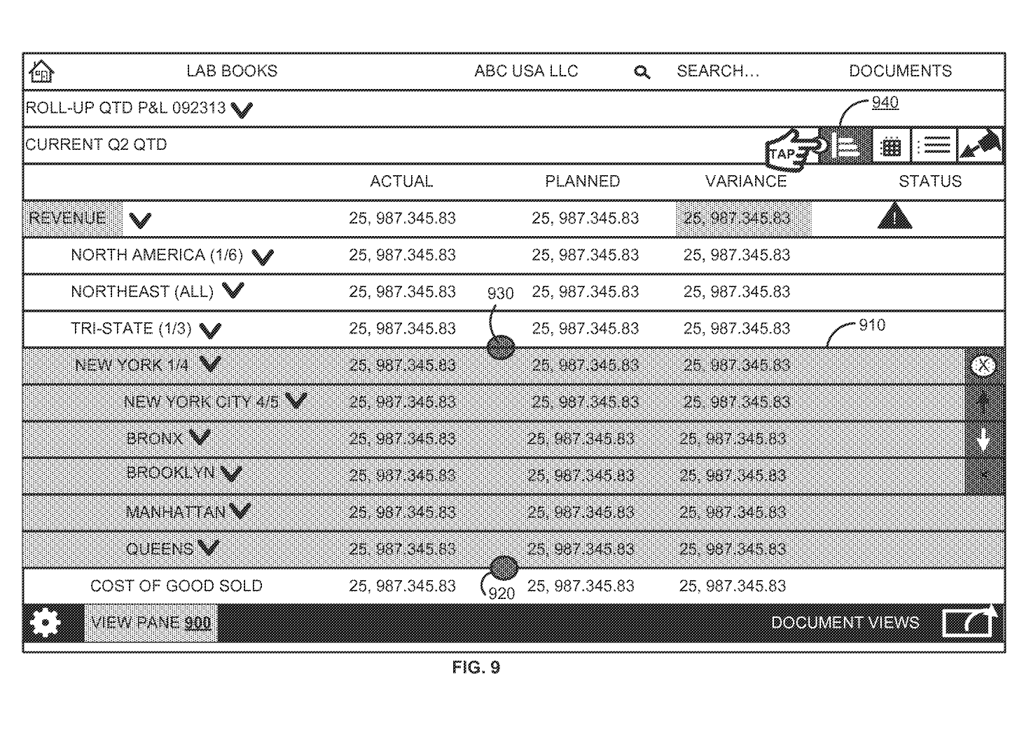

Referring to FIG. 9, a view pane tab 900 may be tapped to open a view pane 910. The view pane 910 includes field-of-focus (row/s) as shown. The field-of-focus can be adjusted, e.g., expanded or contracted, by pulling or pushing view pane extend control 920/930. In an embodiment, the field-of-focus can be viewed graphically by selecting a graphical display icon 940. Further, the view pane 910 can be moved or re-positioned (up/down).

In an embodiment, when the view pane tab 900 is right clicked a view pane menu (not shown) is displayed. The view pane menu includes various options to initiate the view pane with 1 row, 2 rows, 3 rows, etc. In an embodiment, when 1 row option is selected from the view pane menu, a view pane including a single row is displayed. In another embodiment, the view pane may be displayed along with a view pane action bar (not shown) displayed adjacent the view pane. Using the view pane action bar, the view pane may be expanded, moved, or closed. In an embodiment, the view pane may be opened by pinching-out on the screen.

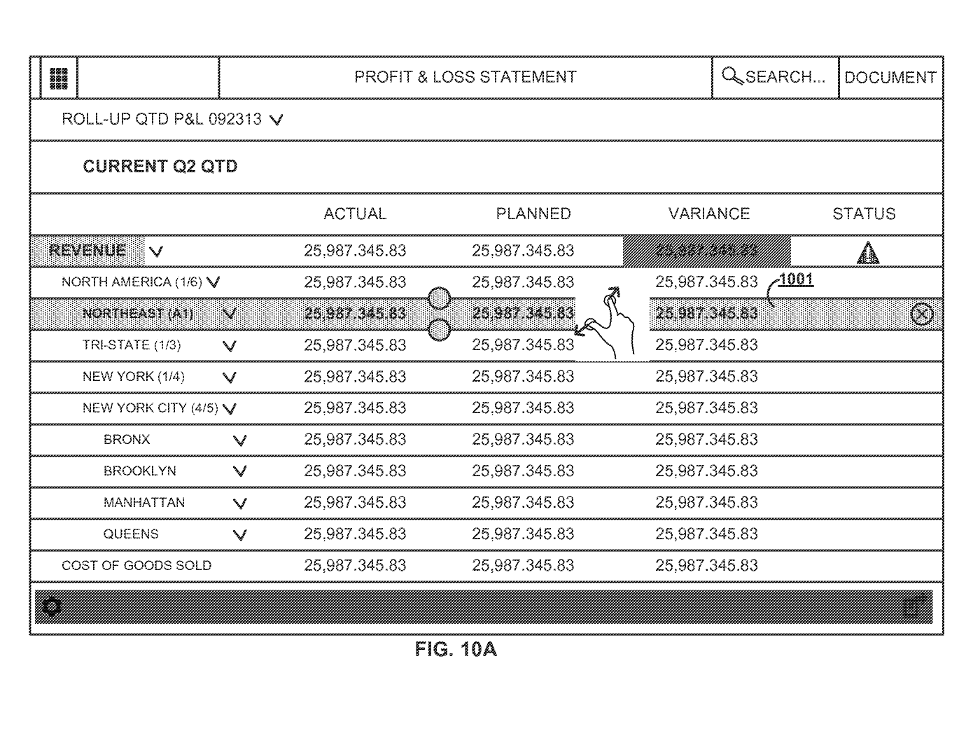

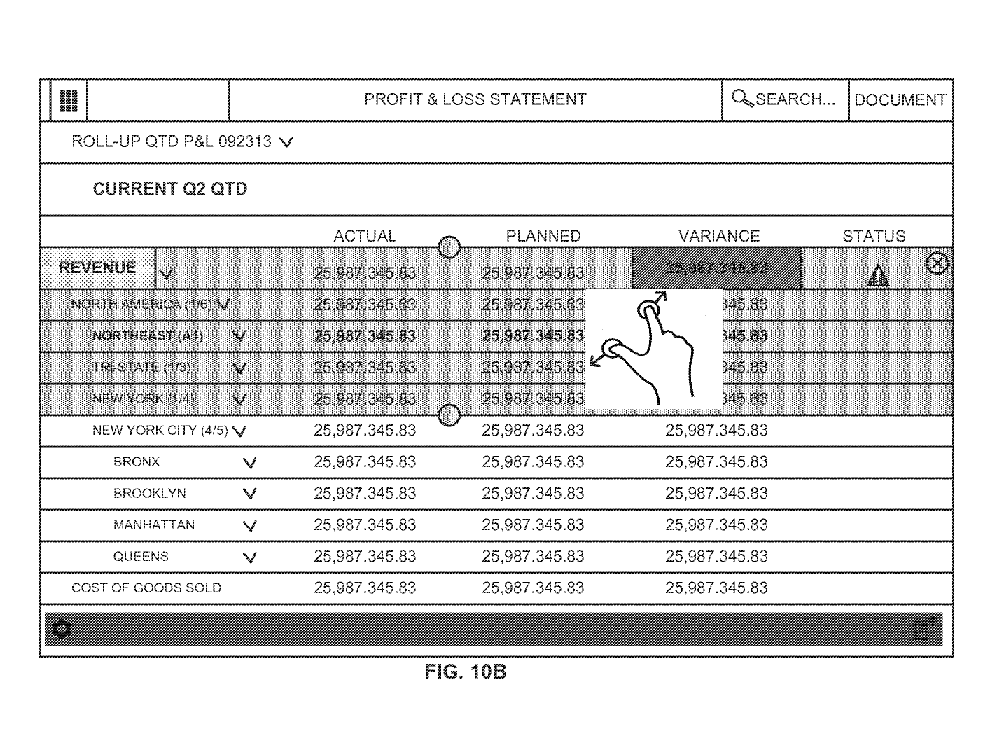

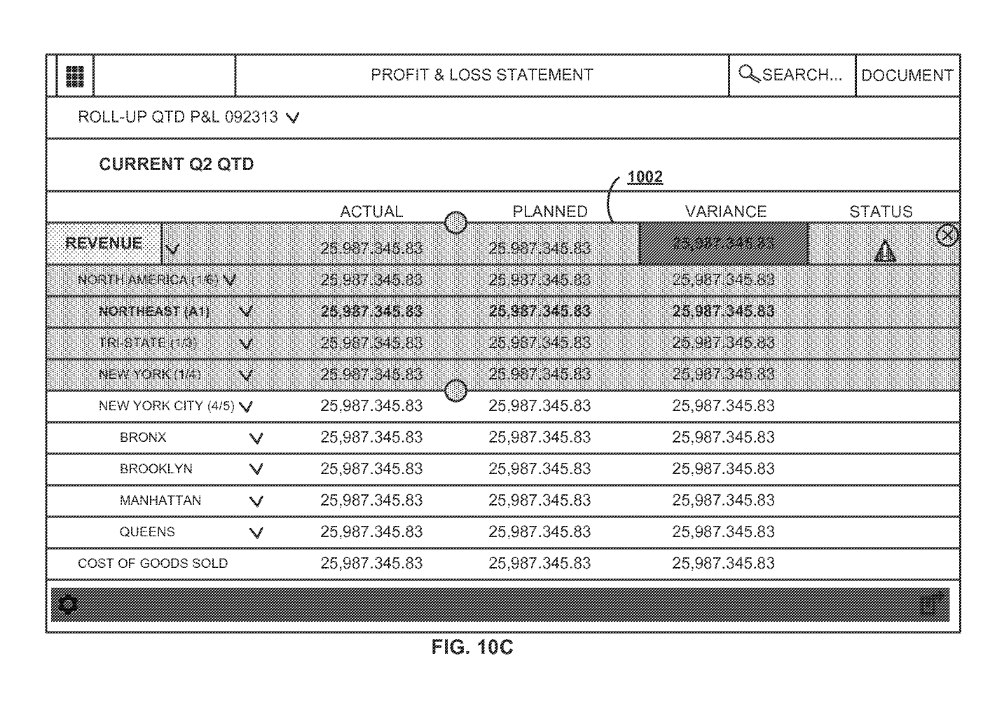

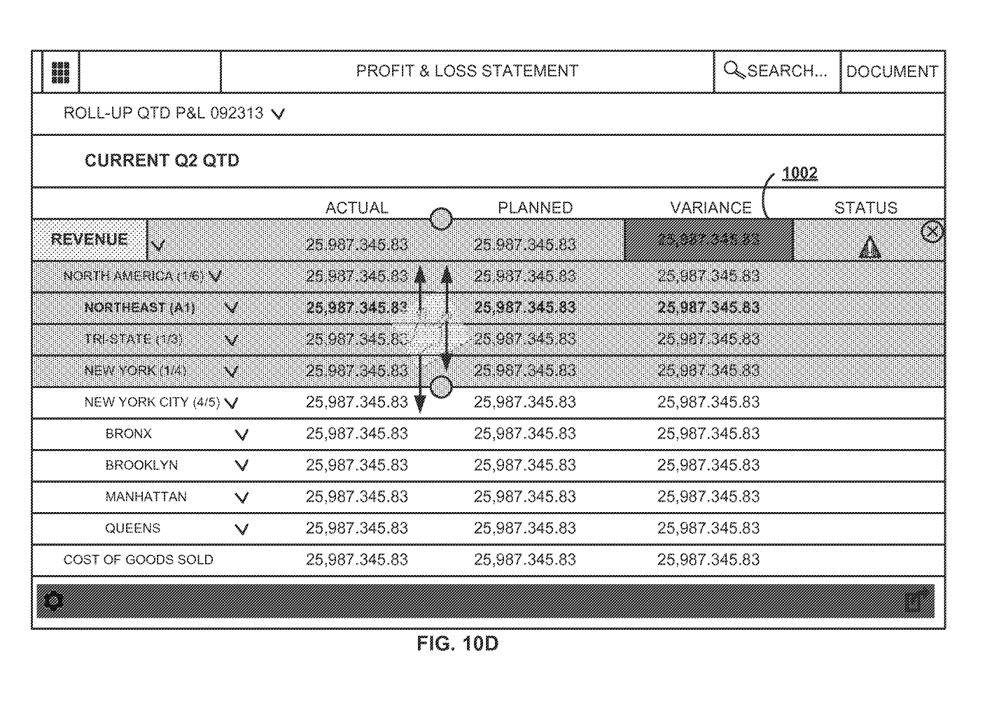

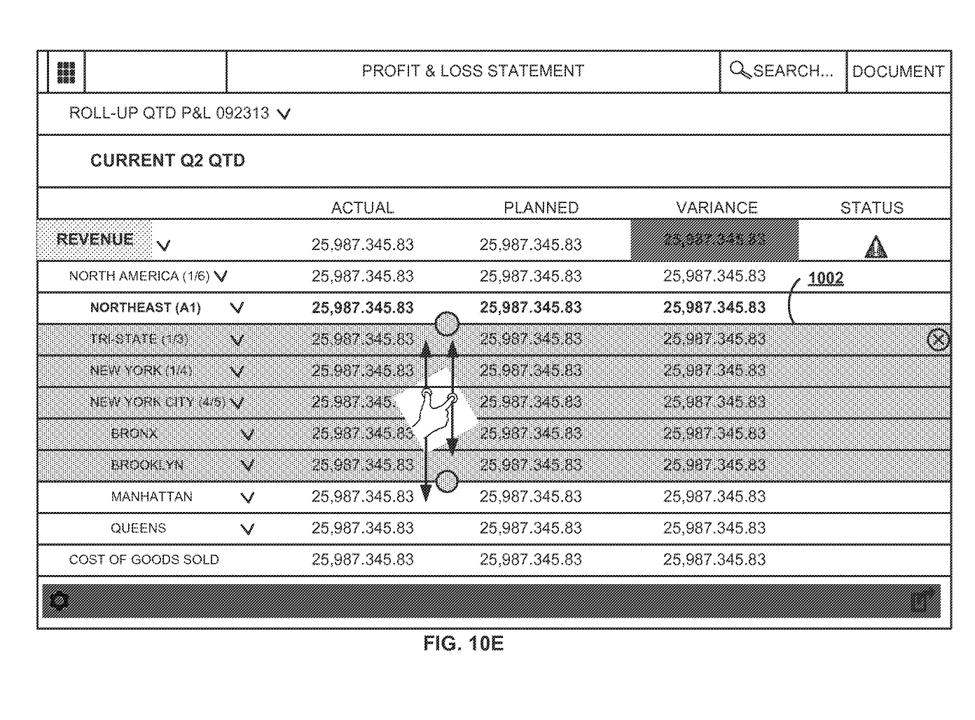

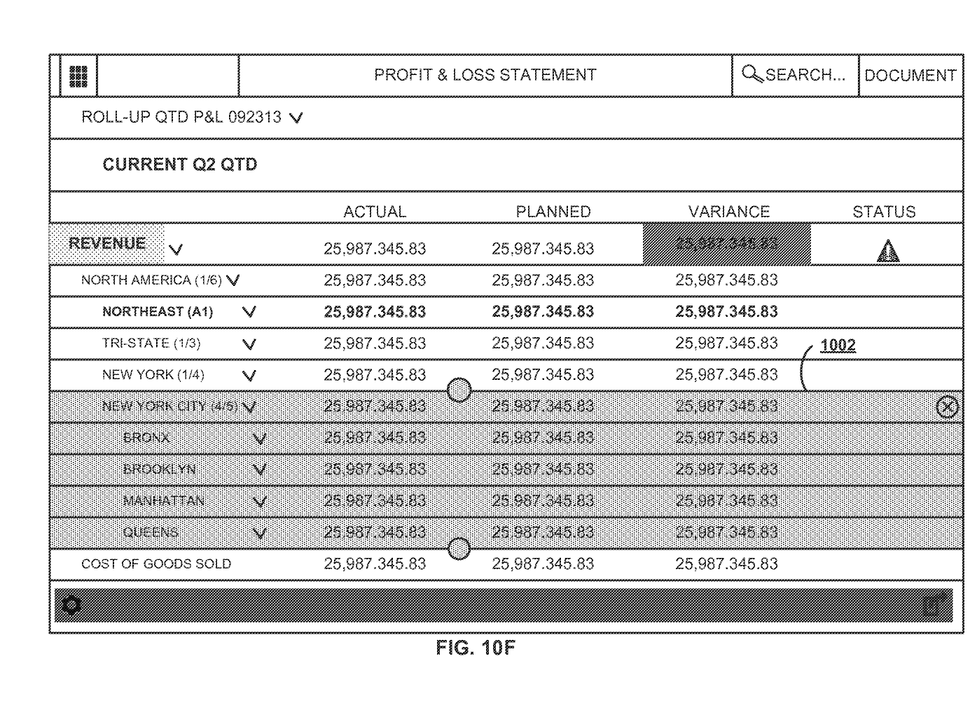

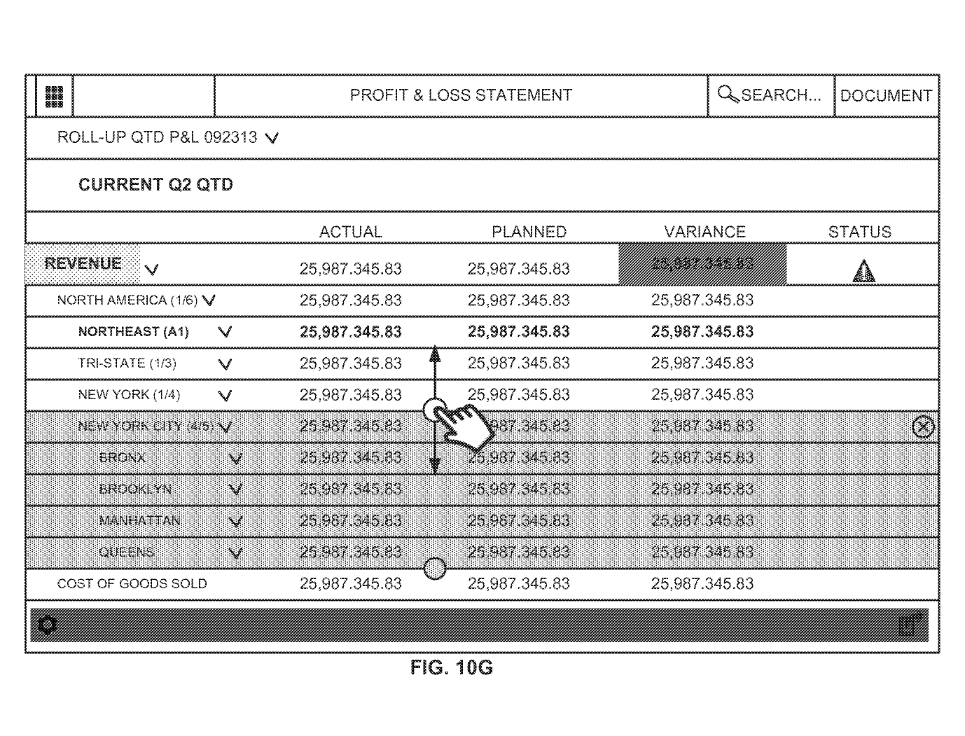

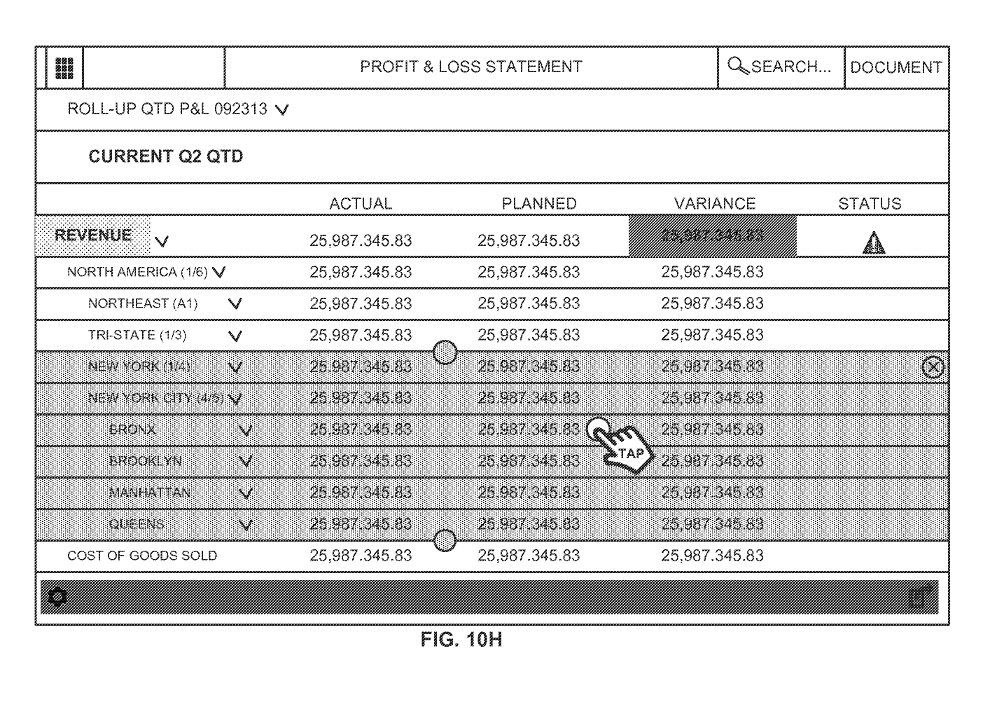

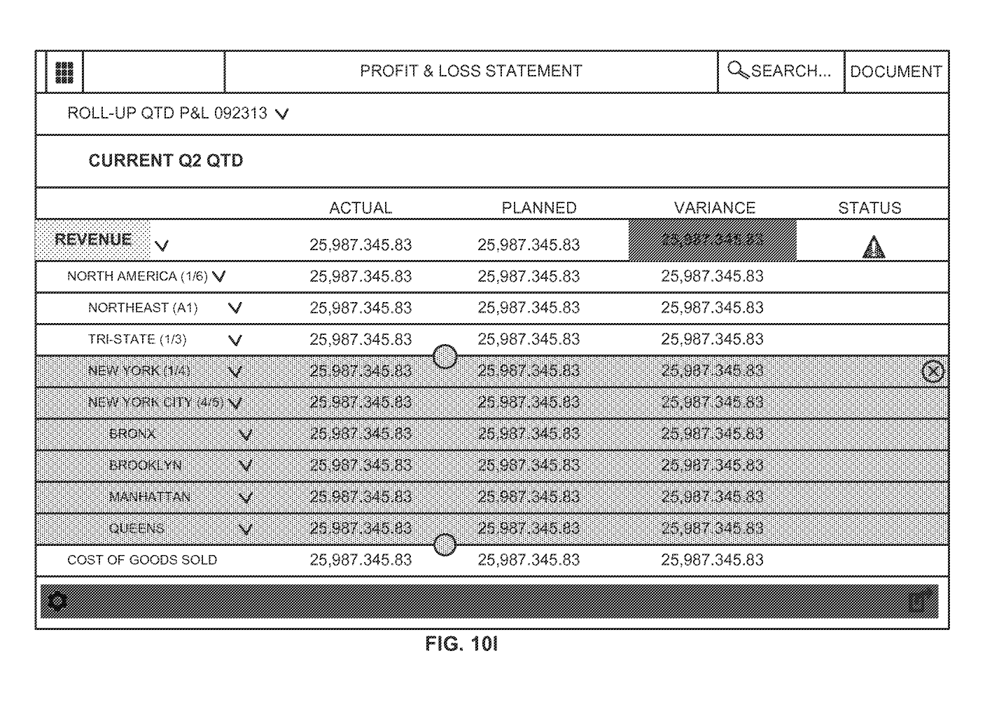

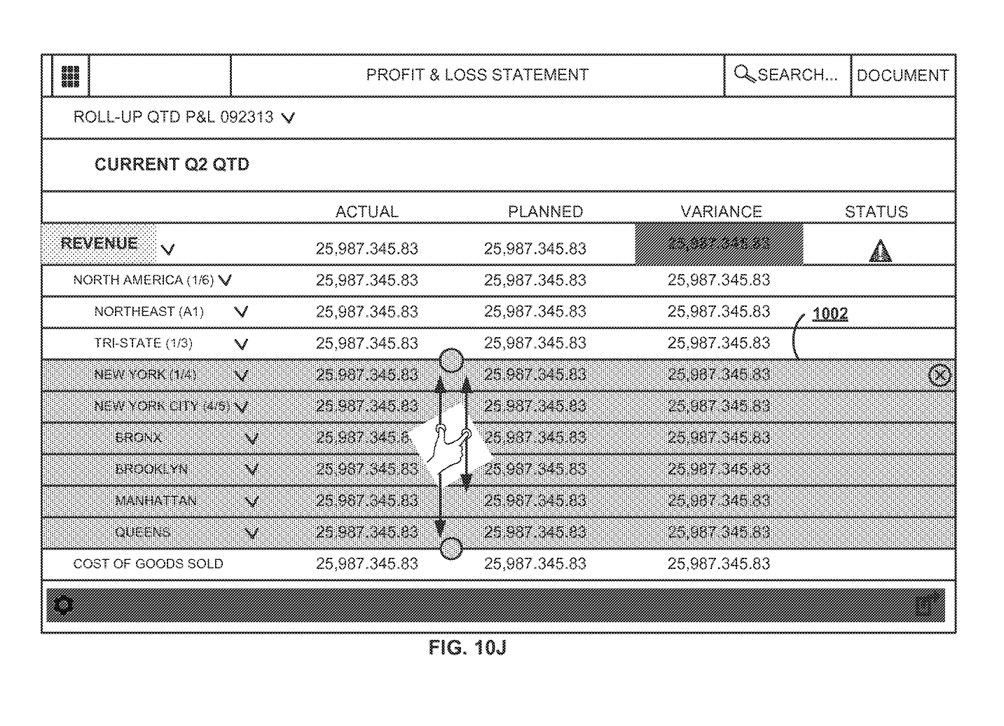

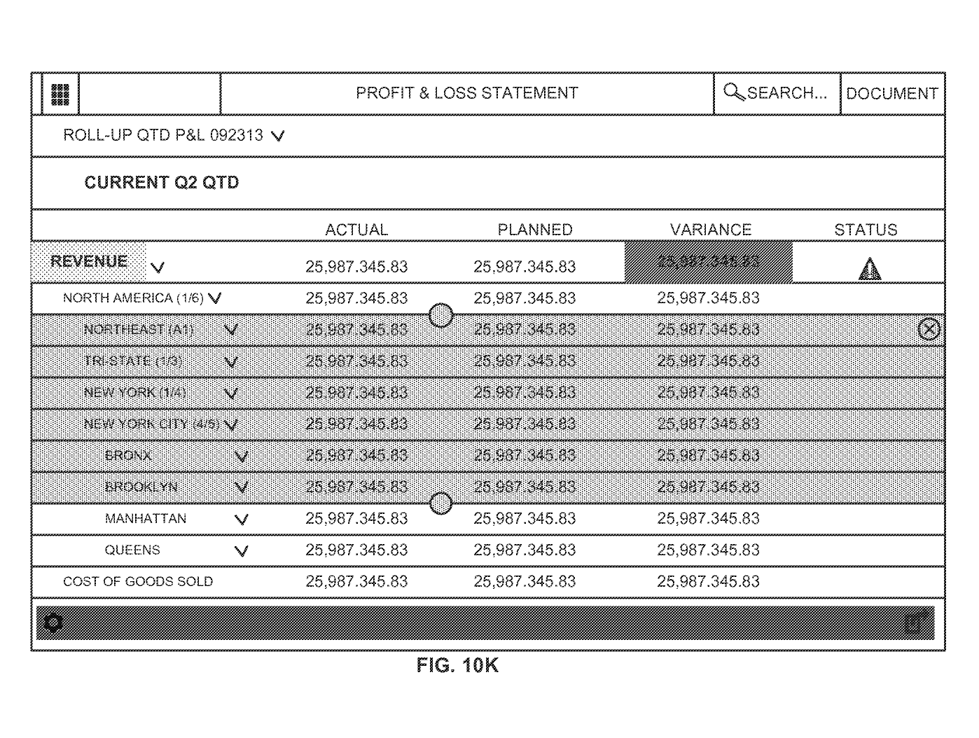

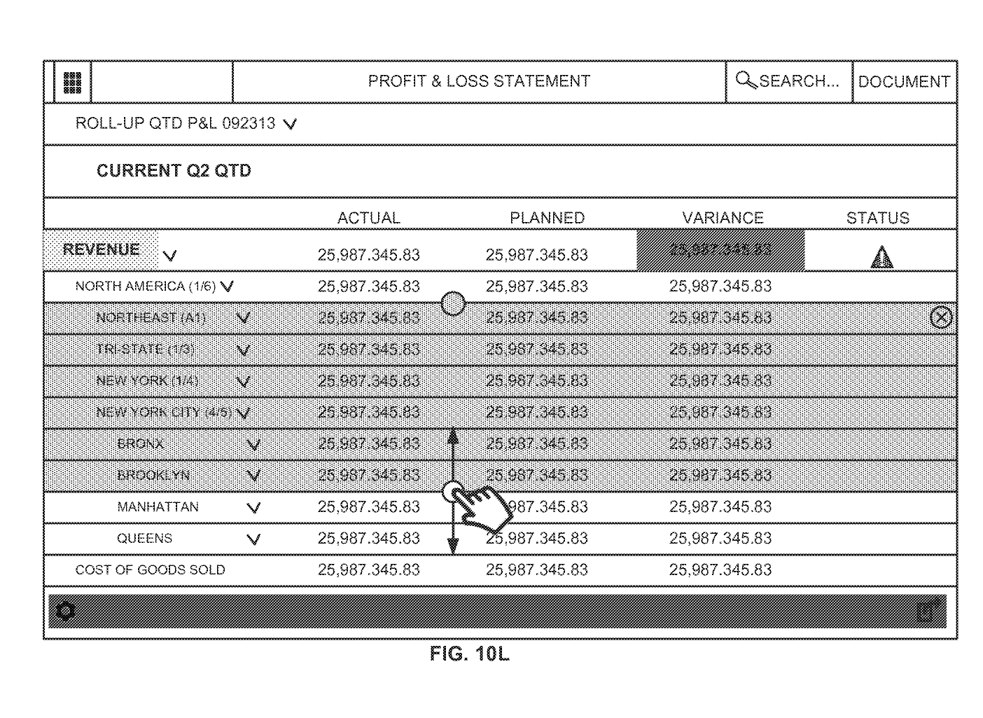

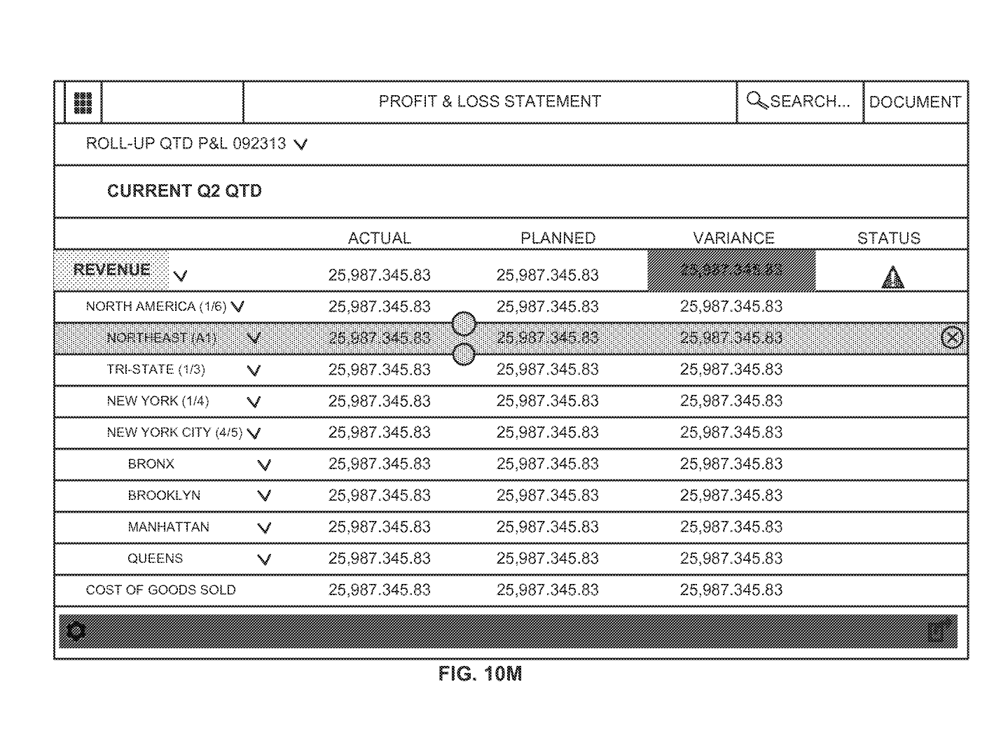

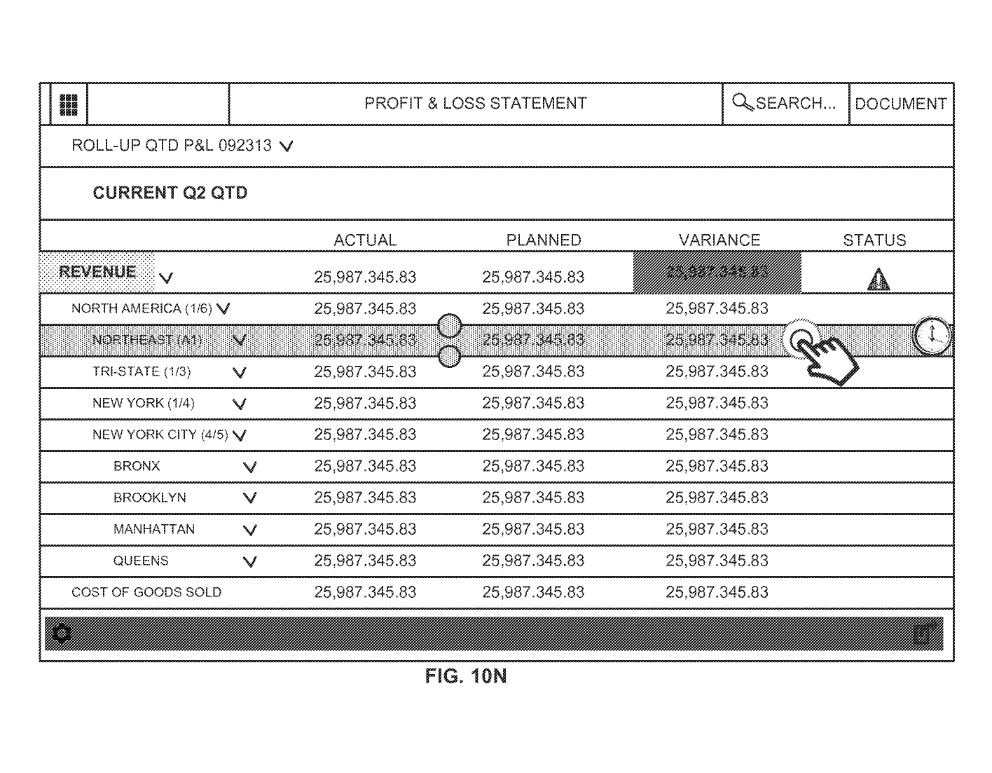

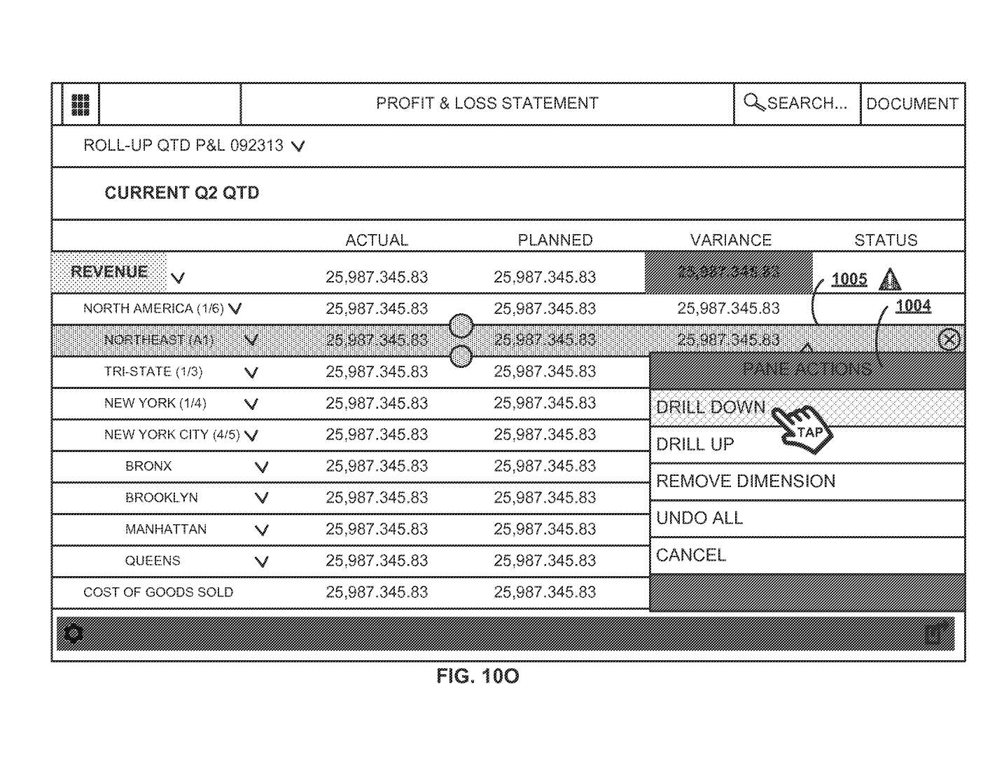

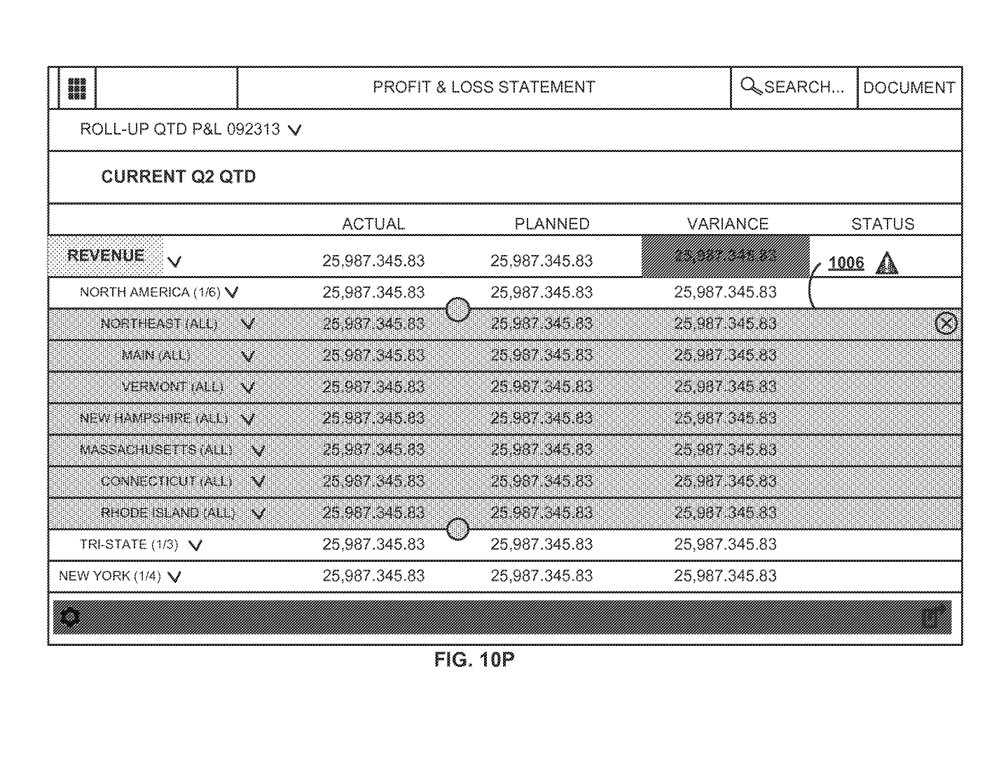

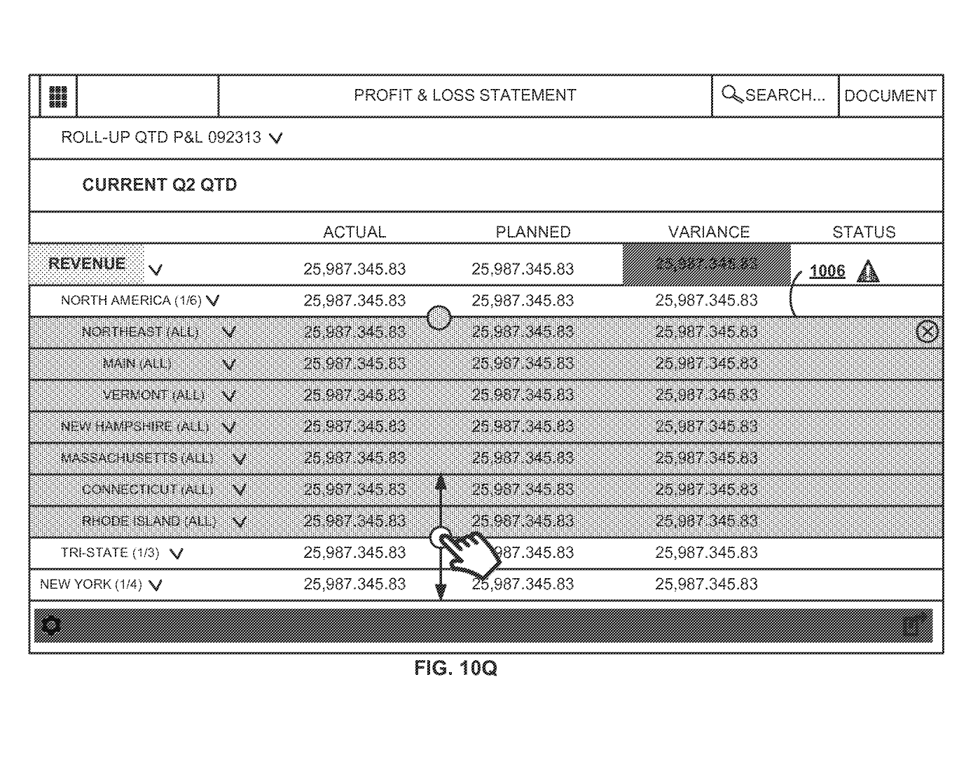

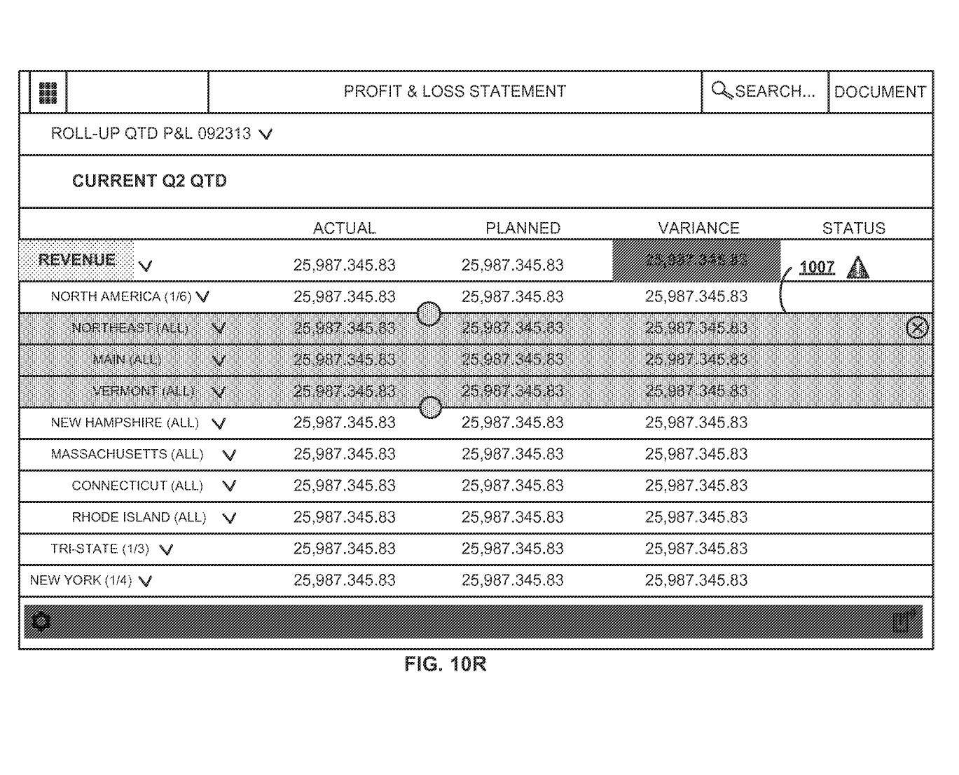

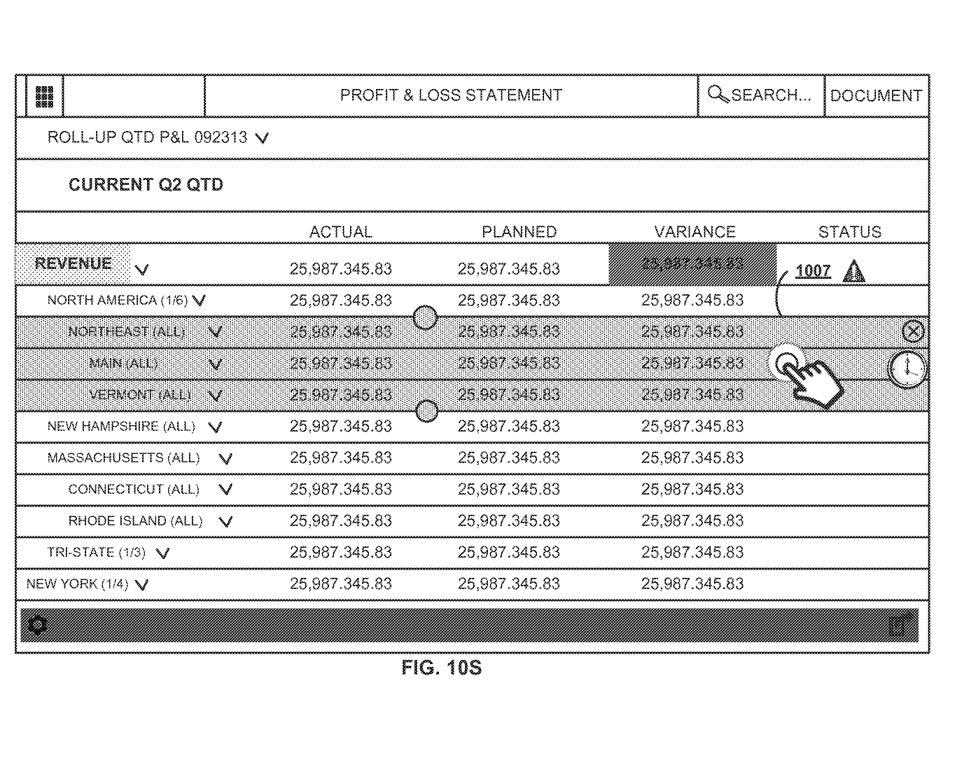

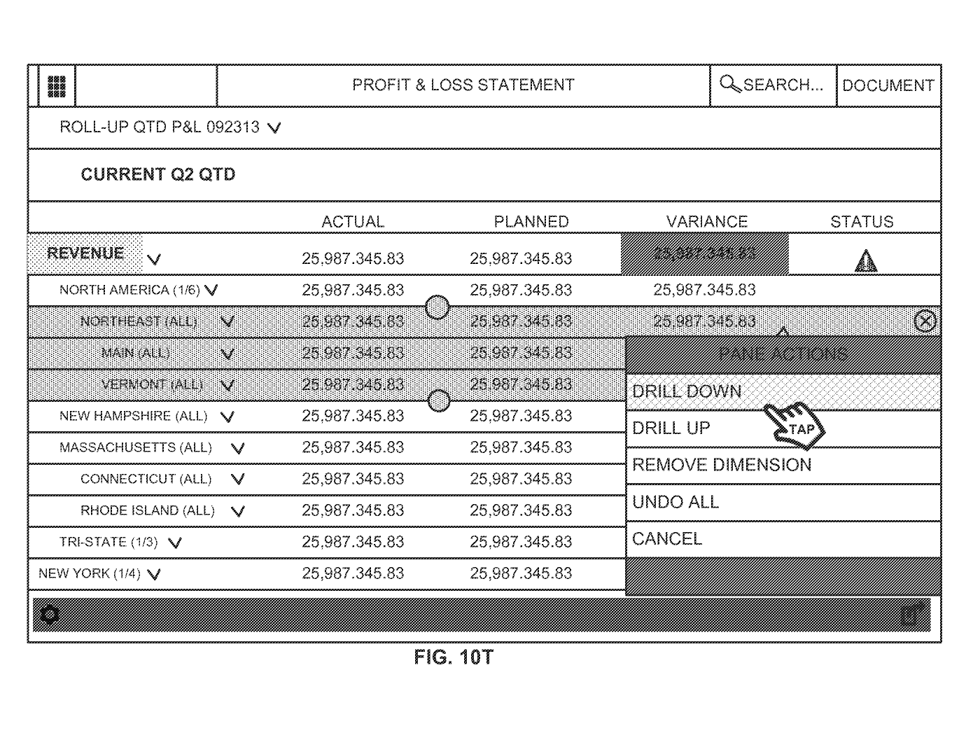

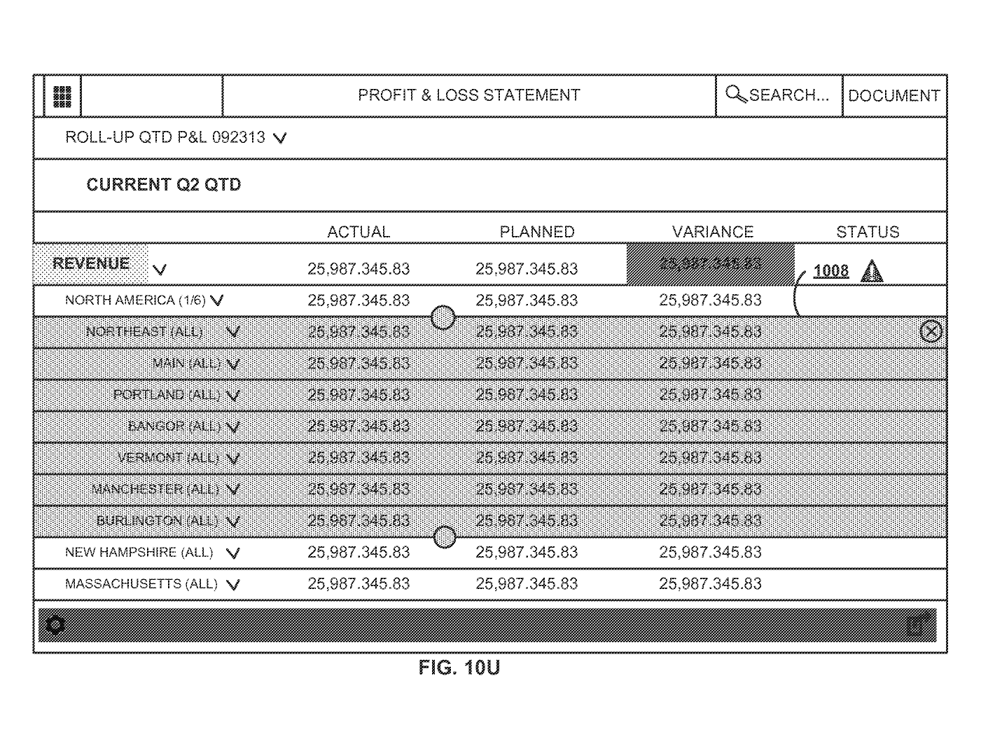

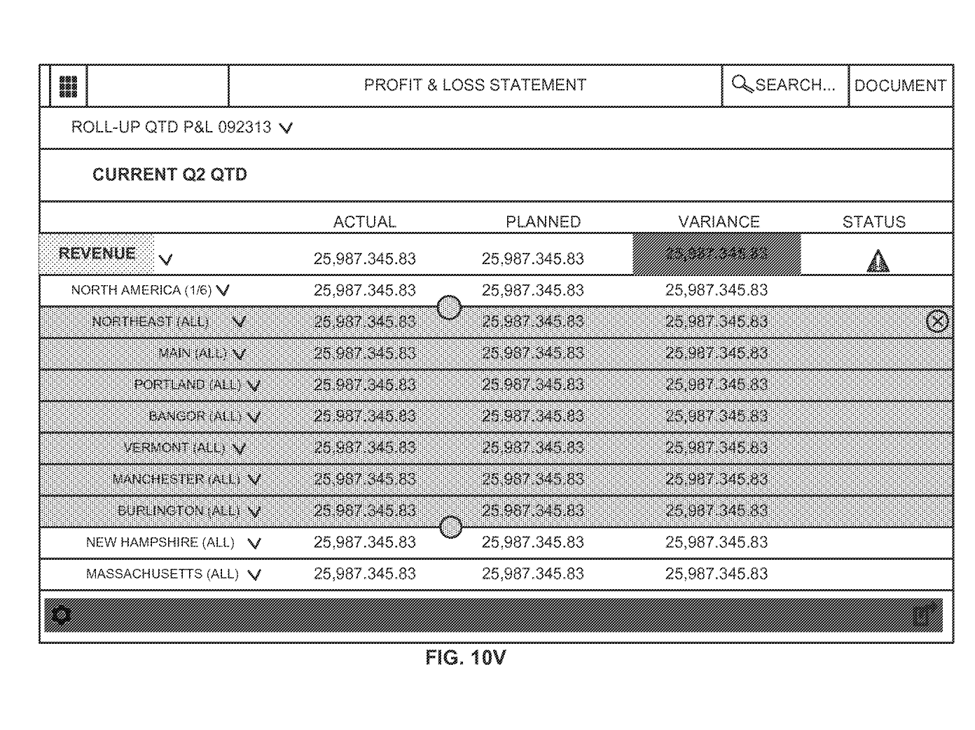

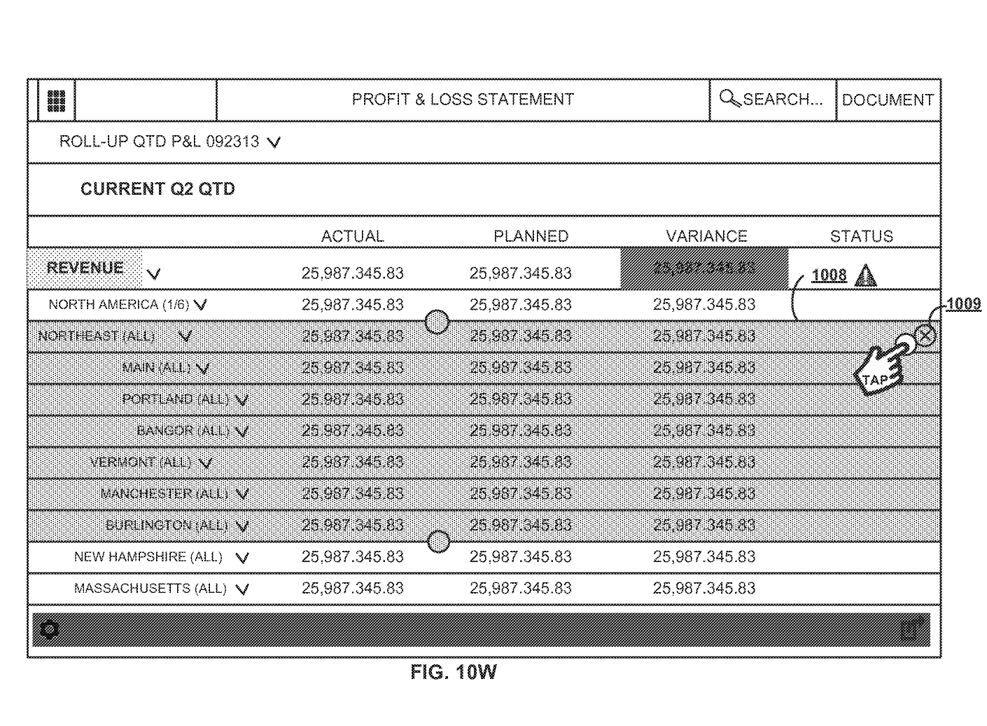

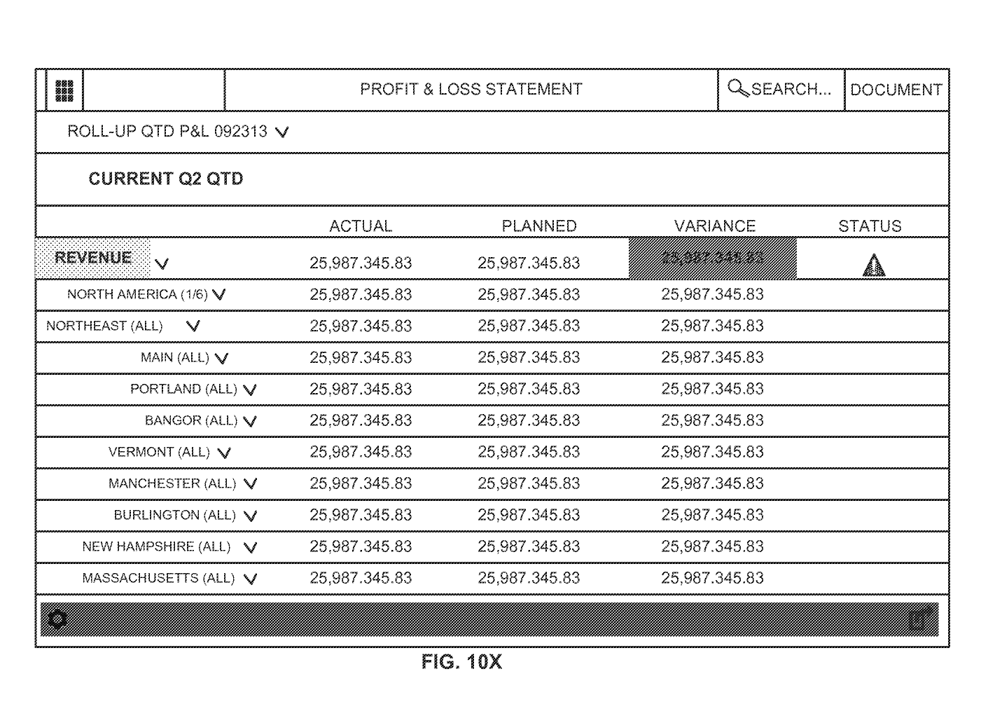

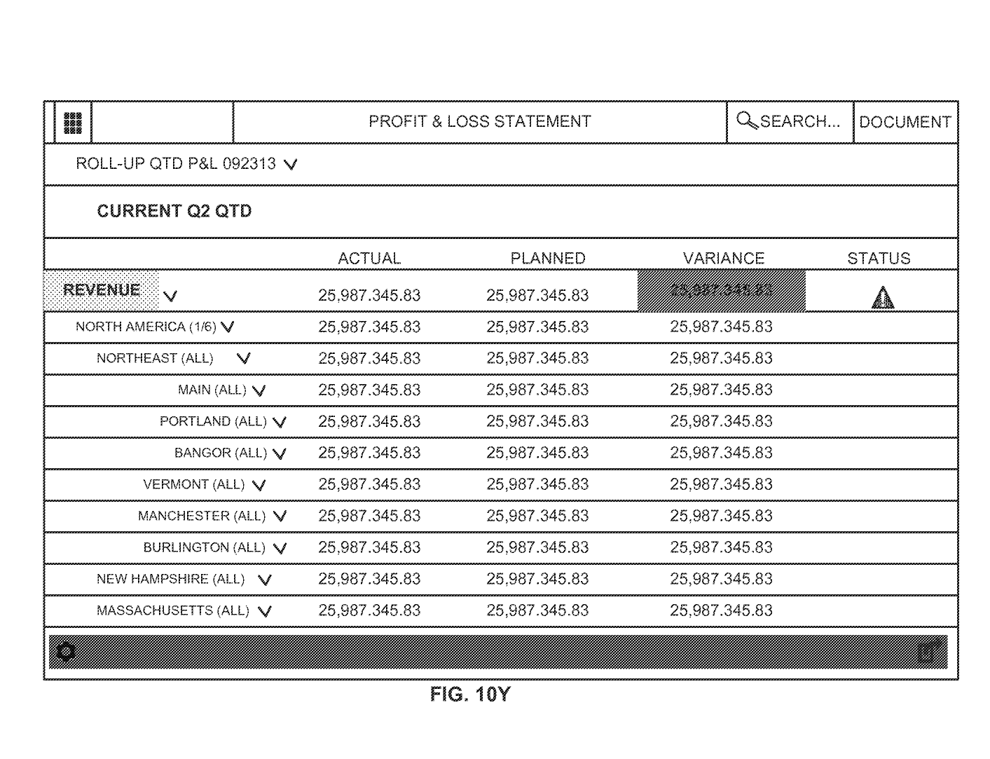

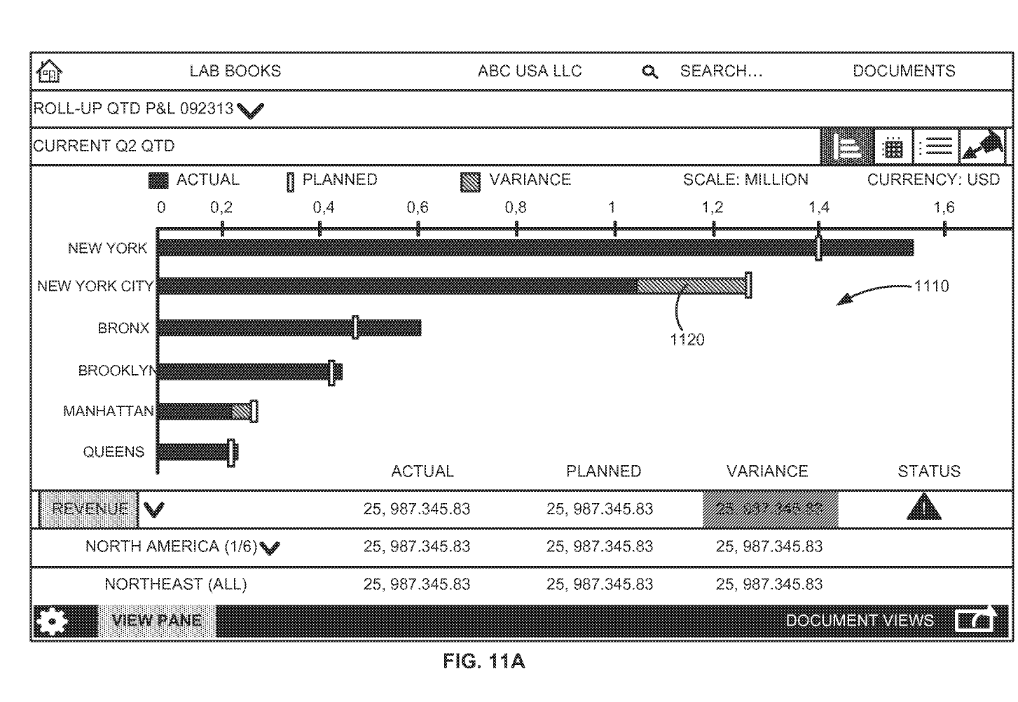

FIG. 10A-FIG. 10Y illustrate a dynamic multi-select hierarchical tree selection using a view pane, according to an embodiment. FIG. 10A shows the user pinches-out on screen to variably open a view-pane window 1001. In FIG. 10B, the user continues to “pinch-out.” FIG. 10C shows that the user releases pinch gesture and view pane 1002 is displayed. FIG. 10D-FIG. 10E show that using a 2-finger drag-down gesture the user drags the view pane 1002 to a new location over the financial data table and then releases touch. FIG. 10F shows that the view pane 1002 is now located at its resting position. In an embodiment, the user drags the panes extend control upward to include additional rows, as shown in FIG. 10G.

Referring to FIG. 10H, the user may taps on view pane 1002 in ‘edit mode.’ In an embodiment, the edit mode may be highlighted, e.g., in dark blue color. FIG. 10I shows that after the user taps on view pane 1002 in edit mode, the view pane 1002 automatically performs auto-re-justification on row labels within the view pane. FIG. 10J shows that the user drags the view pane 1002 up to a new location. FIG. 10K shows the UI after the user releases the 2-finger gesture. In an embodiment, the user drags the view pane bottom up to a new location, as shown in FIG. 10L. As shown, the user drags the view pane bottom up using a single figure drag gesture. In FIG. 10M the user releases the single figure drag gesture. FIG. 10N shows that the user long-presses on the view pane. Upon long-press, a pane action menu 1004 is displayed. The user may select a pane action menu item from the pane action menu 1004, as shown in FIG. 10O. For example, the user may select the pane action menu item “drill-down.” Once the pane action menu item (e.g., drill-down) is selected, the hierarchical row dimensions below the Northeast region (previously situated in the view pane) is displayed, as shown in FIG. 10P. Therefore, the cells included below the Northern region (drill-down) in the view pane is displayed and the view pane 1005 gets extended to view pane 1006 (FIG. 10P). FIG. 10Q shows the user drags the bottom of the view pane 1006 upward using single figure gesture.

Referring to FIG. 10R, once the user moved upward at desired position and release finger, an active view pane 1007 now adjusted to include “All” the Northeast with main and Vermont dimensions delineated below. FIG. 10S shows the user long-presses on the view pane 1007. Again, in FIG. 10T, the user selects the pane action menu item (e.g., drill-down). As shown in FIG. 10U, the view pane 1007 gets expanded to view pane 1008 to display the next hierarchical levels below Northeast/Main/Vermont Categories. In an embodiment, the hierarchical tree-representation is initially displayed in a “flat” indentation. In an embodiment, the “auto-correction” animation immediately commences to compensate the hierarchical tree view indentations in a more appropriate manner.

FIG. 10V shows that the “auto-correction” animation continues to compensate the hierarchical tree view indentations in a more appropriate manner. FIG. 10W shows a view pane 1008 once the auto-correction on indentations is complete. The user may tap on a “close” button 1009 to dismiss the view pane 1008. Based upon the action performed in FIG. 10W, the view pane 1008 gets dismissed, as shown in FIG. 10X. The hierarchical left indents now begin to move back to “standard view” locations. FIG. 10Y shows that the hierarchical left indents now begin to move back to “standard view” locations. The view pane justification is now restored to a non-focused view pane state.

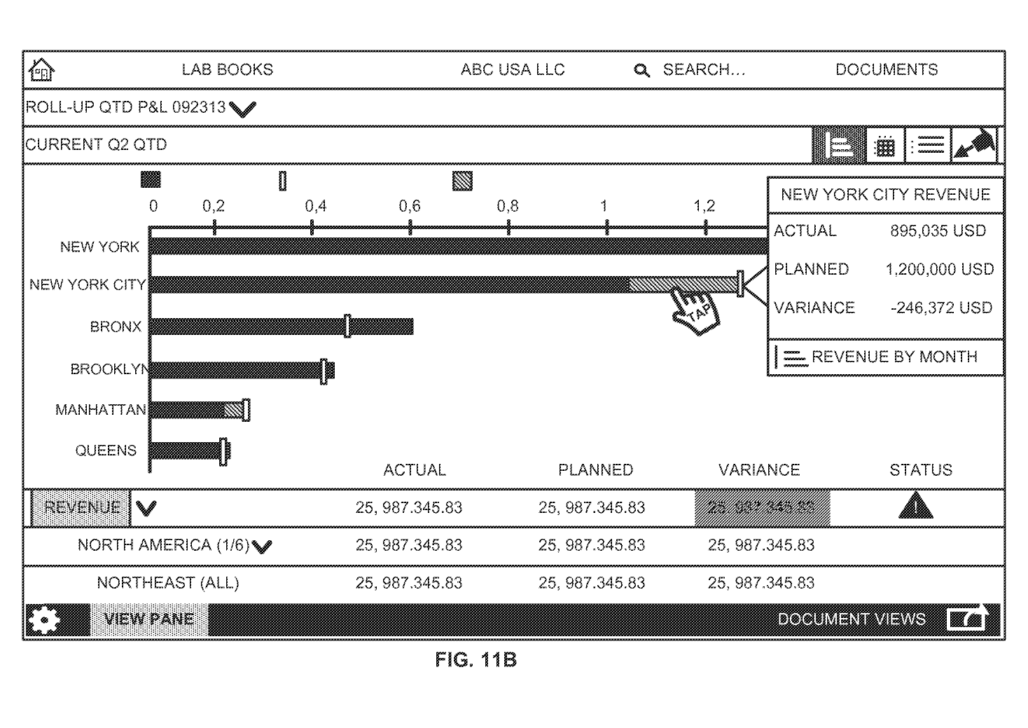

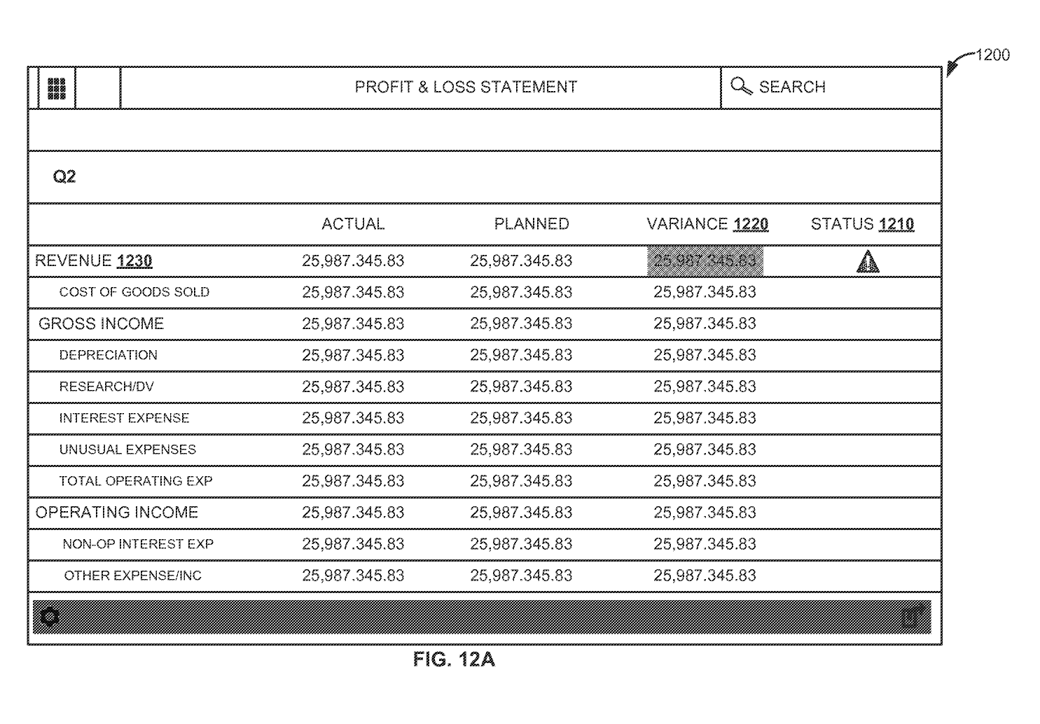

Referring back to FIG. 9, the field-in-focus of the view pane 910 can be viewed graphically. For viewing the field-in-focus graphically, the user can tap on the graphical display icon 940. Once the graphical icon 940 is tapped, a graphical representation 1110 (FIG. 11A) is displayed at the top of the data table. In an embodiment, the graphical representation 1110 is interactive, e.g., a highlighted part of the graphical representation, e.g., 1120 when clicked displays various information related to the highlighted part 1120, as shown in FIG. 11B.

In an embodiment, any data within the document (report) can be viewed graphically at any hierarchical level. For example, the user may click on a ‘customer’ row to view one or more customers positioned in next hierarchical level, the user can click on a graphical icon (similar to the graphical display icon 940) positioned at the top of the document to display the customers data graphically. In an embodiment, the graph may be interactive to provide various relevant information related to the customers. The graph can be analyzed easily. Once the problem is identified in the graph, e.g., if problem is identified as associated with the customer ‘XYZ’ then the user can switch to the table view by clicking on a tabular icon (not shown) displayed at the top of the document and drill-down on customer ‘XYZ’ to view required customer data (e.g., projects for the customer, consultants associated with respective projects, etc).

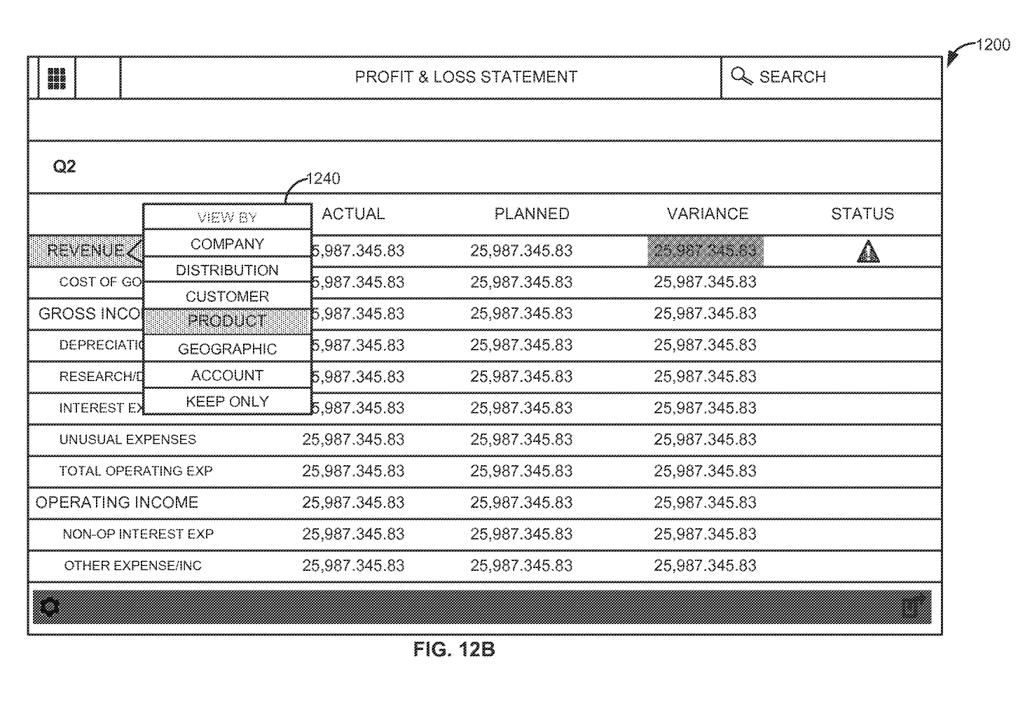

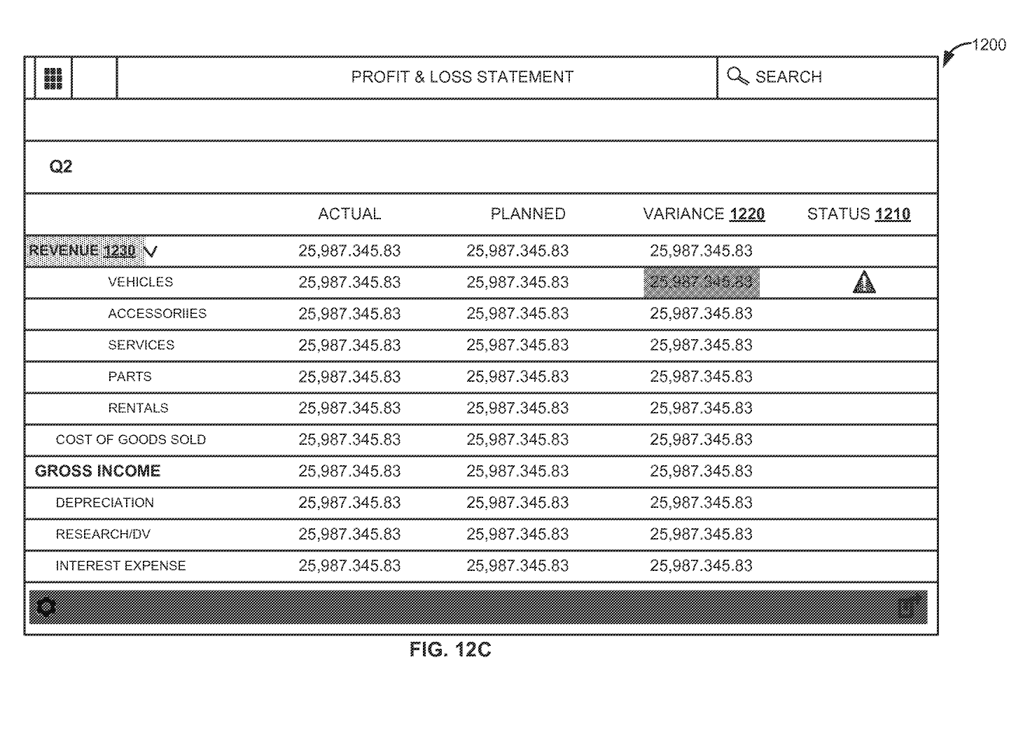

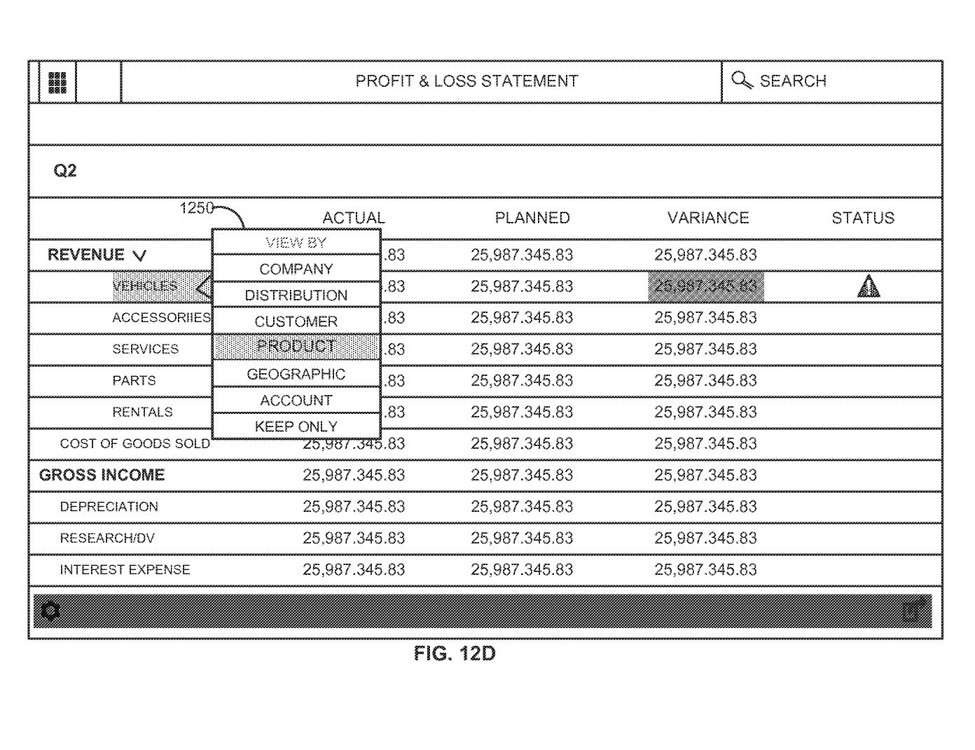

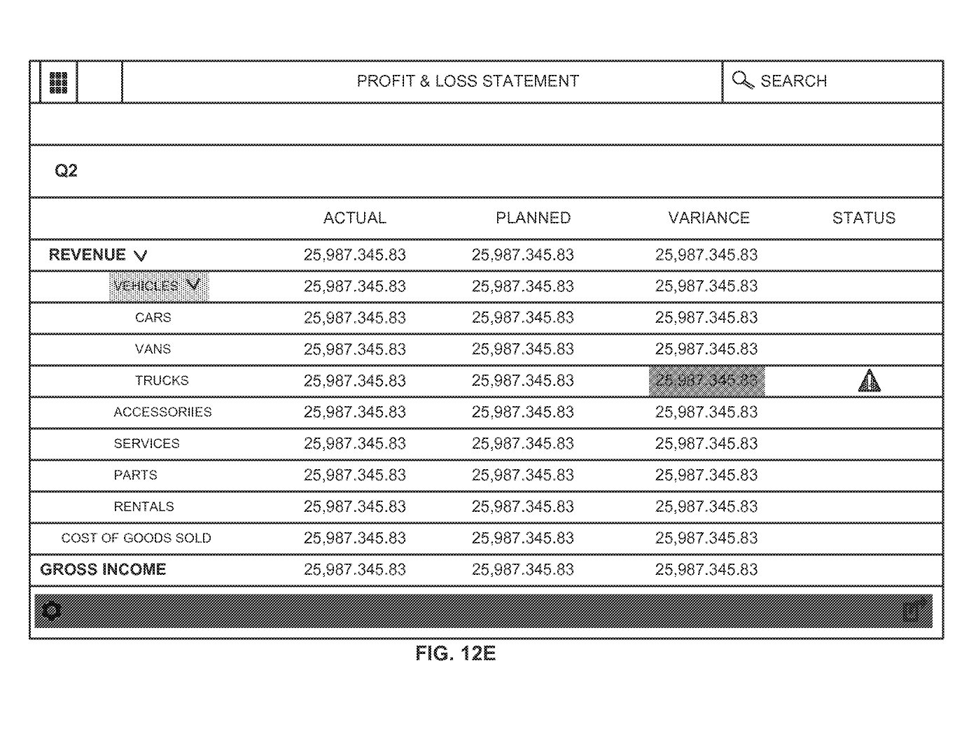

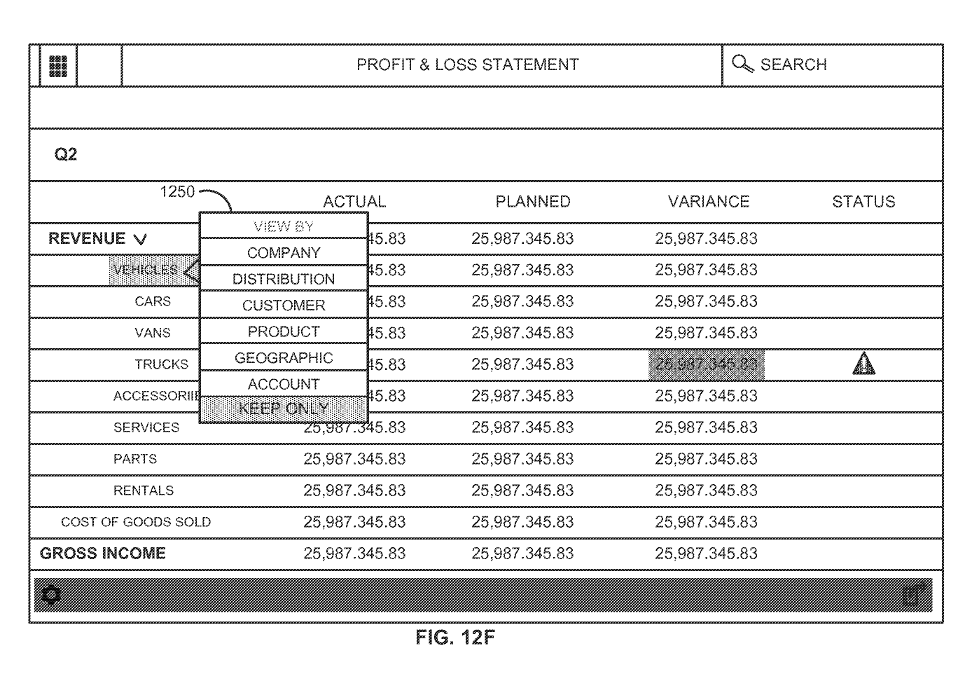

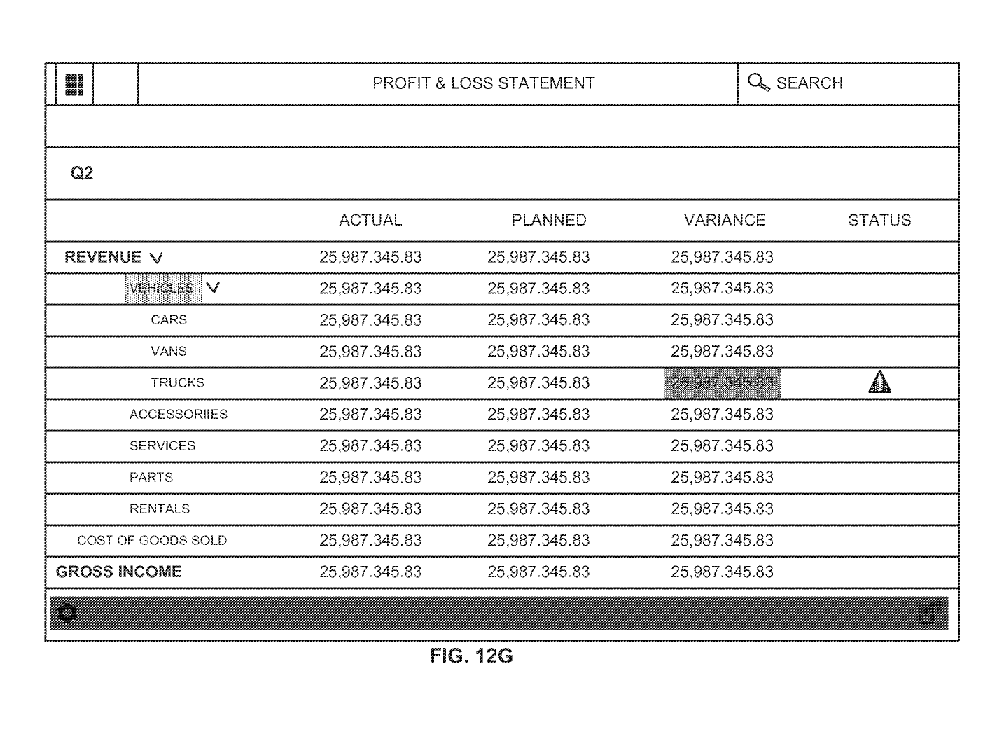

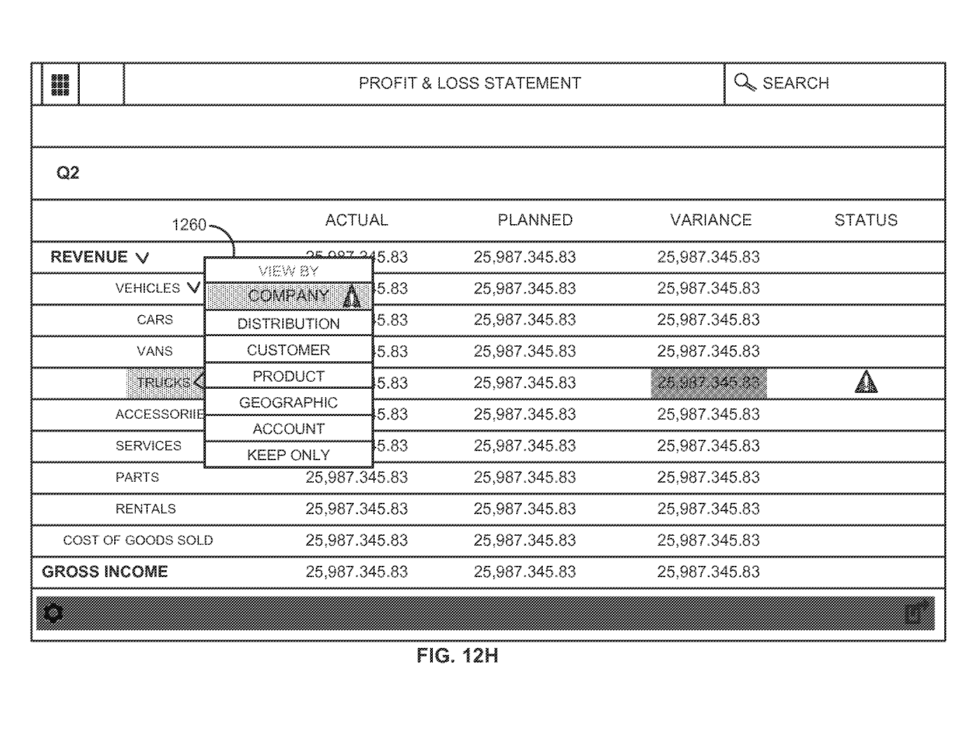

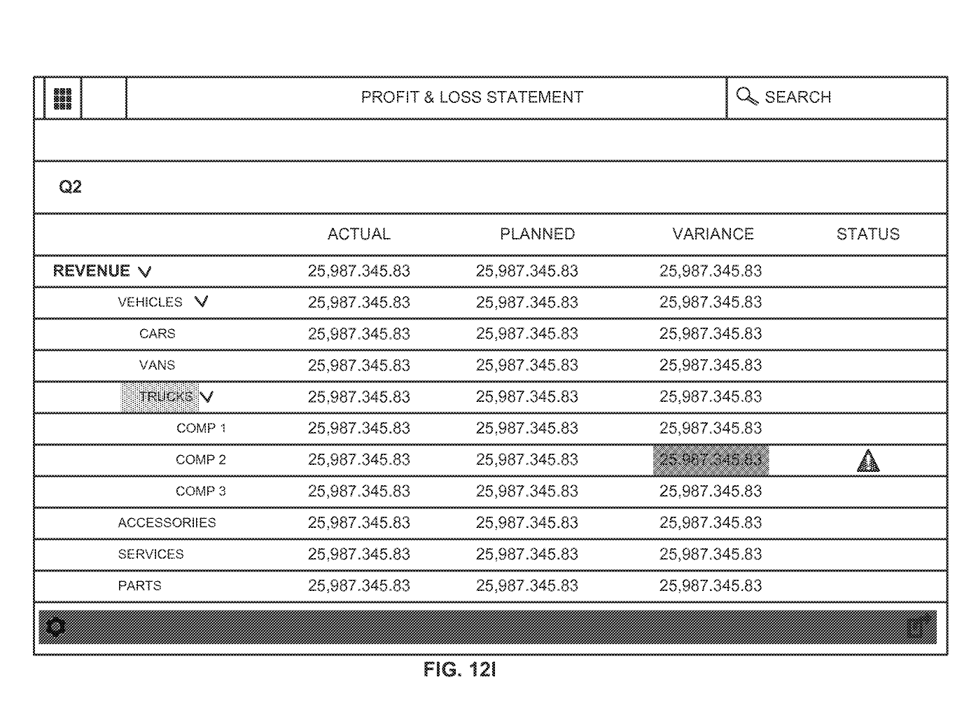

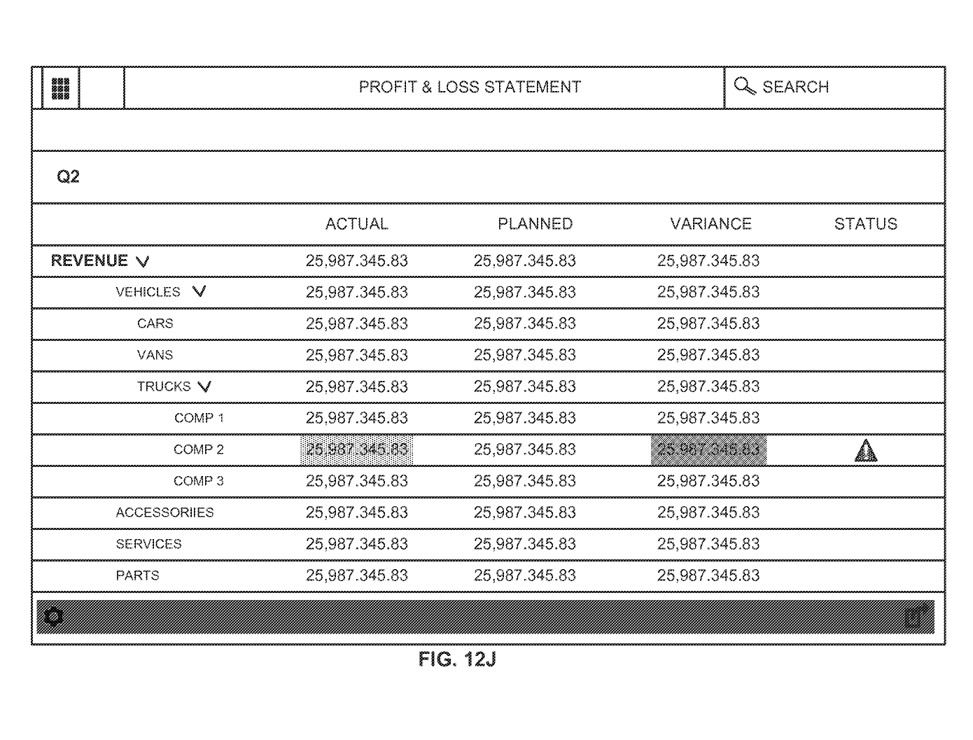

FIG. 12A-FIG. 12J illustrate a ledger document (P&L statement 1200) explored for an identified issue, according to an embodiment. Referring to FIG. 12A, the P&L statement document 1200 shows a potential problem in Q2 revenue. In an embodiment, a status column 1210 indicates the problem by displaying an ‘alert icon’ for the revenue. The specific problem may be indicated by color highlighting. For example, a variance value 1220 for the revenue is highlighted to indicate the problem is associated with the variance value of the revenue. In an embodiment, the variance problem may be determined programmatically by executing the algorithm (problem finder) in the backend. The algorithm may be known state-of-art algorithm. Once the problem is determined, the problem is highlighted on the P&L statement document 1200. The user can investigate the indicated problem.

For investigating the problem, the user selects (taps on) a revenue row label (e.g., revenue 1230). In response, hierarchical dimension options, e.g., menu ‘view by’ 1240 (FIG. 12B) corresponding to the revenue 1230 is rendered. The menu ‘view by’ 1240 provides various options for filtering the revenue 1230, e.g., the revenue can be displayed or filtered by ‘company,’ ‘customer,’ ‘product,’ etc. In another embodiment, when a user selects (taps on) the revenue row label (e.g., revenue 1230), a cell action menu (not shown) is displayed. The cell action menu includes various options including the ‘view by’ option, ‘pivot rows to columns’ to change document layout (e.g., show rows as columns) for purpose of analysis, ‘keep only’ to keep just the selected revenue row, and ‘remove only’ to remove just the selected row. Similarly, when the user selects (taps on) a column element (e.g., actual), a column action menu (not shown) may be displayed. The column action menu includes ‘pivot columns to rows’ option to change document layout (e.g., show columns as rows) for purpose of analysis, ‘keep only’ to keep just the selected column, and ‘remove only’ to remove just the selected column.

Referring to FIG. 12B, the user can select one of the options from the menu ‘view by’ 1240. For example, the user selects the option ‘product.’ Upon selecting the ‘product,’ the revenue is displayed by product. FIG. 12C shows revenue by product categories displayed under revenue. For example, the product categories include ‘vehicles,’ ‘accessories,’ ‘parts,’ etc. In an embodiment, the revenue is highlighted (e.g., blue color) to show context of last invoked action. In an embodiment, this highlighting fades out not to distract the user. As shown, the alert highlighting is moved or shifted to ‘vehicle’ variance of the product categories. Therefore, it can be identified that the revenue problem is associated with the product ‘vehicle.’

Referring to FIG. 12D, for further investigating the problem, the user selects (taps on) the ‘vehicle.’ In response, hierarchical dimension options (e.g., menu 1250) corresponding to the vehicle is rendered. The menu 1250 provides various options for filtering the product vehicle by ‘company,’ ‘customer,’ ‘product,’ etc. The user can select one of the options. For example, the user selects the option ‘product,’ shown as highlighted area. Upon selecting the ‘product,’ the vehicle is displayed by product. FIG. 12E shows vehicle by product categories displayed under revenue. For example, the product categories under vehicle include ‘card,’ ‘vans,’ and ‘trucks.’ In an embodiment, the vehicle is highlighted (e.g., blue color) to show context of last invoked action. In an embodiment, this highlighting fades out not to distract the user. As shown, the alert highlighting is moved or shifted to ‘trucks’ variance of the product categories. Therefore, it can be identified that the problem is associated with the product ‘trucks’ variance of the vehicle.

Upon identifying the problem, the user desire to focus on the financial data corresponding to the revenue of ‘vehicle’ and clear the screen or other variance (e.g., ‘accessories,’ ‘service,’ ‘parts,’ etc) which is of no further interest. Referring to FIG. 12F, the user selects (taps on) the ‘vehicle.’ Upon selecting the ‘vehicle,’ the hierarchical dimension options (e.g., menu 1250) corresponding to the vehicle is rendered. One of the options within the menu is ‘keep only.’ The user taps on the option “keep only” to only keep the financial data corresponding to the revenue of ‘vehicle’ and remove other data on the screen, as shown in FIG. 12G. In an embodiment, when the user re-opens the menu 1250 again after ‘keep only’ is selected (as shown in FIG. 12G), the ‘keep only’ is changed to ‘restore all rows.’ Referring back to FIG. 12G, as the alert highlighting or problem is indicated with the ‘trucks,’ the user taps on the ‘truck’ to display the hierarchical dimension options (e.g., menu 1260) corresponding to the ‘truck,’ as shown in FIG. 12H.

Referring to FIG. 12H, the user may desire to investigate the ‘truck’ by company and therefore, the user selects ‘company’ (highlighted area) on the menu 1260. When the user selects the ‘company,’ the financial data corresponding to ‘truck’ revenue is displayed by companies. Truck by company categories are displayed, as shown in FIG. 12I. In an embodiment, the truck is highlighted (e.g., blue color) to show context of last invoked action. In an embodiment, this highlighting fades out not to distract the user. As shown, the alert highlighting is now displayed on ‘company 2’ variance of the truck. Therefore, it can be identified that the revenue problem of truck is associated with the company 2.

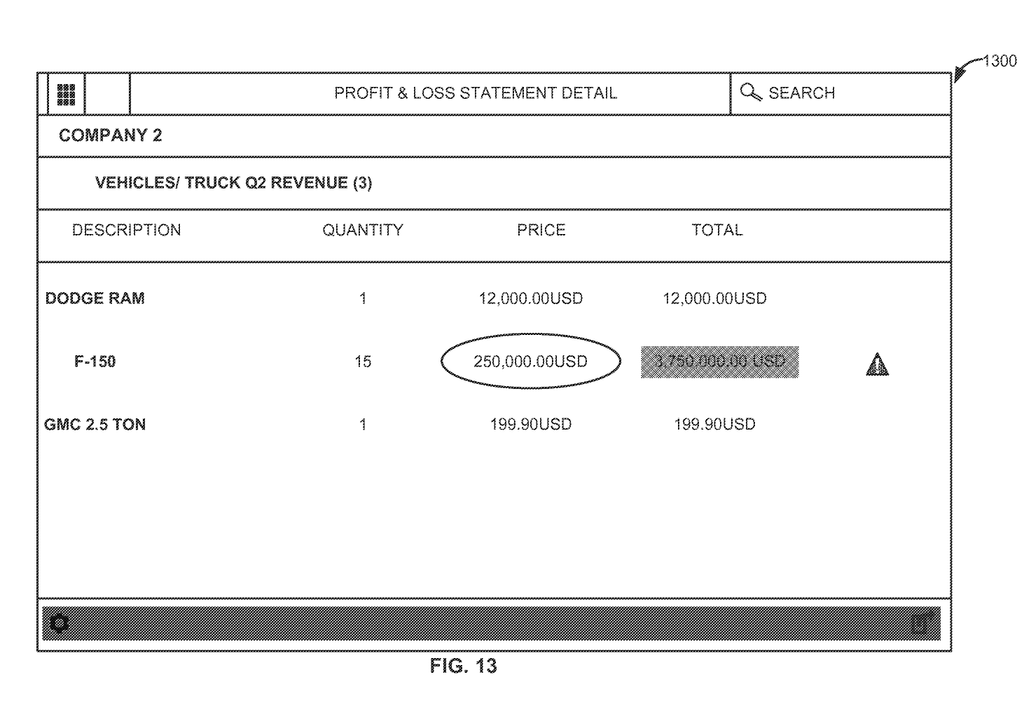

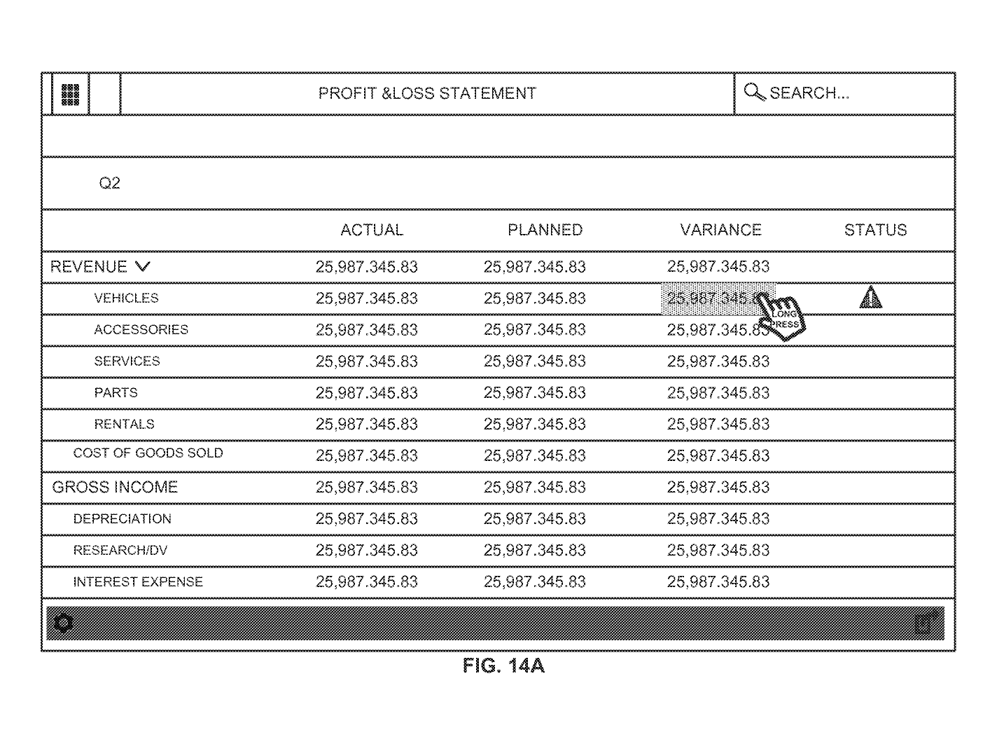

Referring to FIG. 12J, the user desire to drill down to ‘actual revenue number’ for company 2 trucks and selects (taps on) the corresponding data cell including the ‘actual revenue number.’ In response to the selection on the data cell, financial data corresponding to Q2 trucks revenue for company 2 is displayed, as shown in FIG. 13. FIG. 13 shows the P&L statement detail document 1300 including financial data corresponding to Q2 for trucks revenue for company 2. As shown, the alert highlight is now displayed on total sales for the truck model F-150, shown as highlighted area. Once the problem is identified, the user may share the hunt or search using the collaborator. In an embodiment, the user can also communicate these finding to required recipients such as company 2 controller.

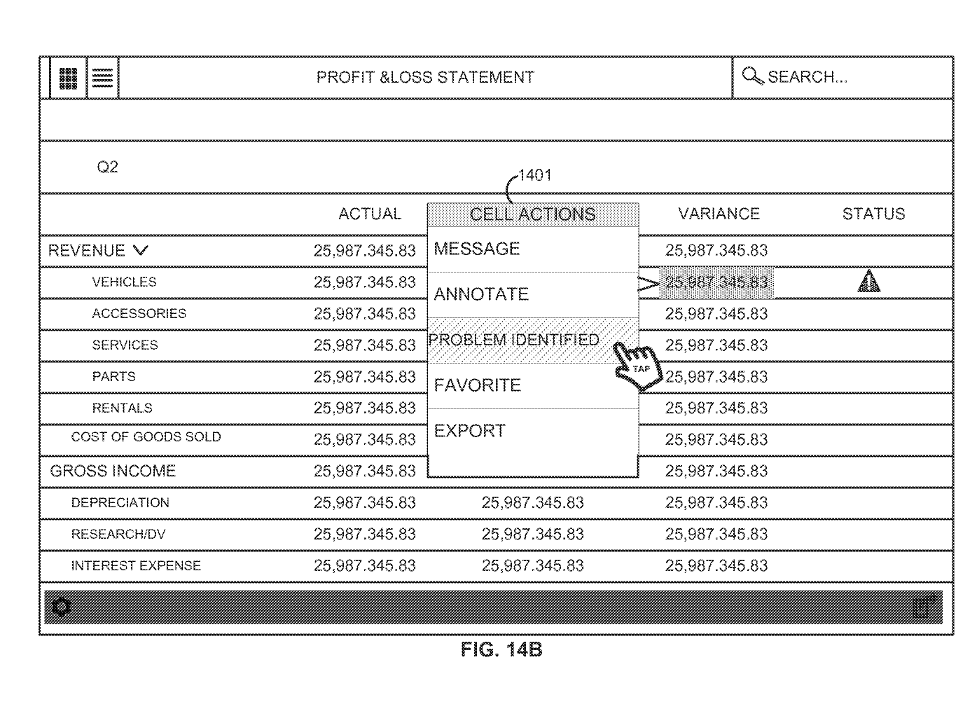

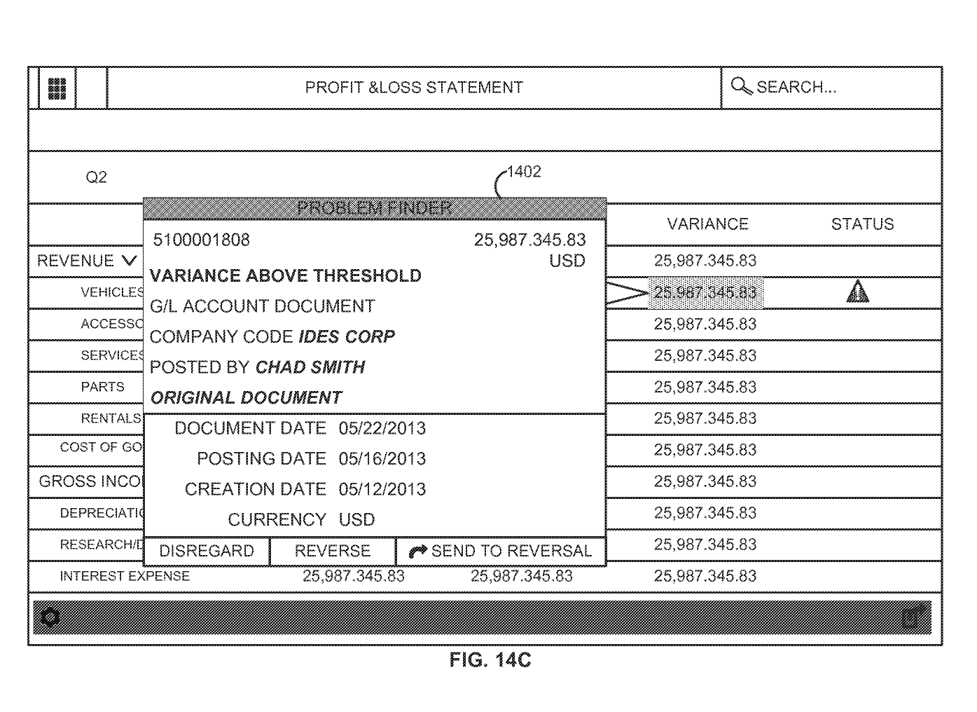

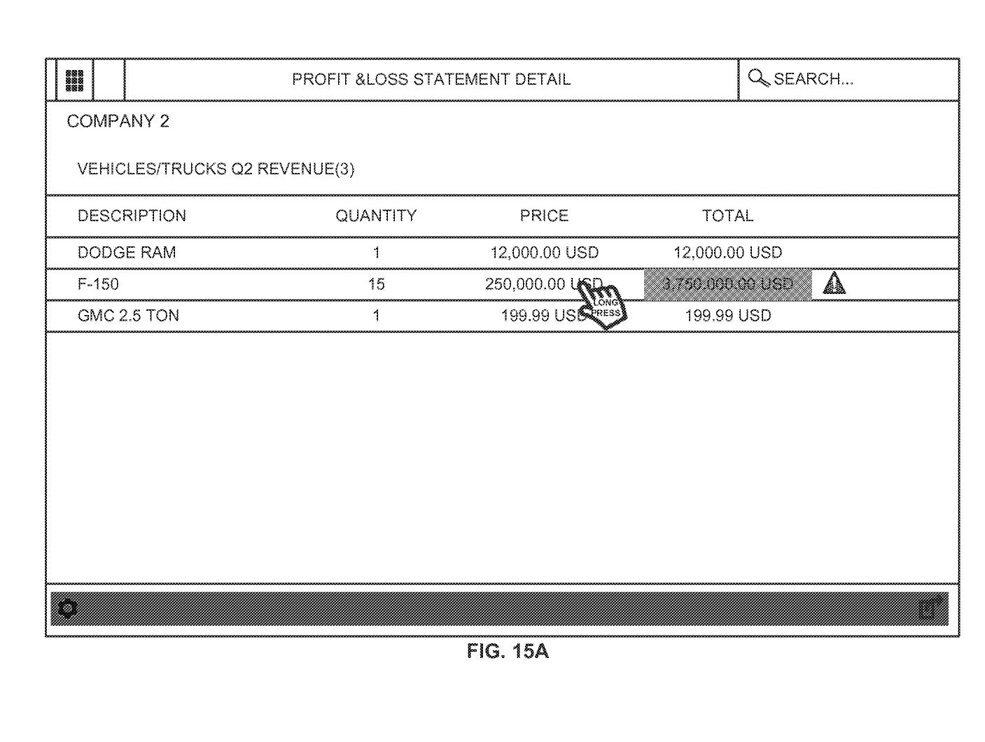

FIG. 14A-FIG. 14C illustrate invoking a problem detector UI from a highlighted cell indicated with a potential problem to get details on the potential problem and the problem status. FIG. 14A shows a highlighted cell which indicates a potential problem that has been identified by the problem finder. The user selects the cell to investigate the identified problem. In one embodiment, the user can long press (e.g., on tablet) or double click (e.g., on desktop) on the cell to select the cell. In an embodiment, if the user simply taps or single-clicks on the cell (not long-press or, double click), a standard drill-down view is displayed whereby the numbers or documents that “make-up” the highlighted number (e.g., highlighted variance number) are shown. When the user selects, e.g., long press, the identified cell, a cell action menu 1401 is displayed (FIG. 14B). The cell action menu 1401 displays various options. In one embodiment, the user selects an option ‘problem identified’ to get details or a description of the potential/detected problem. Upon selection of ‘problem identified’ option, a ‘problem finder’ popover 1402 (FIG. 14C) is displayed. In an embodiment, the problem finder may be a full screen view. The ‘problem finder’ popover 1402 displays description of the potential problem detected, as shown. In an embodiment, other details related to the document may also be displayed. In an embodiment, the user may also be provided with the actions such as disregard, reverse, or send for reversal by another person, etc. Additional affordances (e.g., icons or other indications) may be displayed adjacent the highlighted number itself or in the status column to indicate if the issue resolution is in-progress, addressed/fixed, or disregarded states. In case the problem is fixed and approved, the highlighting is removed from the cell/number.

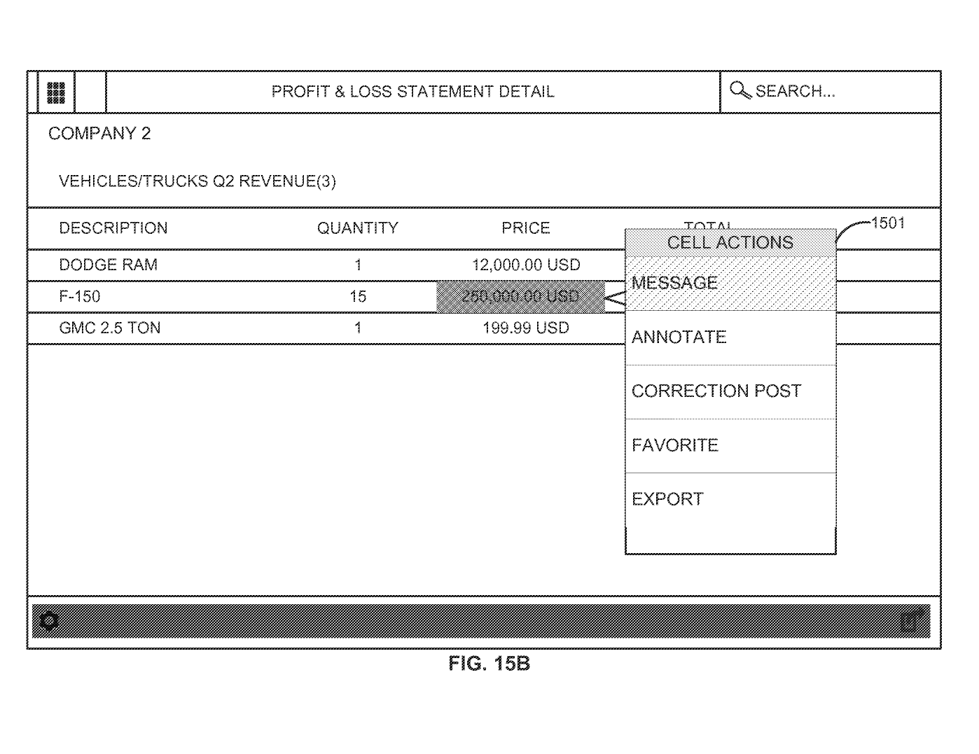

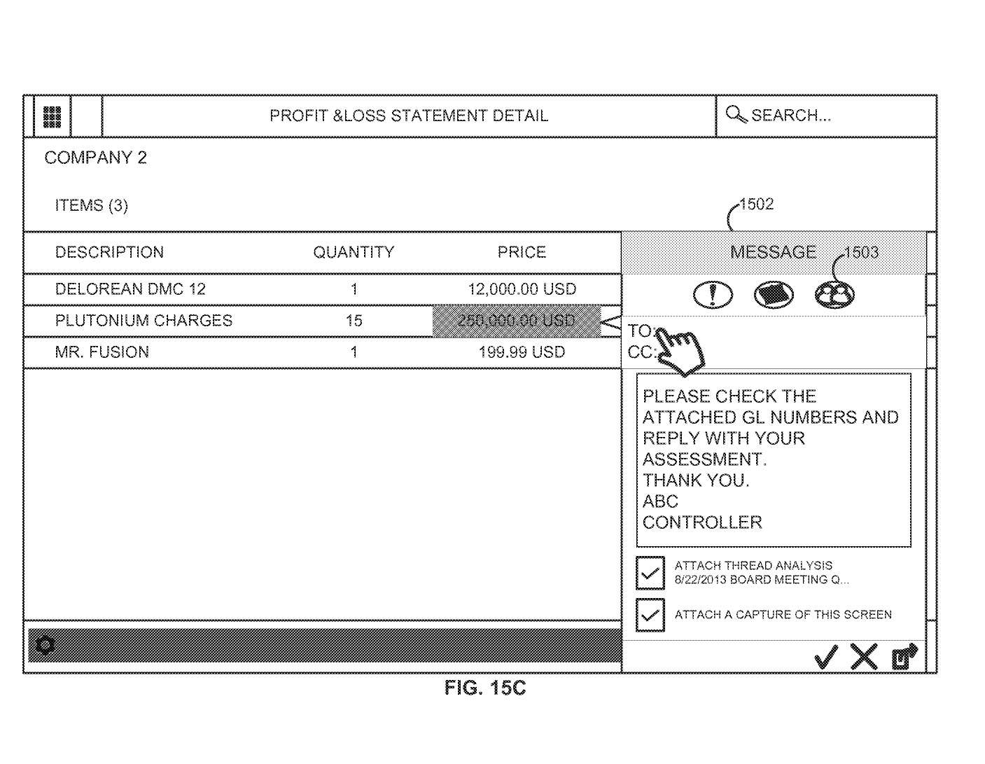

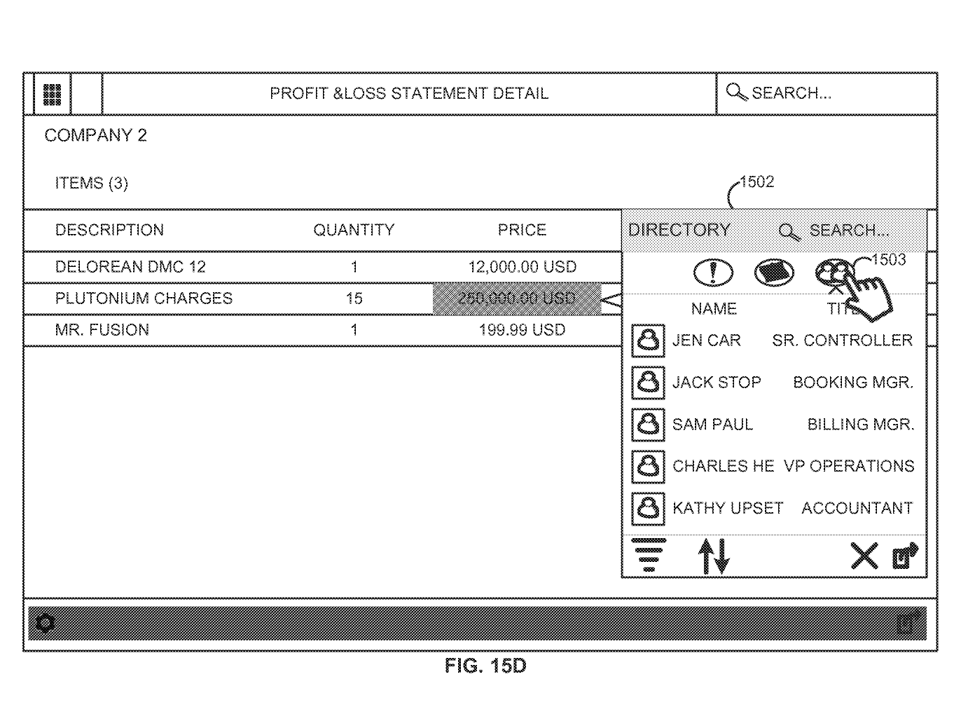

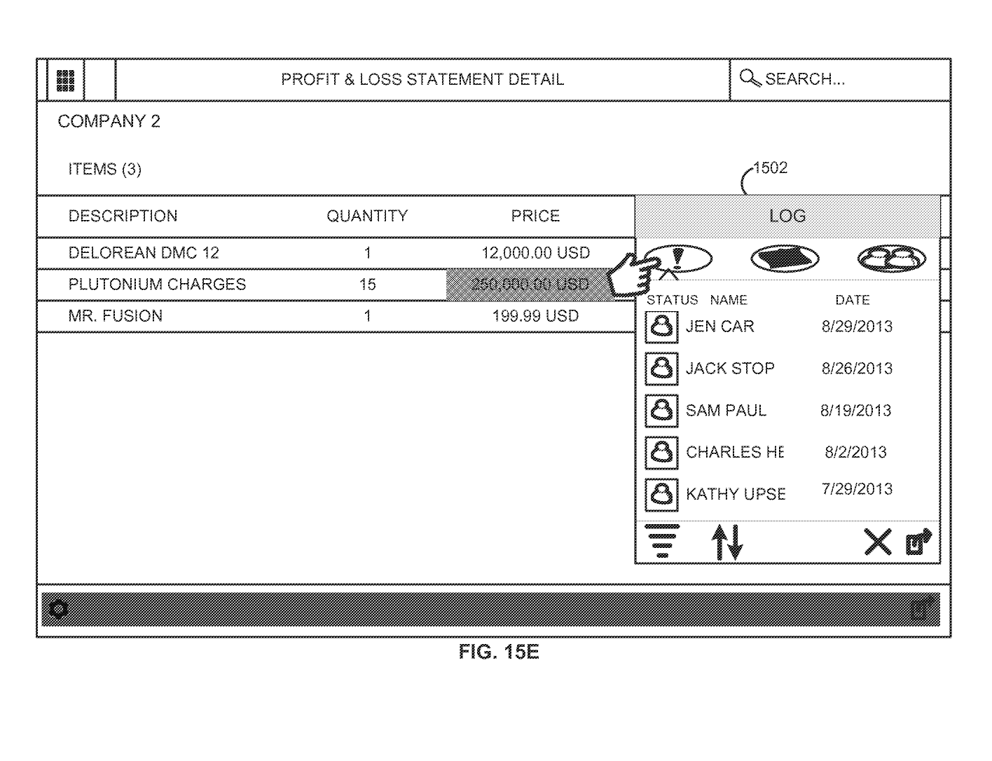

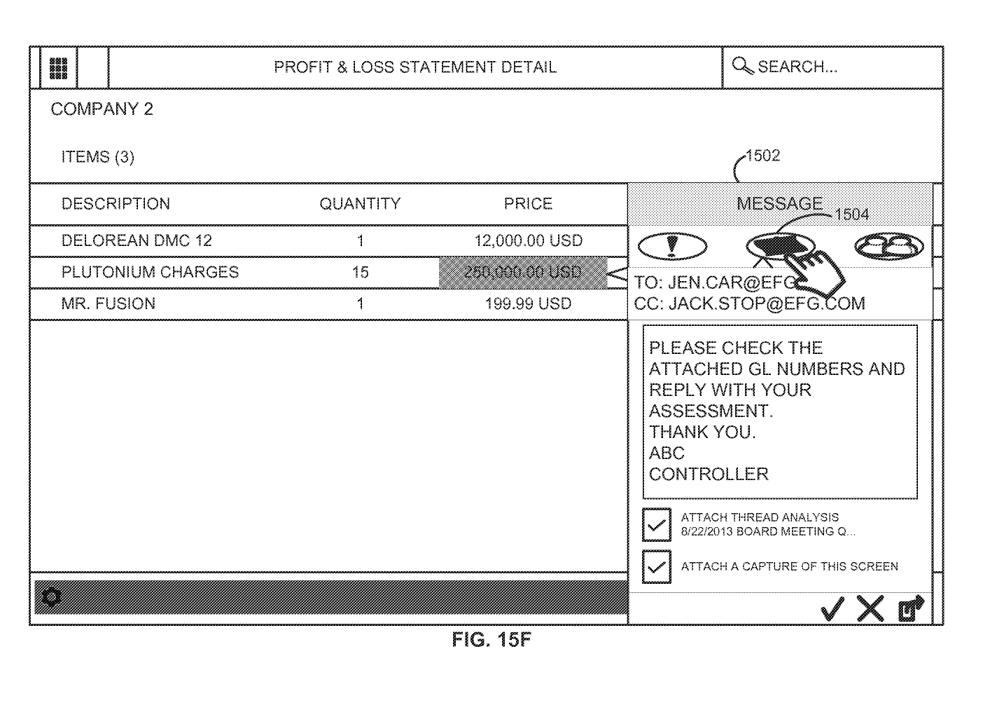

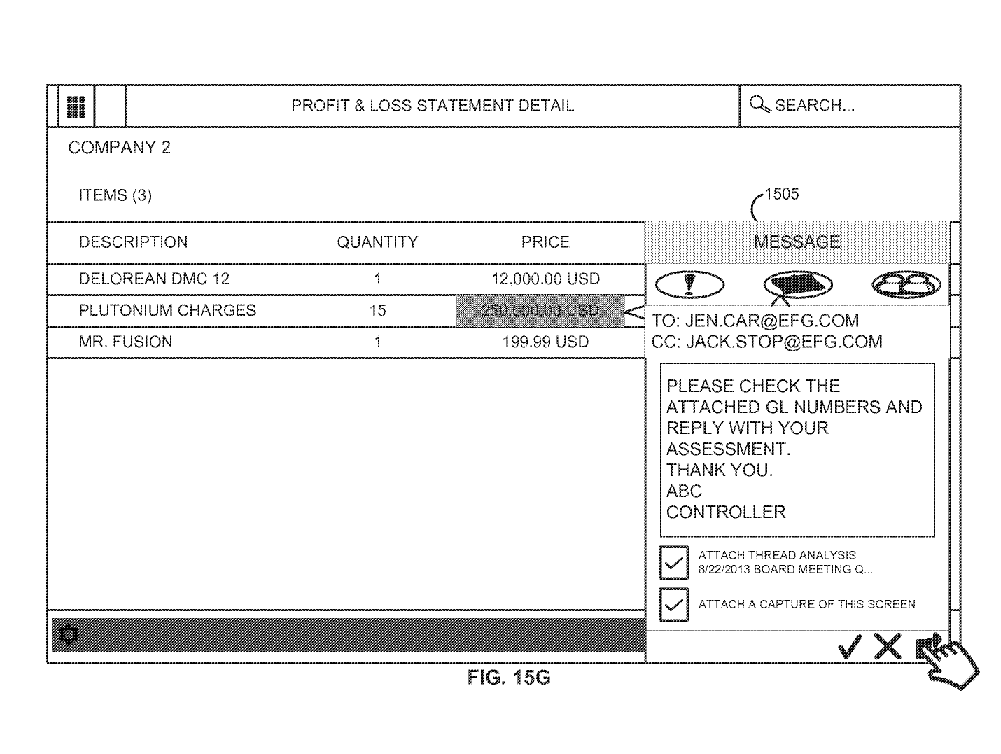

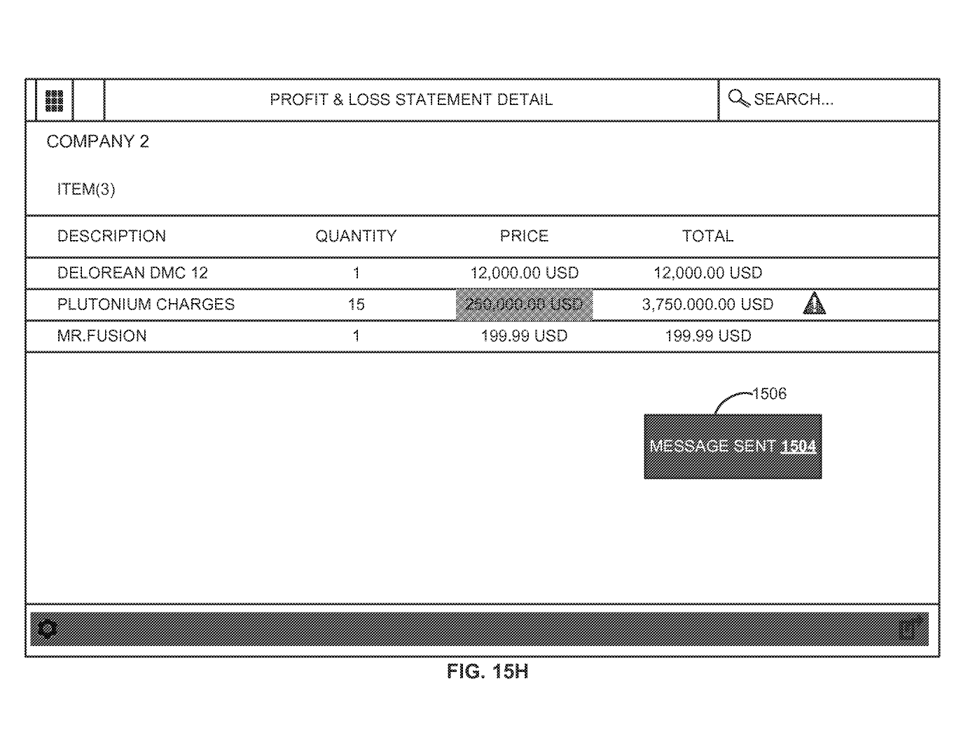

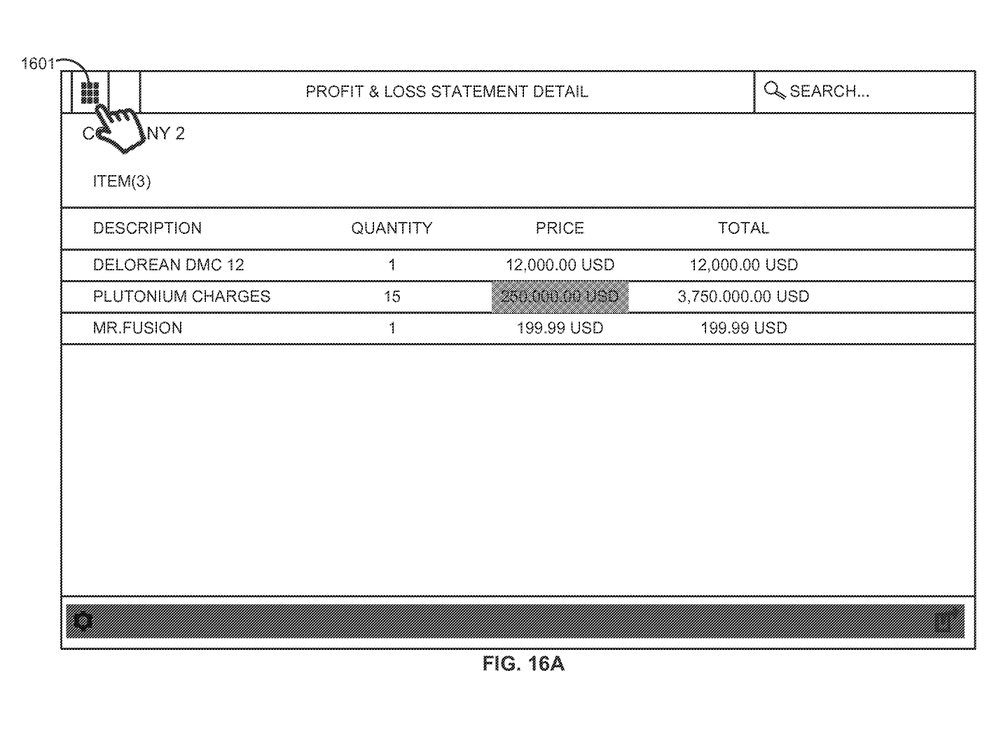

FIG. 15A-FIG. 15H illustrate a collaboration feature in a document level view, according to an embodiment. FIG. 15A shows that in the document level when the user long presses on a specific number, a cell action menu 1501 (FIG. 15B) is displayed. In an embodiment, instead of long press other secondary mode of operation such as double click, right click, mouse click, hold, drag, specific icon, etc., can be used to invoke the cell action menu. In an embodiment, when a first mode of action is performed like single press or tap on the number, a next financial number or numbers which make up the selected number is displayed. In an embodiment, the next financial number or numbers may be another document level such as invoice or a billing. In an embodiment, the cell action menu 1501 includes options like ‘message’ to send message to others, ‘annotate’ to post a note of the selected number (cell) to themselves or others, ‘correction post,’ ‘favorite’ to mark as favorite for recall at later time, ‘save as tile’ to save the data (cell or selected number) as a tile on a home page, and ‘export’ to export number or group of numbers which make a selected number to another applications such as Microsoft Excel®.

FIG. 15C-FIG. 15G illustrate an exemplary collaborator UI (e.g., a message popover 1502) which is displayed upon selecting message option from the cell action menu 1501 for sending message. In an embodiment, when the ‘message’ is selected (tapped) from the cell action menu 1501, another menu (not shown) is displayed including options for various mode of communication which can be used. The modes of communication comprise, but are not limited to, in-app messaging, emails, blogs or social media, SMS, phone, corporate collaboration network, etc. One of the modes of communication may be selected by the user for sharing messages or information with others. In another embodiment, when the ‘message’ option is selected from the cell action menu 1501, the message popover 1502 is displayed (FIG. 15C). The collaborator UI or message popover context is directly associated with the selected cell.

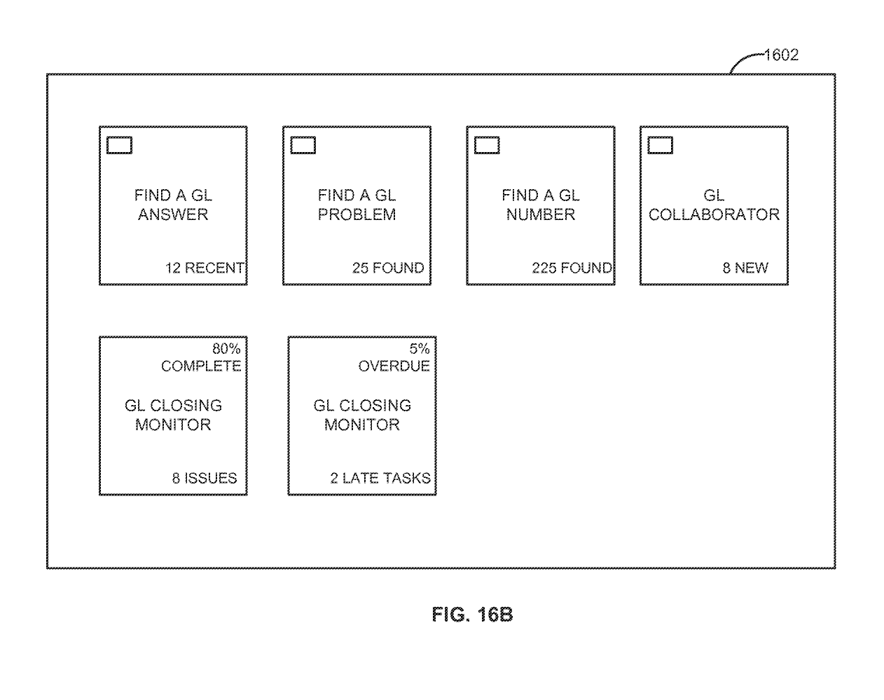

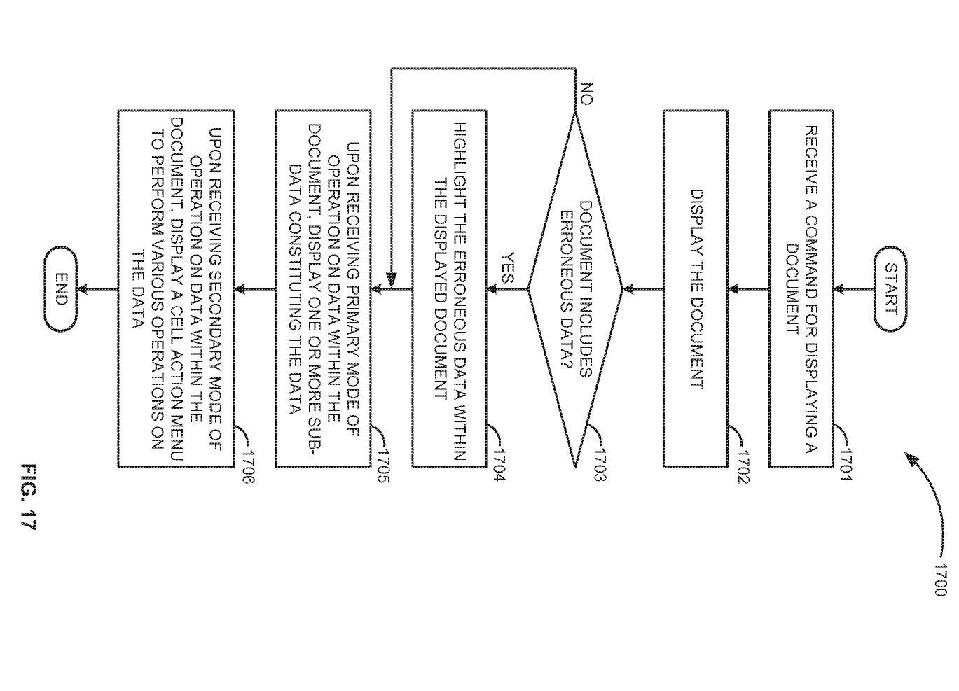

As shown in FIG. 15C, the user can tap on a “To” field to enter a recipient's name/email address to whom the message is to be sent. In an embodiment, the “To” field may be entered by tapping on a contact tab icon 1503. FIG. 15D shows user selecting the contact tab icon 1503 to refer to directories of the recipients. In an embodiment, the message UI allows for multiple channel communication such as note communication, email, SMS, phone, in-app, blogs, social media, enterprise network collaboration, etc. FIG. 15E shows the directories of recipients, the user can select a contact person whom the message is to be sent. Once the contact person or recipient is selected, the user can select a log tab icon (‘i’). Upon selecting the log tab icon (i), a message UI 1504 is displayed, as shown in FIG. 15F. The user can then select a message body tab button to create their message, note, blog, etc. Once the message is composed, the user selects a send or post tab 1505, as shown in FIG. 15G. Once the message is sent, a confirmation message 1506 is displayed on the document, as shown in FIG. 15H. Once the confirmation message 1506 is displayed, the user may select to return to a home screen for further activities. FIG. 16A shows user selecting a home screen icon 1601 to return to a home screen 1602 (FIG. 16B).

In an embodiment, the users who are named as participants are permitted to participate in the collaboration activities. In an embodiment, the user and recipient actions are viewable and indicated on a “cell-level” in the UI to those that have been named in a collaborator list. In an embodiment, the collaborator's contacts list UI is also pre-optimized according to the context of an individual “cell financial number”. The default contact list view is pre-filtered to appropriate people and distribution lists either used in past collaborator communications or determined by customer configurations. The collaboration is stored/referenced “in context” to the information being collaborated on, so that later user can review a number and understand the discussions around that number. In an embodiment, upon sharing the data to one or more recipients, annotating the data, marking the data as favorite, and saving the erroneous data as a tile, an information or a reference key is stored on the data itself back to the communications so that later user can review a number and understand the discussions around that number.

A collaborator communication protocol provides for data cell and data view illustrations and visualizations as are required to efficiently inform recipients of content, context, and details surrounding the financial information being communicated in the collaborative task. One-click or limited multi-click selections efficiently attach or embed an image(s) of the financial document, links to the financial applications views, notes or annotations associated with the cell data, and other text descriptions or attachments to support, make the case for, or respond to a particular collaboration. This methodology is also suitable for cross-platform mobile and desktop devices and interactions.

In an embodiment, the dynamic multi-select hierarchical tree control UI provides the ability for a user to drill-down into multiple category hierarchies at varying levels and make one or more selections that would be displayed in the financial data table (e.g., P&L Statement). Hierarchical tree lists utilize indents towards the right to show relevant hierarchies for different levels, and thus presents a significant display problem, especially on mobile devices with limited screen. In large categories, for example, geographic and products, etc., there can be numerous hierarchies of categories and sub-categories. The dynamic multi-select hierarchical tree control UI solves the issue of requiring too much screen to display hierarchical tree lists. At the same time, the dynamic multi-select hierarchical tree control provides an optimized “user-relevant view” that limits the tree display to show only what is in context to user navigation selections and actions. Auto-adjust animation behaviors deliver an optimized and completely “relevant” screen view of hierarchical tree list structures. The “dynamic” characteristic provides a solution that automatically and dynamically re-displays tree levels through animations as the user makes selections or scrolls the tree-list. The animation sequence is also the system component that display's “relevant” hierarchies as the user actually makes selections and navigations when drilling down or up during unstructured investigations. Therefore, the user can efficiently perform analysis using various approaches specified in the above-mentioned embodiments.

FIG. 17 is a flowchart illustrating process 1700 to explore, analyze, and collaborate a document. At 1701, a command for displaying the document is received. Upon receiving the command, the document is displayed at 1702. At 1703, it is determined if the document includes an erroneous data. In an embodiment, an algorithm (e.g., state-of-art algorithms) is executed in backend to identify the erroneous data. When the document includes the erroneous data (1703: YES), the erroneous data within the document is highlighted at 1704. Once the document is displayed, user's operation is received on data within the displayed document. Upon determining a primary mode of operation on the data (e.g., erroneous data) within the displayed document, one or more sub-data constituting the data is displayed at 1705. In an embodiment, the single mode of operation comprises a single click. Upon determining a secondary mode of operation on the data (e.g., erroneous data) within the displayed document, a cell action menu is displayed at 1706. The cell action menu (e.g., menu 1601 of FIG. 16A) enables the user to perform at least one of sharing the data, sending the data, annotating the data, marking the data as favorite, saving the data as a tile on a home page, and exporting the data to other applications, e.g., Microsoft Excel®. In an embodiment, the secondary mode of operation comprises one of a double click, a right click, and long press.

Some embodiments may include the above-described methods being written as one or more software components. These components, and the associated functionalities, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. A computer readable storage medium may be a non-transitory computer readable storage medium. Examples of a non-transitory computer readable storage media include, but are not limited to: magnetic media, such as hard disks, floppy disks, and magnetic tape; optical media such as CD-ROMs, DVDs and holographic indicator devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment may be implemented using Java, C++, or other object-oriented programming language and development tools. Another embodiment may be implemented in hard-wired circuitry in place of, or in combination with machine readable software instructions.

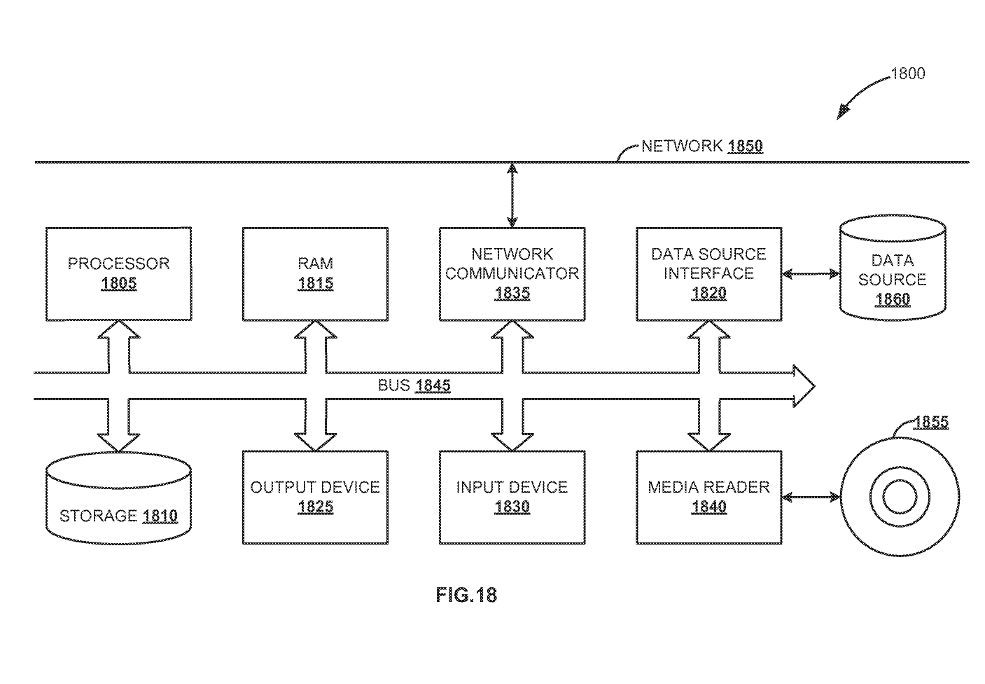

FIG. 18 is a block diagram of an exemplary computer system 1800. The computer system 1800 includes a processor 1805 that executes software instructions or code stored on a computer readable storage medium 1855 to perform the above-illustrated methods. The processor 1805 can include a plurality of cores. The computer system 1800 includes a media reader 1840 to read the instructions from the computer readable storage medium 1855 and store the instructions in storage 1810 or in random access memory (RAM) 1815. The storage 1810 provides a large space for keeping static data where at least some instructions could be stored for later execution. According to some embodiments, such as some in-memory computing system embodiments, the RAM 1815 can have sufficient storage capacity to store much of the data required for processing in the RAM 1815 instead of in the storage 1810. In some embodiments, the data required for processing may be stored in the RAM 1815. The stored instructions may be further compiled to generate other representations of the instructions and dynamically stored in the RAM 1815. The processor 1805 reads instructions from the RAM 1815 and performs actions as instructed. According to one embodiment, the computer system 1800 further includes an output device 1825 (e.g., a display) to provide at least some of the results of the execution as output including, but not limited to, visual information to users and an input device 1830 to provide a user or another device with means for entering data and/or otherwise interact with the computer system 1800. One or more of these output devices 1825 and input devices 1830 could be joined by one or more additional peripherals to further expand the capabilities of the computer system 1800. A network communicator 1835 may be provided to connect the computer system 1800 to a network 1850 and in turn to other devices connected to the network 1850 including other clients, servers, data stores, and interfaces, for instance. The modules of the computer system 1800 are interconnected via a bus 1845. Computer system 1800 includes a data source interface 1820 to access data source 1860. The data source 1860 can be accessed via one or more abstraction layers implemented in hardware or software. For example, the data source 1860 may be accessed by network 1850. In some embodiments the data source 1860 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open Database Connectivity (ODBC), produced by an underlying software system, e.g., an ERP system, and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments. One skilled in the relevant art will recognize, however that the one or more embodiments can be practiced without one or more of the specific details or with other methods, components, techniques, etc. In other instances, well-known operations or structures are not shown or described in details.

Although the processes illustrated and described herein include series of steps, it will be appreciated that the different embodiments are not limited by the illustrated ordering of steps, as some steps may occur in different orders, some concurrently with other steps apart from that shown and described herein. In addition, not all illustrated steps may be required to implement a methodology in accordance with the one or more embodiments. Moreover, it will be appreciated that the processes may be implemented in association with the apparatus and systems illustrated and described herein as well as in association with other systems not illustrated.

The above descriptions and illustrations of embodiments, including what is described in the Abstract, is not intended to be exhaustive or to limit the one or more embodiments to the precise forms disclosed. While specific embodiments of, and examples for, the embodiment are described herein for illustrative purposes, various equivalent modifications are possible within the scope of the embodiments, as those skilled in the relevant art will recognize. These modifications can be made to the embodiments in light of the above detailed description. Rather, the scope of the one or more embodiments is to be determined by the following claims, which are to be interpreted in accordance with established doctrines of claim construction.

What is claimed is:

1. A non-transitory computer readable medium to tangibly store instructions, which when executed by a computer, cause the computer to perform operations comprising:
receive a command for displaying a document;
based upon the received command, display the document;
determine whether the document includes an erroneous data;
upon determining the document includes the erroneous data, highlight the erroneous data within the displayed document; and
perform at least one of:
upon receiving a primary mode of operation on data within the document, display one or more sub-data constituting the data; and
upon receiving a secondary mode of operation on the data, display a cell action menu to perform at least one of sharing the data to one or more recipients, annotating the data, marking the data as favorite, saving the data as a tile on a home page, and exporting the data to other application.

2. The non-transitory computer readable medium of claim 1, wherein the primary mode of operation comprises a single click and the secondary mode of operation comprises one of a double click, a right click, and a long press on touch devices.

3. The non-transitory computer readable medium of claim 1, wherein the data within the document is the highlighted erroneous data.

4. The non-transitory computer readable medium of claim 1 including instructions, which when executed by the computer, cause the computer to perform operation further comprising at least one of:
upon receiving a command for editing one or more dimensions and their corresponding measures associated with the document, edit the one or more dimensions and their corresponding measures;
upon receiving a request for displaying one or more predefined row sets, display the one or more predefined row sets, wherein at least one row set of the one or more predefined row sets includes fields associated with the document;
upon receiving selection of a row set from the displayed one or more row sets, update the document row fields with corresponding fields included in the selected row set;
upon receiving a request for displaying one or more predefined column sets, display the one or more predefined column sets, wherein at least one column set of the one or more predefined column sets includes fields associated with the document;
upon receiving selection of a column set from the displayed one or more column sets, update the document column fields with corresponding fields included in the selected column set;
upon receiving a request to swap row fields with column fields of the document, swap the row fields with column fields of the displayed document; and
upon receiving a request to swap column fields with row fields of the document, swap the column fields with row fields of the displayed document.

5. The non-transitory computer readable medium of claim 1, wherein the document includes an option to toggle between a real-time view and a frozen-time view and wherein the real-time view displays data of the document in a current time and the frozen-time view displays data of the document in one of a selected time and the time when a screenshot of the document is taken.

6. The non-transitory computer readable medium of claim 1 comprising instructions, which when executed by the computer, cause the computer to perform operation further comprising at least one of:
upon receiving a command for displaying one or more viewed documents in a tile pane window, display the one or more viewed documents in the tile pane window; and
upon receiving a command relative to a selected document in the tile pane window, perform at least one of:
deleting the selected document;
sharing the selected document with one or more recipients;
removing one or more documents above the selected document in the tile pane window;
removing one or more documents below the selected document in the tile pane window; and
keeping only the selected document.

7. The non-transitory computer readable medium of claim 6, wherein a single-finger gesture is used to scroll up and down within the tile pane window.

8. The non-transitory computer readable medium of claim 1, wherein the cell action menu further comprises an option to view data by one or more categories including at least one of a product, a customer, and a geography.

9. The non-transitory computer readable medium of claim 8 comprising instructions, which when executed by the computer, cause the computer to perform operation further comprising at least one of:
upon receiving a selection of view by recipients option from the cell action menu, display one or more recipients associated with the data along with their contact details; and
invoke a communication through at least one of an email, an in-app messaging, a social media, an SMS, and a corporate collaboration network to send required information to the one or more recipients.

10. The non-transitory computer readable medium of claim 1 comprising instructions, which when executed by the computer, cause the computer to perform operations further comprising:
upon receiving user's request, activate a view pane in the document, wherein the activated view pane enable viewing the document with adjustable focused “field-of-view,” and wherein the view pane is re-locatable within the document using at least one of a single-finger gesture and a double-finger gesture.

11. The non-transitory computer readable medium of claim 10, wherein the field-of-view can be viewed graphically upon receiving user's request.

12. A computer-implemented method for document exploration, analysis, and collaboration, the method comprising:
receiving a command for displaying a document;
based upon the received command, displaying the document;
determining whether the document includes an erroneous data;
upon determining the document includes the erroneous data, highlighting the erroneous data within the displayed document; and
performing at least one of:
upon receiving a primary mode of operation on data within the displayed document, display one or more sub-data constituting the data; and
upon receiving a secondary mode of operation on the data within the displayed document, display a cell action menu to perform at least one of sharing the data to one or more recipients, annotating the data, marking the data as favorite, saving the data as a tile on home page, and exporting the data to other application.

13. The computer-implemented method of claim 12, wherein the primary mode of operation comprises a single click and the secondary mode of operation comprises one of a double click, a right click, and a long press on touch devices and wherein the data within the displayed document on which the one of primary mode of operation and secondary mode of operation is performed is the erroneous data.

14. The computer-implemented method of claim 12 further comprising at least one of:
upon receiving a request for editing one or more dimensions and their corresponding measures associated with the document, editing the one or more dimensions and their corresponding measures;
upon receiving a request for displaying one or more predefined row sets, displaying the one or more predefined row sets, wherein at least one row set of the one or more predefined row sets includes fields associated with the document;
upon receiving selection of a row set from the displayed one or more row sets, updating the document row fields with corresponding fields included in the selected row set;
upon receiving a request for displaying one or more predefined column sets, displaying the one or more predefined column sets, wherein at least one column set of the one or more predefined column sets includes fields associated with the document;
upon receiving selection of a column set from the displayed one or more column sets, updating the document column fields with corresponding fields included in the selected column set;
upon receiving a request to swap row fields with column fields of the document, swapping the row fields with column fields of the displayed document; and
upon receiving a request to swap column fields with row fields of the document, swapping the column fields with row fields of the displayed document.

15. A computer system for document exploration, analysis, and collaboration comprising:
at least one memory to store executable instructions; and
at least one processor communicatively coupled to the at least one memory, the at least one processor configured to execute the executable instructions to:
receive a command for displaying a document;
based upon the received command, display the document;
determine whether the document includes an erroneous data;
upon determining the document includes the erroneous data, highlight the erroneous data within the displayed document; and
perform at least one of:
upon receiving a primary mode of operation on data within the document, displaying one or more sub-data constituting the data; and
upon receiving a secondary mode of operation on the data, displaying a cell action menu to perform at least one of sharing the data to one or more recipients, annotating the data, marking the data as favorite, saving the erroneous data as a tile on a home page, and exporting the data to other application.

16. The computer system of claim 15, wherein the primary mode of operation comprises a single click and the secondary mode of operation comprises one of a double click, a right click, and a long press on touch devices and wherein the data within the document is the erroneous data.

17. The computer system of claim 15, wherein the at least one processor is further configured to execute the executable instructions to perform operations comprising at least one of:
upon receiving a request for editing one or more dimensions and their corresponding measures associated with the document, edit the one or more dimensions and their corresponding measures;
upon receiving a request for displaying one or more predefined row sets, display the one or more predefined row sets, wherein at least one row set of the one or more predefined row sets includes fields associated with the document;
upon receiving selection of a row set from the displayed one or more row sets, update the document row fields with corresponding fields included in the selected row set;
upon receiving a request for displaying one or more predefined column sets, display the one or more predefined column sets, wherein at least one column set of the one or more predefined column sets includes fields associated with the document;
upon receiving selection of a column set from the displayed one or more column sets, update the document column fields with corresponding fields included in the selected column set;
upon receiving a request to swap row fields with column fields of the document, swap the row fields with column fields of the displayed document; and
upon receiving a request to swap column fields with row fields of the document, swap the column fields with row fields of the displayed document.

18. The computer system of claim 15, wherein the at least one processor is further configured to execute the executable instructions to perform operations comprising at least one of:
upon receiving a command for displaying one or more viewed documents in a tile pane window, display the one or more viewed documents in the tile pane window; and
upon receiving a command relative to a selected document in the tile pane window, perform at least one of:
deleting the selected document;
sharing the selected document with one or more recipients;
removing one or more documents above the selected document in the tile pane window;
removing one or more documents below the selected document in the tile pane window; and
keeping only the selected document.

19. The computer system of claim 15, wherein the at least one processor is further configured to execute the executable instructions to perform operations comprising at least one of:
upon receiving a selection of view by recipients option from a cell action menu, display one or more recipients associated with the data along with their contact details; and
invoke a communication through at least one of an email, in-app messaging, social media, SMS, and a corporate collaboration network to send required information to the one or more recipients.

20. The computer system of claim 15, wherein the at least one processor is further configured to execute the executable instructions to:
upon receiving user's request, activate a view pane in the document, wherein the view pane enable viewing the document with adjustable focused “field-of-view,” and wherein the view pane is re-locatable within the document using at least one of a single-finger gesture and a double-finger gesture.
